(19) United States
(12) Patent Application Publication
(10) Pub. No.: US 2003/0030637 A1
(43) Pub. Date: Feb. 13, 2003

(54) Method and system for data analysis

(76) Inventors: Georges G. Grinstein, Ashby, MA (US); Patrick E. Hoffman, Wilmington, MA (US); Alexander G. Gee, Lowell, MA (US); Philip J. O'Neil, Somerville, MA (US)

Correspondence Address: ROPES & GRAY, One International Place, Boston, MA, 02110-2624, US

(21) Appl. No.: 10/077,694

(22) Filed: Feb. 15, 2002

Related U.S. Application Data
(60) Provisional application No. 60/285,385, filed on Apr. 20, 2001.
(60) Provisional application No. 60/285,954, filed on Apr. 24, 2001.
(60) Provisional application No. 60/322,771, filed on Sep. 17, 2001.

(51) Int. Cl. G06T 17/00

(52) U.S. Cl. 345/420

(57) ABSTRACT

The invention, in one embodiment, is directed to a system and related methods of data analysis. According to one aspect, the invention processes a plurality of records, each of the records having an associated plurality of attributes, the plurality of records being divisible into at least two categories. More particularly, the invention provides a multidimensional array having intersecting first and second axes; assigns each of the attributes as a one dimensional vector aligned along the first axis, and each of the records as a one dimensional vector aligned along the second axis; displays a graphical indication of an occurrence and/or a value of each attribute for each record at an intersection of each record vector with each attribute vector; and manipulates the record vectors and/or the attribute vectors to produce a graphical pattern representative of the at least two categories.

### REFERENCE TO RELATED APPLICATIONS

This application claims the benefit of U.S. provisional patent application Serial No. 60/285,385, filed Apr. 20, 2001, U.S. provisional patent application Serial No. 60/285,945, filed Apr. 23, 2001, U.S. provisional patent application Serial No. 60/322,771, filed Sep. 17, 2001, and U.S. provisional application identified by Attorney Docket Code ANV-003PR, entitled Multi-Dimensional Interactive Data Visualization Applied To Small Molecule Research, filed Jan. 15, 2002, all of which applications are incorporated herein in their entirety by reference.

This application is related to U.S. patent application identified by Attorney Docket Code ANV-002, entitled “Method And System For Data Analysis” and to U.S. patent application identified by Attorney Docket Code ANV-004, and entitled “Method And System For Data Analysis”, both of which are filed on even date herewith and incorporated herein in their entirety by reference.

### FIELD OF THE INVENTION

The invention relates generally to extracting meaningful information from a data set. More particularly, in one embodiment, the invention relates to systems and methods for interactively analyzing large data sets and providing intuitive visualizations of such analysis and the results thereof to an analyst.

### BACKGROUND OF THE INVENTION

Methods of analyzing data to determine relationships among variables represented by the data are well known. Many purely mathematical methods, such as those used in clustering, classification, numerical prediction, and statistical analysis, which include general techniques such as Neural Networks, Support Vector Machines, Multiple Dimensional Scaling, K-Means, Decision Trees, Association Rules, and similar methods are described at length in the technical literature. One deficiency of such conventional methods is that as data sets grow, the use of these methods become less intuitive. Thus, it becomes more difficult for analysts to identify relationships between variables. To address this deficiency, some commercially available data analysis tools provide graphical visualizations to aid the analyst.

A visualization is a visual representation of data. Data is mapped to some numerical form and translated into some graphical representation. Visualization is used increasingly in the data exploration process. In its early years it was mostly, if not only, used to convey the results of statistical computation or data mining algorithms. Over the last decade, it has been used in data massaging and cleansing processes, and somewhat in data management processes.

There are numerous types of visualizations. Historically, static displays, most of which have been extended to support probing (identification of the coordinate values of the mapped records) include histograms, scatterplots, and their extensions. These can be seen in most commercial graphics and statistical packages.

Examples of some higher dimensional visualizations include: two- and three-dimensional scatterplots; matrices of scatterplots; heat maps; height maps; table lenses; survey plots; iconographic displays; dimensional stacking (general logic diagrams); parallel coordinates; line graphs; multiple line graphs; pixel techniques, such as circle segments; multiple dimensional scaling and Sammon plots; polar charts; principal component and principal curve analysis; grand tours; projection pursuit; and Kohonen self-organizing maps. Several of the above are similar and related.

Effective visualization tools not only need to display data, but also need to include interactive tools (i.e., human curation). One drawback of conventional data visualization techniques is that, typically, they only incorporate visualization to present the results of computations or access. Generally, they fail to provide visualization for data understanding and massaging in the preliminary phases of data exploration. They also fail to provide effective data interrogation tools in intermediate phases of the knowledge discovery process.

Conventional visualization tools also have other significant deficiencies. By way of example, some visual displays, such as tabulations of numerical values, are difficult to use to discern patterns and relationships. Other graphical methods, such as scatter plots, or line graphs, can display information in a manner that shows relationships. However, such displays often are difficult to manipulate to extract meaningful information regarding particular interrelationships between the variables. They also do not provide adequate tools for identifying a reduced set of variables that control a particular relationship. Thus, conventional visualization tools are only of limited value when applied to large data sets, having a large number (i.e. greater than about ten) of variables and/or a large number (i.e. greater than about one hundred) of records.

### SUMMARY OF THE INVENTION

The invention relates to systems and methods for analyzing data. More particularly, in one embodiment, the invention provides systems and methods for identifying relationships between a present or predicted future state (“state”) of a study object and one or more attributes of the study object, expressed, for example, as occurrences or values. According to one aspect of the invention, a study object can be any item about which one or more attributes can be detected or measured. According to one feature, the invention expresses the study objects as records, with each record having one or more attributes. According to another feature, the number of records may range into the hundreds, thousands, tens of thousands or more. According to another feature, the number of attributes for each record may range into the hundreds, thousands, tens of thousands or more. The number of attributes and/or records analyzed is limited, primarily, by processing and computer memory requirements. Generally, the greater the number of study objects and associated attributes to be analyzed, the more useful the systems and methods of the invention. The limits on the number of study objects, records, or attributes are much higher than conventional systems but still can be limited by computer memory and speed. In one embodiment, the invention provides an attribute reduction aspect, a record categorization aspect, data processing algorithms and a graphical user interface GUI.

The attribute reduction aspect of the invention, in one embodiment, processes a set of records and related attributes to determine a result-effective subset of attributes, the values of which, when taken in combination, are sufficient to divide the set of records into at least two categories. According to a further embodiment, the attribute reduction aspect of the invention arranges the records and attributes in a multi-dimensional spatial array along separate vectors. For example, the records and attributes may be arranged in tabular form, with each column representing a record and each row representing an attribute or vice versa. According to one feature, the individual attribute values are converted into visually distinguishable indicia. For example, in one instance, a high attribute value, such as a concentration of substance X, which may be present in each record, shows as black. Its absence shows as white, and intermediate values show as gray. Optionally, depending on the goal of the analysis, the records having a known common state may be grouped adjacent to one another. For example, the records of cells displaying phenotype A may be grouped adjacent to one another, and the records of cells not exhibiting phenotype A grouped similarly. Next, with the aid of a computer, for example, exploiting data processing algorithms and logic of the type described herein, the attribute reduction aspect of the invention repeatedly re-orders and organizes the attribute vectors until a recognizable pattern emerges indicative of a result-effective subset of attributes representative of a particular state of the records.

According to a further feature of the attribute reduction aspect of the invention, a computer is programmed to discriminate among patterns so as to select only certain patterns, or to display for viewing only patterns which meet some predefined criteria. According to one feature, the computer programs include clustering, classification and prediction algorithms. One such predefined criteria takes advantage of pattern recognition abilities of the visual cortex of the human brain.

In some embodiments, the attribute reduction aspect of the invention involves more than two dimensions. For example, a collection of attributes obtained from a group of objects under study may include data recorded repeatedly (or at varying times) so as to examine the evolution of some feature of interest with time. An example of such a time evolution is the study of living subjects with respect to a disease or degenerative condition that increases in severity over time. For example, a group of persons, some of whom have normal health and some of whom exhibit a disease such as arthritis, heart disease or some form of cancer, is examined periodically to obtain measured values for a variety of attributes such as genetic information, mRNA, proteins, metabolites, medications, environmental influences such as chemicals and the like, and the time evolution of the disease state may be investigated, so as to identify attributes that tend to precipitate or aggravate the disease and/or attributes that tend to prevent and/or ameliorate the disease. According to one such embodiment, the invention provides an additional array vector to account for time.

According to a further feature, the attribute reduction aspect of the invention finds the attributes that are the most relevant in determining a relationship between or among study objects represented as records. The records and related attributes are displayed in a multi-dimensional display having the records aligned along a first direction, and having the attributes aligned along a second direction. According to one feature, within a group of records that are related by having a common feature, the sequence of records is manipulated. For example, records may be manipulated by pair wise exchange of the attributes corresponding to individual records. Alternatively, the sequence of attributes may be rearranged by pair wise exchange of records corresponding to individual attributes, or through an ordering computed from an algorithm, such as, for example, a genetic sorting algorithm, correlation, cross-correlation or clustering algorithm. According to other embodiments, any available sorting algorithms may be employed. Such manipulation provides a sequence of records and attributes that cluster true positive records in one region, and true negative records in a separate region. When a suitable pattern of records is obtained, attributes that are likely to have strong influences on the grouping of the records (e.g., attributes along the true positive—true negative border) are indicated by positive correlations in the one region and negative correlations in the other. According to another feature, manipulations and algorithms that rearrange triples (or larger numbers) of records or attributes are also possible.

According to a further embodiment, the attribute reduction aspect of the invention employs a two dimensional array having intersecting first and second axes. In this embodiment, the invention assigns each of the attributes as a vector aligned along the first axis, and each of the records as a one dimensional vector aligned along the second axis. According to a further feature, the invention displays a graphical indication of the value associated with each of the attributes for each of the records at an intersection of each record vector with each attribute vector. Next, an operator and/or automated data processing algorithms manipulate record vectors and/or attribute vectors to produce a graphical pattern in the array representative of the at least two categories. According to one embodiment, the invention displays the graphical pattern to the operator and the operator is charged with detecting a category separation, such as visual clustering, from the display. However, in alternative embodiments, the automated data processing algorithms detect the category separations, without need of a display. According to one feature, the category separations may be numerical as well as visual. In one embodiment, the invention computes an optimal layout that separates the records into the at least two categories.

According to a further embodiment, the invention computes statistics for each of the records, placing all of the attributes along one axis and the statistical computations along the other axis. The statistics include, for example, any of mean, median, mode, standard deviation, variance, kurtosis, quartiles, regression, correlation, missing values, and various significance metrics. The graphical indication of the value associated with each of the statistics for each of the records is presented at the intersection of each record vector with each statistic value. According to one feature, an operator and/or automated data processing algorithms manipulate the record and/or statistic vectors to identify outliers and/or grouping patterns.

According to a further feature, the detected category separations, enable the operator and/or the automated data processing algorithms to determine a result-effective subset of attributes that is sufficient to divide the records into the detected category separations. According to one feature, the result-effective subset of attributes is a minimum subset adequate to divide the records into the detected categories.

According to a further embodiment, the graphical indication of attribute values include at least two gradations (e.g. having the attribute, not having the attribute and indeterminate). In one embodiment, the invention provides a color for each of the gradations. In an alternative embodiment, the invention provides an integer for each of the gradations. In another embodiment, the invention provides a symbol for each of the gradations. In another alternative embodiment, the invention provides a gray tone for each of the gradations. In another alternative embodiment, the invention provides for various combinations of the above; for example a colored symbol may be used to provide a graphical indication of two or more of the attribute values, where the color represents one of the attributes and the symbol one or more of all the attributes.

In another embodiment, the attribute reduction aspect of the invention employs training data records for each of a plurality of study objects. According to one embodiment, each of the study objects have a known condition that places it into one of at least two categories. The attribute reduction aspect of the invention organizes the training data records in a multidimensional array having a plurality of sets of indices, including a first set of indices enumerated by the study objects and a second set of indices enumerated by the attributes. It then manipulates at least one of the plurality of sets of indices for at least one dimension of the multidimensional array to produce a substantially monotonic variation of the data records relative to at least one set of the plurality of sets of indices. The attribute reduction aspect then determines a result-effective subset of attributes for which the training data records indicate a variation representative of a decomposition of the training data records into the at least two categories.

According to one embodiment, the features of attribute reduction aspect of the invention are performed using a variety of algorithms. In one case, the result-effective attribute subset is determined through a genetic algorithm, with one goal being to maximize the cluster separation of the records for display to a user. In another case, the result-effective subset is determined through Principal Component Analysis and the attribute coefficients contributing to the Principal Components. In another case, the result-effective subset is determined by sampling the plurality of records to produce a representative view of the complete set. This sampling can be performed using a classic sampling methodology, with or without replacement, in each case having some metric or threshold determining how to accept records for representation.

According to a further embodiment, the attribute reduction aspect of the invention employs a principal uncorrelated row set (PURS) and/or a principal uncorrelated column set (PUCS) algorithm to determine the reduced set of attributes. According to one embodiment, the PURS and PUCS algorithms employ a two dimensional array having intersecting first and second axes. Each of the attributes is mapped as a one dimensional vector aligned along the first axis and each of the records as a one dimensional matrix aligned along the second axis. Either the rows (PURS) or the columns (PUCS) are then selected as a class of vectors. Let K be an integer value representing the maximum number of uncorrelated vectors to be identified from the class of vectors, and select a threshold value used to determine a vector relationship. This K can be defined by the user or determined by the algorithm. A first vector is then selected (preferably substantially randomly, but the selection may depend on some prior knowledge) from the class of one dimensional vectors to be a member of an uncorrelated vector set. Next, an additional vector is selected (preferably substantially randomly, but the selection may depend on some prior knowledge) from the class of vectors. A correlation parameter or some other metric (distance, statistical or other) is then computed using the first vector and the additional vector. The correlation parameter or metric is then compared to the threshold value, and add the additional vector to the uncorrelated vector set in response to the correlation parameter or metric having a particular relationship with the threshold value. According to one embodiment, the particular relationship requires that the correlation parameter or metric be less than the threshold value.

According to a further embodiment, the algorithms iteratively perform the additional vector selection, correlation or metric parameter computation, the comparison and set addition steps until substantially all of the vectors in the class of vectors have been analyzed.

In one embodiment, the algorithms further include determining whether there are more than K vectors in the set of uncorrelated vectors. According to one feature, in response to such a determination, the PURS and PUCS algorithms repeat an integer N number of times the steps of selecting a threshold value, choosing a first vector, and performing iteratively the steps of selecting an additional vector from the class of vectors, computing a correlation parameter using the first vector and the additional vector, comparing the correlation parameter to the threshold value, and adding the additional vector to the uncorrelated set of vectors in response to the correlation parameter being less than or equal to the threshold value, so as to determine a set of vectors that are uncorrelated.

In one embodiment, upon a determining that no set of uncorrelated vectors has more than K members, the algorithms reduce the threshold value and repeat the steps of choosing a first vector, and performing iteratively the steps of selecting an additional vector, computing a correlation parameter, comparing the correlation parameter to the threshold value, and adding the additional vector to the uncorrelated set of vectors if the correlation parameter is less than or equal to the threshold value. According to one feature, the algorithms repeat the above steps until substantially all of the vectors in the class of vectors have been analyzed again.

In a further embodiment, the PURS and PUCS algorithms further comprise determining whether there are more than K vectors in the set of uncorrelated vectors. According to one feature, in response to such a determination, the algorithms repeat, an integer M number of times, selecting a threshold value, choosing a first vector from the class of vectors, and performing iteratively the steps of selecting an additional vector, computing a correlation parameter, comparing the correlation parameter to the threshold value, and adding the additional vector to the uncorrelated set of vectors in response to the correlation parameter being less than or equal to the threshold value, determining M sets of vectors that are uncorrelated, and determining whether there are K or fewer vectors in any of the M sets, so as to determine an uncorrelated set of vectors having no more than K members.

Turning to the record categorization aspect of the invention, in one embodiment, it provides systems and methods for employing a set of attributes to determine into which of the at least two categories records representing study objects are likely to divide. In one embodiment, the record categorization aspect of the invention employs the result-effective attribute subset identified by the attribute reduction aspect of the invention.

The record categorization aspect of the invention, in one embodiment, organizes records and attributes on a multi-dimensional representation. According to one feature, the invention assigns a set of attributes to positions on a locus, such as on a periphery of the multi-dimensional representation. In one embodiment, the locus is a circle and the attributes are arranged equidistant around the periphery of the circle. In other embodiments, the locus may be any multi-dimensional locus, including, any two-dimensional locus, whether circumscribing a two-dimensional region or piecewise and unenclosed, including any curvilinear shape; ellipse; or polygon, including reentrant polygon, such as a star; a piece-wise connected polygon where the polygon edges are separated; a piece-wise connected collection of curves where the curve pieces are separated; and any three-dimensional shape, such as a sphere; a volume of revolution; a dimensional polygonal structure, such as a geodesic structure, such as a tetrahedron, cube, dodecahedron, or icosahedron.

The record categorization aspect of the invention assigns each record to a position on the multidimensional representation, based on at least one of the occurrence and the value of at least one associated attribute. According to one feature, the invention determines the position of the record on the multidimensional representation by considering the record as a vector, evaluating a relationship in which each attribute value of a particular record represents a coordinate of said vector, each attribute position on the locus defines a vector having an origin at the attribute position on the locus and endpoint at the record location, and the particular record is located at an equilibrium point determined by summing all of the attribute vector forces acting upon it.

In one embodiment, the magnitudes represent spring force constants and each record is considered to be connected to each of the attribute positions on the locus by way of a plurality of springs (one for each attribute). According to one feature, the record categorization aspect of the invention positions the record on the locus at the equilibrium point determined by summing the spring forces exerted on the record by each of the attributes, as determined from Hooke's Law. According to a further embodiment, the equilibrium point is determined by summing the squares of the magnitude of the spring forces exerted on the record by the attributes. According to another embodiment, the logarithm of the magnitude is used. According to a further embodiment, an operator and/or automated data processing algorithms manipulate the position of one or more of the attributes on or about the periphery of the locus to alter the position of the records. According to a further feature, the record categorization aspect of the invention, either automatedly or under operator control, manipulates the sign (positive or negative) of the forces associated with one or more attributes to enhance category separations. According to an additional embodiment, the record categorization aspect of the invention either automatedly or under operator control manipulates the attribute force values, using for example, t-statistics, to enhance category separations. According to another embodiment, the record categorization aspect of the invention, either automatedly or under operator control, manipulates one or more points on the locus to change the locus shape to enhance category separations. In another feature, the record categorization aspect of the invention, either automatedly or under operator control, can also break the locus into multiple pieces and manipulate the position and/or shape of the resultant pieces to enhance category separation. By enabling such manipulations, the invention provides a mechanism for dividing the records into at the least two categories.

In another embodiment, the record categorization aspect of the invention displays record and attribute positions on the locus to an operator. According to a further feature, in response to any of the above described attribute position, force sign, force magnitude, locus shape manipulations, or direct manipulation of the attributes by the user, the record categorization aspect of the invention displays updated record position information to the operator.

According to one embodiment, the record categorization aspect of the invention employs Automatic Partitioning (AP) layout algorithms. The AP layout algorithms use class distinction metrics to assign the positions of the attributes on the locus. By way of example, for a circular locus, the AP algorithms can provide emphasis by breaking the circular layout and laying out the classes using pie wedges. The AP algorithms can also change the above described spring forces to be negative to enhance the separation (zero-centered). The metrics used can be, for example, t-statistics (with equal and unequal variances for the classes), wilcoxan rank, correlations and F-statistics for all classes, and many other metrics. As another example, if the attributes are sorted by the t-statistic from a two class attribute with highest positive values in the upper right quadrant and lowest negative values in the lower left quadrant, a good class separation is quite often seen. In multiple class layouts (e.g., 3 or more classes), the metrics are combined to get the best positive and negative attributes for each class. In this case, a positive and negative pie wedge is used to lay out each class. The metric can also be used to reduce the attributes from a very large number down to a fixed number of attributes for each class. The spring force circular layout with the AP metric algorithm becomes both a machine learning classifier and a feature reduction tool. Mean normalization of the columns, (similar to z-score normalization), local normalization (all columns use individual scale value between 0 and 1), global normalization (all columns use same scale), or other normalization methods (log, etc.) can also be used to enhance the separation or classification.

According to a further embodiment, the record categorization aspect of the invention employs an array for organizing the attributes and records laid out on the locus. According to one embodiment, a classifier, such as for example, a neural network, can be used to lay out the columns and rows of the array corresponding to the attributes and records laid out on the locus.

According to an additional embodiment, the above described attribute reduction aspect of the invention identifies a result-effective subset of attributes for a first set of records representing training study objects, each being known to divide into one of at least two categories, and the record categorization aspect of the invention then uses the first set of records for calibration. More particularly, according to one feature, the invention performs the above described attribute position, force sign, force magnitude, and/or locus shape manipulations until the training records divide into the known at least two categories. The conditions necessary to cause the appropriate division are then considered to be calibrated attribute conditions.

Next, according to a further feature, for a test record set about which category information is unknown, the record categorization aspect of the invention sets the above discussed calibrated conditions, and either automatedly or under operator control maps the test records onto the locus using the calibrated result-effective attributes, and divides the test records into the at least two categories. According to an additional feature, the record categorization aspect of the invention displays the results to an operator.

According to one feature, reassigning the attribute position of at least one of the attributes includes exchanging the attribute positions of two of the attributes. In another embodiment, reassigning the attribute position of the at least one of the attributes includes shifting the attribute position of the at least one attribute. Attributes may or may not remain equally spaced along the locus.

Turning to the GUI, in one embodiment, it enables an operator to systematically control and modify operation of the attribute reduction aspect, record categorizing aspect, and/or data processing algorithms of the invention. According to a further embodiment, the GUI provides a plurality of display screens, dialog boxes, radio buttons, sliders, dials, pull down menus and the like.

In other embodiments, the invention provides systems, methods and computer software on computer readable media embodying any or all of the attribute reduction, record categorization and GUI aspects of the invention. As used herein, the term computer software includes microcode, object code, source code and the like.

The invention will next be described in connection with certain preferred embodiments. However, it should be clear that various additions, subtractions and modifications can be made without departing from the spirit of the invention. For example, although the invention is illustrated with respect to identifying particular relationships, the invention may be used to identify relationships between a state of any study object and any attributes of the study object. Further, a study object may be any item about which one or more attributes can be detected or measured.

The foregoing and other aspects, features, and advantages of the invention will become more apparent from the following description and from the claims.

### BRIEF DESCRIPTION OF THE DRAWINGS

The objects and features of the invention can be better understood with reference to the drawings described below and the claims. The drawings are not necessarily to scale, emphasis instead generally being placed upon illustrating the principles of the invention. In the drawings, like numerals are used to indicate like parts throughout the various views.

FIG. 1 is a conceptual block diagram depicting a data analysis system according to an illustrative embodiment of the invention;

FIG. 2 is a conceptual flow diagram depicting an exemplary methodology according to an illustrative embodiment of the invention;

FIG. 3 depicts a table of data to be used in illustrating one aspect of the attribute reduction subsystem of FIG. 1;

FIG. 4A depicts an expanded view of a portion of the table of FIG. 3 and an aspect of a binning process used for values of numerical variables of a particular column of the table according to an illustrative embodiment of the attribute reduction subsystem of the invention;

FIG. 4B depicts another expanded view of a portion of the table of FIG. 3 and an aspect of a binning process used for values of level of expression variables of another column of the table according to an illustrative embodiment of the attribute reduction subsystem of the invention;

FIG. 4C depicts another expanded view of a portion of the table of FIG. 3 with all values binned into one of three states (low, medium, high) represented in gray scale according to an illustrative embodiment of the attribute reduction subsystem of the invention;

FIG. 4D depicts another expanded view of a portion of the table of FIG. 3 with all alphanumeric values removed;

FIG. 5A depicts an unsorted gray scale binned table for an ideal data set according to an illustrative embodiment of the attribute reduction subsystem of the invention;

FIG. 5B depicts an intermediately sorted view of the table of FIG. 5A according to an illustrative embodiment of the attribute reduction subsystem of the invention;

FIG. 5C depicts a fully sorted view of the table of FIG. 5A for an ideal data set according to an illustrative embodiment of the attribution reduction subsystem of the invention;

FIG. 6A depicts a screenshot of actual training/control data binned table according to an illustrative embodiment of the attribute reduction subsystem of the invention;

FIG. 6B depicts a display screen of a first intermediately sorted view of the table of FIG. 6A subsequent to sorting on one dimension according to an illustrative embodiment of the attribute reduction subsystem of the invention;

FIG. 6C depicts a display screen of a second intermediately sorted view of the table of FIG. 6A subsequent to sorting on two dimensions according to an illustrative embodiment of the attribute reduction subsystem of the invention;

FIG. 6D depicts a display screen of a third intermediately sorted view of the table of FIG. 6A subsequent to sorting on five dimensions according to an illustrative embodiment of the attribute reduction subsystem of the invention;

FIG. 6E depicts a display screen of a fourth intermediately sorted view of the table of FIG. 6A subsequent to sorting on thirty-three dimensions according to an illustrative embodiment of the attribute reduction subsystem of the invention;

FIG. 6F depicts a display screen of a fully sorted view of the table of FIG. 6A according to an illustrative embodiment of the attribute reduction subsystem of the invention;

FIG. 6G depicts a display screen of the fully sorted view of FIG. 6F highlighting relevant information;

FIG. 6H is a display screen depicting an expanded region of the sorted table of FIG. 6G according to an illustrative embodiment of the attribute reduction subsystem;

FIG. 7 is a GUI screen image for initiating and controlling parameters of a principal uncorrelated row sort (PURS) and a principal uncorrelated column sort (PUCS) data processing algorithm according to an illustrative embodiment of the invention;

FIG. 8 is a flow diagram illustrating aspects of the PURS and PUCS data processing algorithms of the invention;

FIG. 9 is a GUI screen image illustrating verification of a result-effective subset of attributes identified using the PURS and PUCS data processing algorithm of FIG. 8;

FIG. 10A is a GUI display screen image depicting a gray scale binned map of statistical information relating to expression values of genes according to an illustrative embodiment of the attribute reduction subsystem of the invention;

FIG. 10B is a GUI display screen image showing a gray scale binned map representing Pearson Correlation Coefficients for absolute gene expression values in a data set according to an illustrative embodiment of the attribute reduction subsystem of the invention;

FIG. 10C is a GUI display screen image showing a gray scale binned map representing Pearson Correlation Coefficients for comparative gene expression values in a data set according to an illustrative embodiment of the attribute reduction subsystem of the invention;

FIG. 11A depicts another exemplary binned table according to an illustrative embodiment of the attribute reduction aspect of the invention;

FIG. 11B depicts the table of FIG. 11A tracking example record 20 subsequent to independently sorting on variable 1 according to an illustrative embodiment of the attribute reduction aspect of the invention;

FIG. 11C shows the table of FIG. 11B tracking example record 20 subsequent to independently sorting on variable 2 according to an illustrative embodiment of the invention;

FIG. 11D shows the table of FIG. 11C tracking example record 20 subsequent to independently sorting on variable 3 according to an illustrative embodiment of the invention;

FIG. 11E shows the resultant line graph generated by independently sorting on each of the variables 1-16 while particularly tracking example record 20 according to an illustrative embodiment of the invention;

FIG. 12A depicts a single record of the table of FIG. 3 plotted by the record categorization subsystem on a radial visualization according to an illustrative embodiment of the invention;

FIG. 12B depicts the radial visualization of FIG. 12A having all of the records of the table of FIG. 3 plotted according to an illustrative embodiment of the record categorization subsystem;

FIG. 12C depicts the radial visualization of FIG. 12B with the attributes around the periphery of the radial visualization re-plotted and the records divided into categories according to an illustrative embodiment of the record categorization subsystem;

FIG. 13A is a GUI screen display depicting a radial visualization of time varying data during a first set of time intervals according to an illustrative embodiment of the record categorization subsystem;

FIG. 13B is a GUI screen display depicting the data of FIG. 13A with the attributes randomly arranged according to an illustrative embodiment of the record categorization subsystem;

FIG. 13C is a GUI screen display depicting a radial visualization of the time varying data of FIG. 13A during a second set of time intervals according to an illustrative embodiment of the record categorization subsystem;

FIG. 13D is a GUI screen display depicting the data of FIG. 13A with all one hundred time sample attributes randomly arranged according to an illustrative embodiment of the record categorization subsystem;

FIG. 13E is a GUI screen display depicting a table-like visualization of the data of FIG. 13D according to an illustrative embodiment of the attribute reduction subsystem;

FIG. 13F is a GUI screen display depicting the table-like visualization of FIG. 13E subsequent to sorting according to an illustrative embodiment of the attribute reduction subsystem;

FIG. 13G is a GUI screen display depicting a multiple line graph transformation of the data of FIG. 13F according to an illustrative embodiment of the invention;

FIG. 14A-14C are screen shots illustrating operation of the AP algorithms;

FIG. 15A shows the table of FIG. 11A annotated to illustrate a transformation process to a the radial visualization of FIG. 12B according to an illustrative embodiment of the record categorization subsystem;

FIG. 15B depicts a first intermediate conceptual state in the transformation process of the table of FIG. 11B into the radial visualization of FIG. 12B according to an illustrative embodiment of the record categorization subsystem of the invention;

FIG. 15C depicts a second intermediate conceptual state of the transformation process of the table of FIG. 11B into the radial visualization of FIG. 12B according to an illustrative embodiment of the record categorization subsystem of the invention;

FIG. 16A depicts a radial visualization according to an illustrative embodiment of the record categorization subsystem of the invention;

FIG. 16B depicts an elliptical visualization illustrating locus reshaping features of the record categorization subsystem of the invention;

FIG. 16C depicts an arbitrary multi-dimensional visualization illustrating further reshaping features of the record categorization subsystem of the invention;

FIG. 16D depicts a spherical multi-dimensional visualization according to an illustrative embodiment of the record categorization subsystem of the invention;

FIG. 17 depicts a screen image for interacting with features of the invention according to an illustrative embodiment of a GUI;

FIG. 18 depicts a screen image in which seven functional interfaces of the attribute reduction and record categorization subsystems are simultaneously displayed in tiled format, according to an illustrative embodiment of the GUI;

FIG. 19 depicts a GUI screen image in which seven functional interfaces of the attribute reduction and record categorization subsystems are simultaneously displayed in cascaded format, according to an illustrative embodiment of the invention;

FIG. 20 depicts a GUI screen image in which four functional interfaces of the attribute reduction and record categorization subsystems are simultaneously displayed in cascaded format, according to an illustrative embodiment of the invention;

FIG. 21 is a GUI screen image depicting an interface for interacting with the record categorization subsystem according to an illustrative embodiment of the invention;

FIG. 22 is a GUI screen image depicting a radial visualization of data selected from the GUI screen image of FIG. 21, according to an illustrative embodiment of the invention;

FIG. 23 depicts the GUI screen image of FIG. 22 subsequent to an operator selecting the “Data” pull-down menu option, according to an illustrative embodiment of the invention;

FIG. 24 is a GUI screen image depicting a multi-dimensional polygonal visualization, according to an embodiment of the invention;

FIG. 25 is a GUI screen image depicting an interface for interacting with the attribute reduction subsystem according to an illustrative embodiment of the invention;

FIG. 26 is a GUI screen image depicting the visualization of FIG. 25 subsequent to an operator selecting the “Sum” pull-down menu option, according to an embodiment of the invention;

FIG. 27 is a GUI screen image depicting filtering options available from the attribute reduction subsystem according to an illustrative embodiment of the invention;

FIG. 28 is a GUI screen image depicting layout options available from the attribute reduction subsystem according to an illustrative embodiment of the invention;

FIG. 29 depicts the GUI screen image of FIG. 27 subsequent to an operator selecting the “Selection” pull-down menu;

FIG. 30 depicts the GUI screen image of FIG. 27 subsequent to an operator activating the “Selection” tab and the “Visualization Display” pull-down menu;

FIG. 31 depicts the GUI screen image of FIG. 27 subsequent to an operator activating the “Selection” tab, the “Visualization Selection” and “Mark Primary Unrelated Records” pull-down menu;

FIG. 32 depicts the GUI screen image of FIG. 27 subsequent to an operator activating the “Selection” tab, the “Visualization Data”, and “Show Table” pull-down menu;

FIG. 33 depicts the GUI screen image of FIG. 32 subsequent to an operator activating the “Data” tab and the “Sort Ascending” pull-down menu;

FIG. 34 depicts a GUI screen image showing category separation for a 76 gene subset;

FIG. 35 depicts a GUI screen image showing category separation for a 3 gene subset;

FIG. 36 depicts the chemical structure for benzodiazepines;

FIG. 37 is a radial visualization depicting the R3 attributes for the benzodiazepines of FIG. 36;

FIG. 38 is a radial visualization depicting the R3 and R4 attributes for the benzodiazepines of FIG. 36;

FIG. 39 is a radial visualization depicting the R3 and R4 attributes for the benzodiazepines of FIG. 36, along with the actual values for a group of attributes;

FIG. 40 is a radial visualization depicting the R3, R4 and S5 attributes for the benzodiazepines of FIG. 36;

FIG. 41 is a radial visualization depicting the R3, R4 and S5 attributes for the benzodiazepines of FIG. 36, along with the actual values for a group of attributes;

FIG. 42 is a binned table depicting Pearson correlation coefficient information for a bio-chemical example application of the invention;

FIG. 43 is a binned table depicting chemical class clustering information for the bio-chemical example of FIG. 42;

FIG. 44 is a binned table depicting ISIS key clustering information for the bio-chemical example of FIG. 42;

FIG. 45 is a binned table used to identify association rules in the bio-chemical example of FIG. 42;

FIG. 46 is a radial visualization used to identify a sub-selection of records having high activity for isozymel in the bio-chemical example of FIG. 42;

FIG. 47 is a series of histograms depicting characteristics of the sub-selection of FIG. 46;

FIG. 48 is a radial visualization depicting a division between toxic and non-toxic compounds in the example of FIG. 42; and

FIG. 49 depicts a GUI screen image of parameters for an AP algorithm.

### DESCRIPTION OF AN ILLUSTRATIVE EMBODIMENT

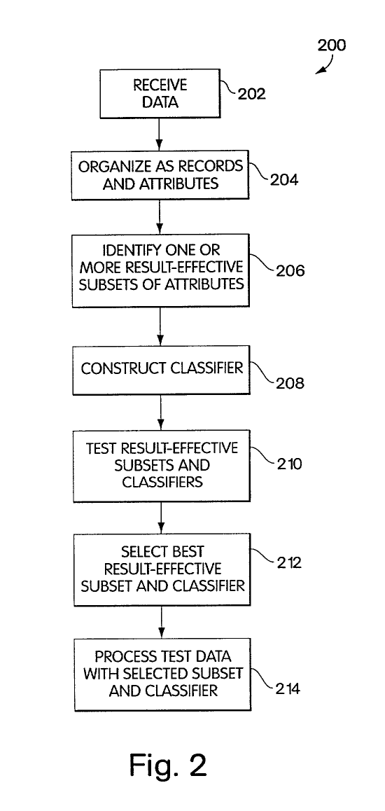

As discussed above in summary, in one embodiment, the invention provides systems and methods for identifying relationships between a state of a study object and one or more attributes of the study object, expressed, for example, as occurrences or values. Illustratively, a study object may be any item about which one or more attributes can be detected or measured. As discussed in more detail below with respect to FIG. 2, the invention expresses the study objects as records, with each record having one or more attributes. According to the illustrative embodiment, the number of records may range into the hundreds, thousands, tens of thousands or more. According to the illustrative embodiment, the number of attributes for each record may range into the hundreds, thousands, tens of thousands or more. As will become apparent from the following description, the greater the number of study objects and associated attributes to be analyzed, the more useful the systems and methods of the invention.

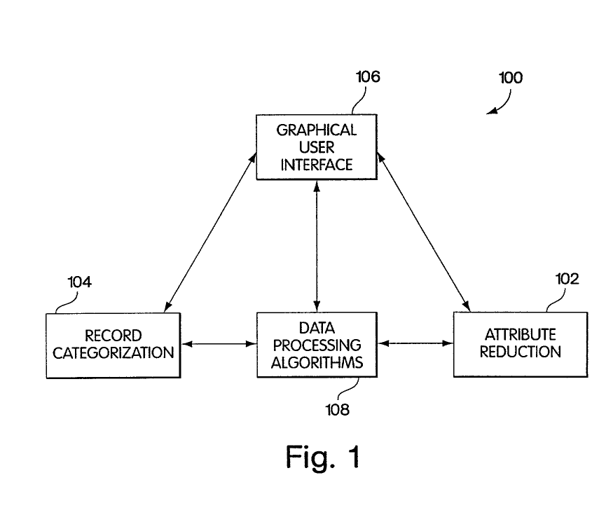

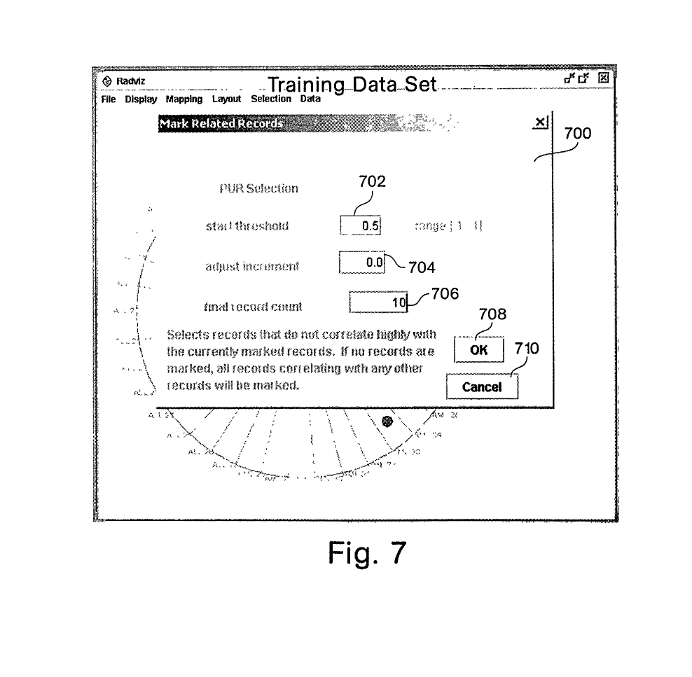

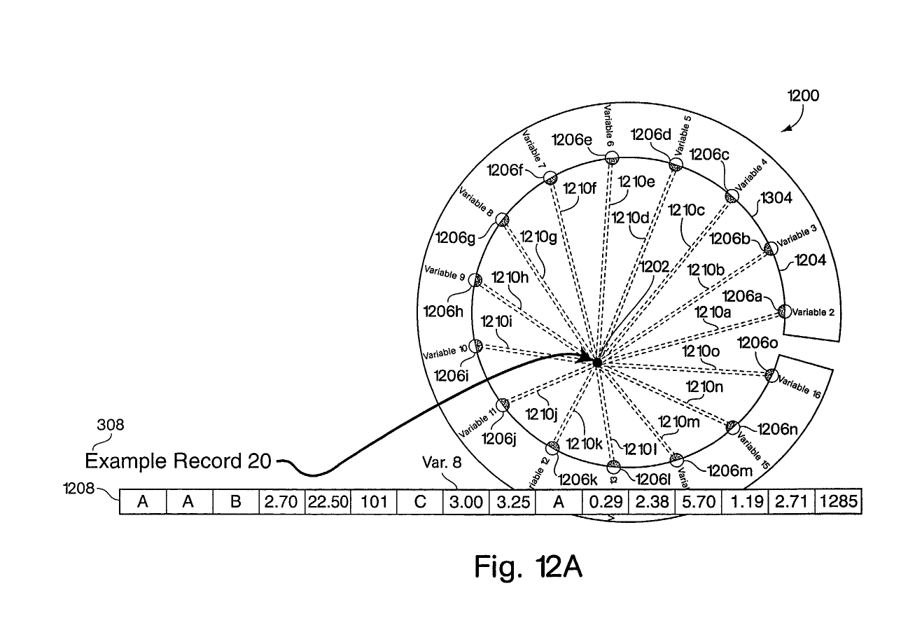

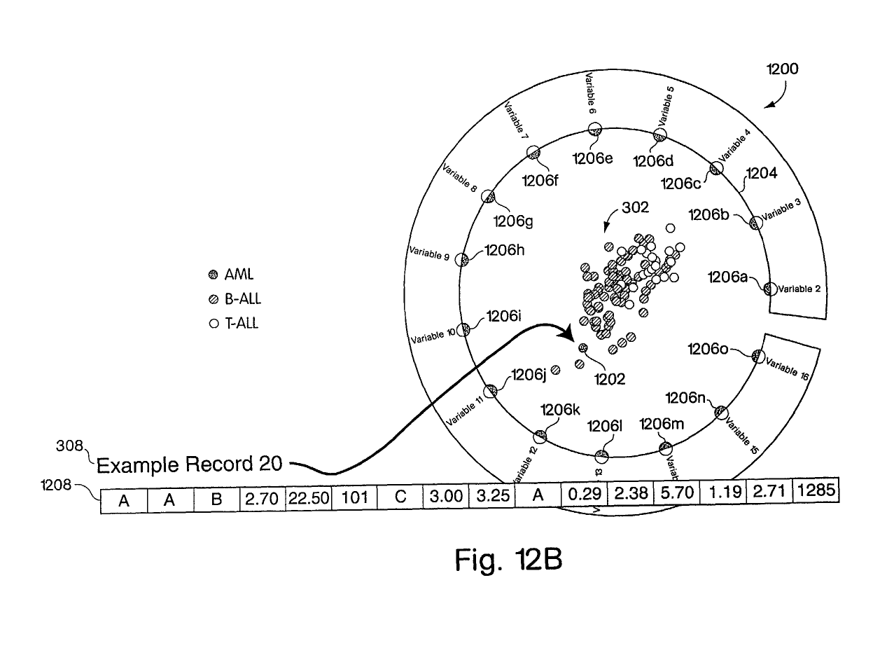

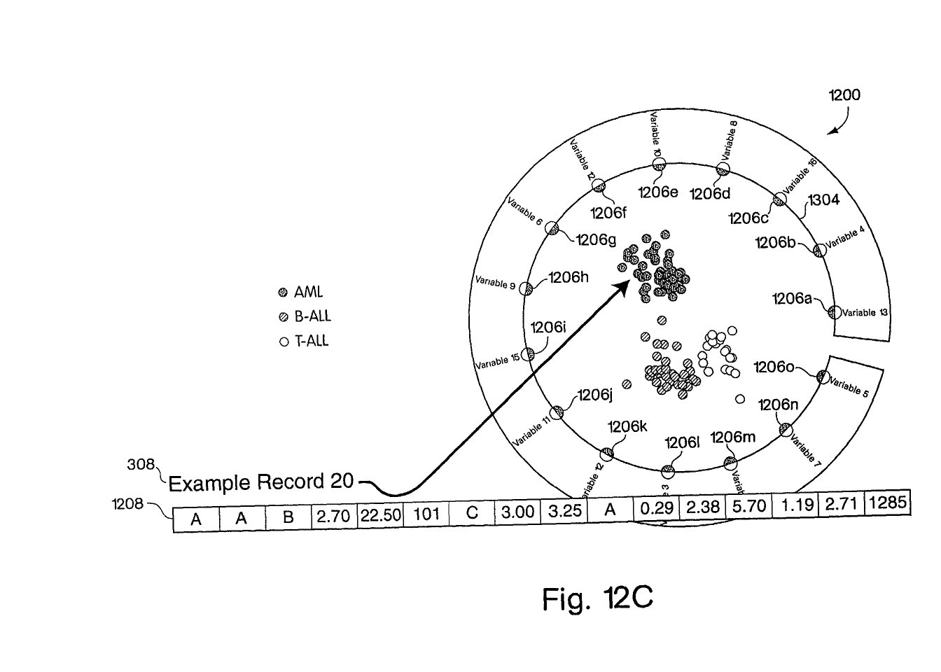

FIG. 1 is a conceptual block diagram depicting a data analysis system 100 according to an illustrative embodiment of the invention. The illustrative data analysis system 100, marketed in one commercial embodiment under the name SuperViz™, by Anvil Informatics, Inc. of Lowell, Mass., includes an attribute reduction subsystem 102, a record categorization subsystem 104, a graphical user interface 106 and data processing algorithms 108. As discussed in further detail below with respect to FIGS. 1-6H, the illustrative attribute reduction subsystem 102 processes a record set and associated attributes to determine a result-effective subset of attributes, the values of which, when taken in combination, are sufficient to divide the record set into at least two categories. As discussed in further detail below with respect to FIGS. 12A-12C, the illustrative record categorization subsystem 104 processes a set of attributes and associated records to determine into which of at least two categories each of the records are likely to divide. In one illustrative embodiment, the attribute reduction subsystem 102 identifies a result-effective subset of attributes for a first set of records representing training study objects, each being known to divide into one of at least two known categories. The record categorization subsystem 104 then uses the result-effective attribute subset identified by the attribute reduction subsystem 102 to process other test record sets, about which category information is unknown. However, as discussed below with respect to FIGS. 12A-12C, in some illustrative embodiments, the record categorization subsystem 104 employs similar data processing algorithms to the attribute reduction subsystem 102, along with additional data processing algorithms, to provide attribute reduction features. The data processing algorithms 108, described in further detail below with respect to FIGS. 7-15C, provide the methodology by which the illustrative attribute reduction 102 and record categorization 104 subsystems process record and attribute data. The illustrative GUI 106, described in further detail below with respect to FIGS. 7-33, enables an operator to interactively control aspects of the attribute reduction subsystem 102, the record categorization subsystem 104 and/or the data processing algorithms 108.

Although, the attribute reduction subsystem 102, the record categorization subsystem 104, the data processing algorithms 108 and the GUI 106 are described herein with respect to the illustrative data processing system 100, each may exist as independent inventions or in various other combinations with each other.

FIG. 2 is a conceptual flow diagram 200 depicting an exemplary data analysis methodology according to the illustrative embodiment of the invention. As indicated at step 202, the first step is to receive data for analysis. Next, as shown at step 204, the data is organized as a set of records representing study objects and associated attributes of the study objects, represented, for example as occurrences or values. As mentioned above, a study object is any item about which one or more attributes can be detected or measured. Next, as indicated at step 206, the invention determines one or more result-effective subsets of attributes. A result-effective subset is a subset of attributes, the values of which, when taken in combination, are sufficient to divide the set of records into at least two categories. By identifying a result-effective attribute subset, the invention enables future processing to accommodate fewer variables, thus simplifying data manipulation. As will be discussed in further detail below, according to the illustrative embodiment, the attribute reduction subsystem 102, the record categorization subsystem 104 and the data processing algorithms 108, individually, in combination, automatedly or with operator interaction, may perform the result-effective attribute identification of step 206.

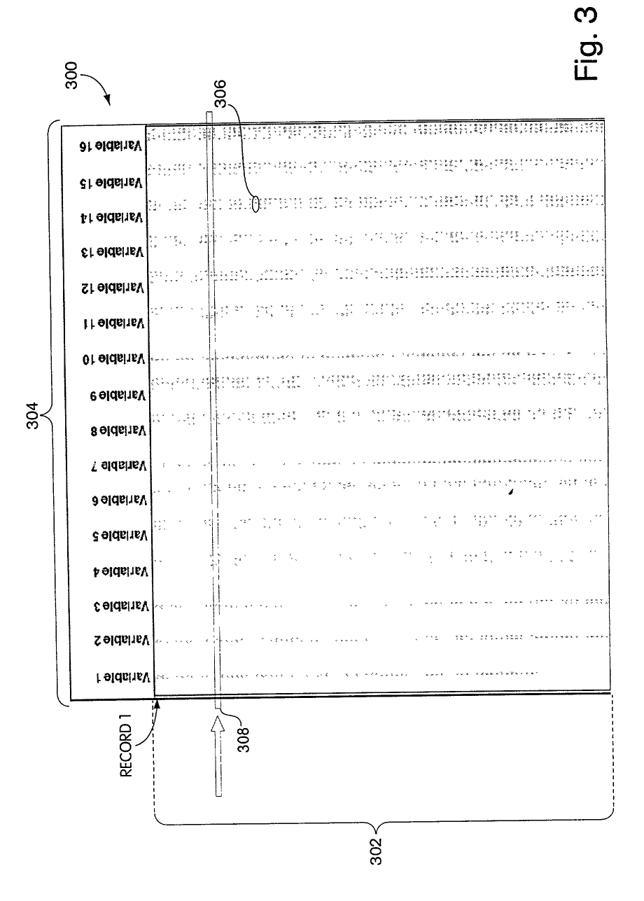

As indicated in step 208, subsequent to result-effective attribute subset identification, the illustrative data analysis system 100 constructs one or more classifiers. Classifiers are relationships, such as equations or regions of a visual display, that yield a result which classifies a study object as belonging to (or not belonging to) a particular category or class. By way of example, one category might be individuals likely to respond to a particular treatment, while another category might be individuals not likely to respond to the treatment. By way of a further example, the categories may be whether a chemotherapy agent is likely to be effective for a particular illness or in a particular patient. The illustrative system 100 determines categories for a particular record set by processing the result-effective subset of attributes for the record set according to the constructed classifier. As described in further detail below with respect to FIGS. 3-15, the attribute reduction subsystem 102, the record categorization subsystem 104, or the data processing algorithms 108, individually, in combination, automatedly or with operator interaction, may perform the classifier construction of step 208.

As indicated at steps 210 and 212, the illustrative data analysis system 100 next tests the one or more result-effective attribute subsets and the one or more classifiers to determine the best subset/classifier combination for dividing the records into the two or more categories of interest. According to the illustrative embodiment, the data analysis system 100 employs training data about which record category information is known to determine the best subset/classifier combination. Next, as indicated at 214, the data analysis system 100 employs the best subset/classifier combination of steps 210 and 212 to analyze test data about which record category information is not known.

Presented below are more detailed illustrative descriptions of the attribute reduction subsystem 102, the record categorization subsystem 104, the data processing algorithms 108 and the GUI 106 of the illustrative data processing system 100.

Attribute Reduction Subsystem

As mentioned above, according to the illustrative embodiment of the invention, the attribute reduction subsystem 102 processes a set of records and related attributes to determine a result-effective subset of the attributes. According to the invention, the values and/or occurrence (collectively “values”) of the result-effective attribute subset, when taken in combination, are sufficient to divide the set of records into at least two categories. According to one preferred embodiment, the attribute reduction subsystem 102 arranges the records and attributes in a multi-dimensional spatial array along separate vectors. More particularly, in the illustrative embodiment, the attribute reduction subsystem 102 arranges the records and attributes in a tabular form, similar to a spread sheet, with each row representing a record and each column representing an attribute. However, it should be noted that in other embodiments, the data set may be pivoted such that each row represents an attribute and each column represents a record.

FIG. 3 depicts a table 300 showing how the attribute reduction subsystem 102 of FIG. 1 initially organizes records and attributes for processing according to one illustrative embodiment of the invention. The table 300 may include n rows and m columns, where m and n are not necessarily equal. In the particular example of FIG. 3, the table 300 depicts 16 columns and 91 rows. The table 300 assigns each record 302, about which the table 300 contains information, to a row, and assigns each attribute 304 (illustratively represented by variables 1-16), about which information has been collected for each of the records 302, to a column. The table 300 also includes values 306 stored in cells of the table 300. The values 306 indicate either the value, presence or absence (collectively “value”) of each attribute 304 for each record 302. The table cells are illustratively identified by two integer coordinates in the form (row, column). By way of example, the value of attribute 1 for record 1 is represented in the cell (1,1). However, skilled artisans will appreciate that in alternate embodiments, the positioning of the records 302 and the attributes 304 may be reversed.

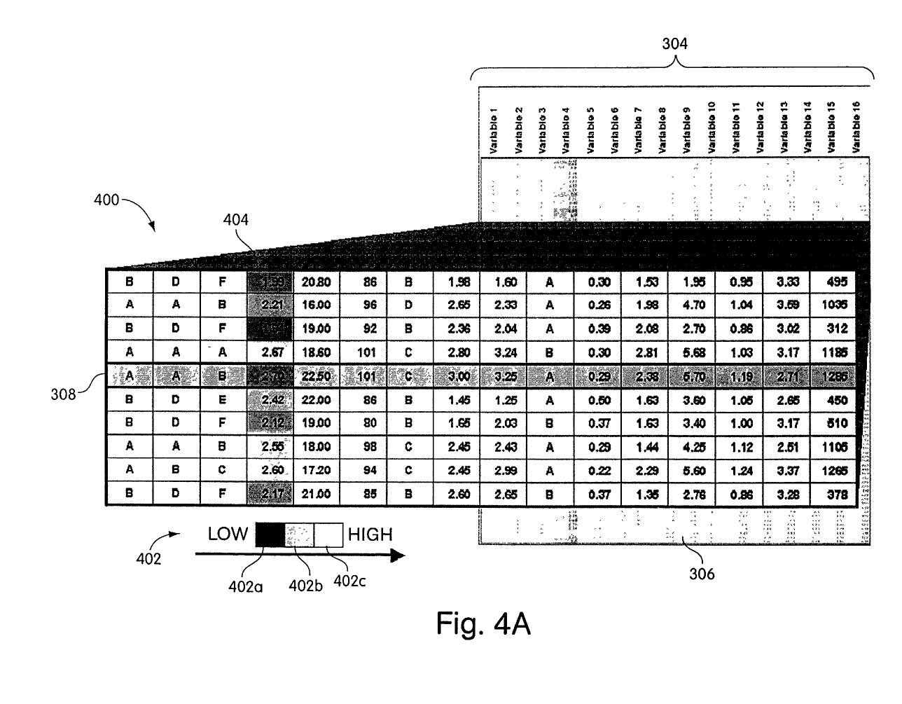

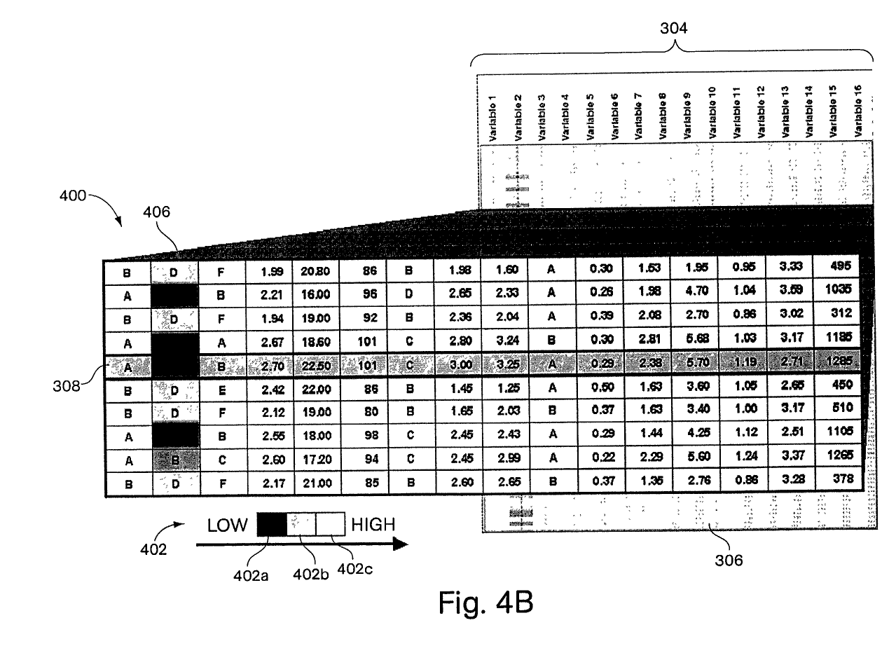

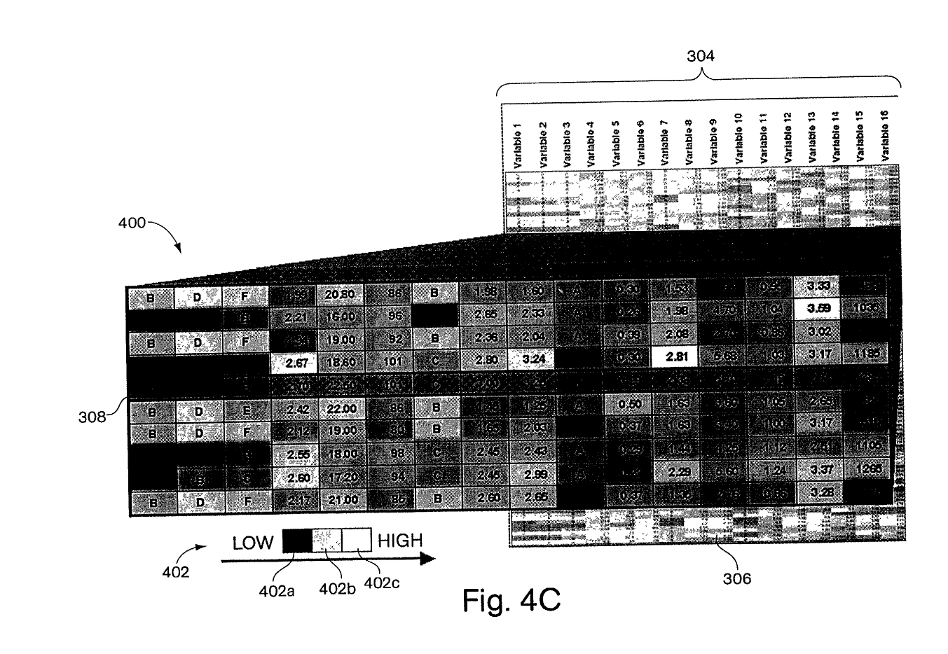

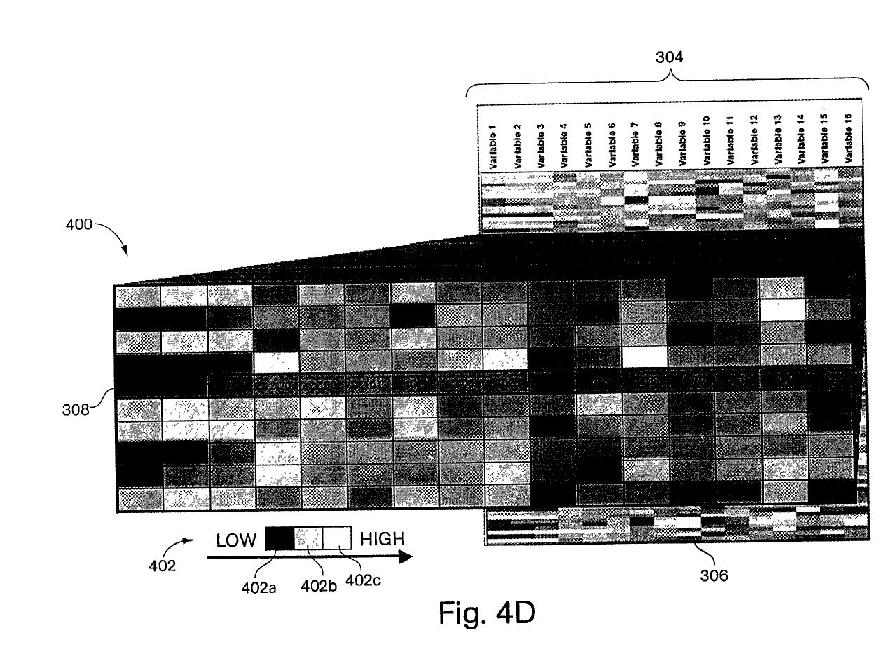

According to the illustrative embodiment, the attribute reduction subsystem 102 assigns the values 306 according to a binning procedure. The binning procedure may have any number of discrete values, or gradations. As discussed in further detail below with respect to FIGS. 4A-4D, the illustrative attribute reduction subsystem 102 displays graphical representations of the table 300 to an operator during the attribute reduction process by way of the GUI 106.

Illustratively, the attribute reduction system 102 represents each of the values 306 of a bin by a graphical indicator, such as a color, a symbol, an integer, a gray scale, combination thereof, or another readily recognized visual representation. According to one feature, the attribute reduction subsystem 102 employs relatively few bin gradations (e.g., 2, 3 or 4) to enable the operator to more easily recognize patterns in the graphical representation displayed by the GUI 106. For example, in the illustrative embodiment, the attribute reduction subsystem 102 may employ a graphical indicator having three gradations, in which each indicator is displayed by the GUI 106 as a different color, gray scale, numerical value or other symbol that takes advantage of the pattern recognition abilities of the visual cortex of the human brain.

According to the illustrative embodiment, the attribute reduction subsystem 102 employs two approaches for specifying the individual table 300 cells: single value and multiple values. In the format, a one-to-one map exists between the two-dimensional table values 306 and the table 300 visualization cells, each cell filled by a single symbol representative of the associated value; here each display cell is described as a region of pixels that can range in size from one pixel square to hundreds of pixels all of the same color or gray scale. On standard workstation displays, the illustrative attribute reduction subsystem 102 can display, via the GUI 106, over one million values using one-pixel/single-color or gray scale display cells. For the latter case of multiple values per cell, each table 300 cell is displayed as a unique color icon encoding several table values 306. A color or gray scale icon is illustratively defined as a rectangular pixel region for which the color or gray scale is defined by various interpolation procedures. These two representational approaches are not mutually exclusive. That is to say, a single table 300 may be defined to contain cells of either type.

The illustrative attribute reduction subsystem 102 uses rectangular pixel regions using the single value/single color or gray scale methodology. However, in other illustrative embodiments, visualizations can also be generated with cells of arbitrary size and shape. Depending on the desired output, non-rectangular shaped cells, such as stick figure-based or grammar-based icons, can be beneficial. By way of example, a table visualization defined by variable shapes and sizes with color and/or gray scale can encode three continuous values as opposed to just the one value commonly associated with standard heatmaps and single color scales. As an example a pixel can be represented as 24 bits, it could be encoded as three 8 bit binned values from three attributes.

In order to support table 300 visualizations of more than a few thousand columns and rows, the attribute reduction subsystem 102 employs various data encoding techniques. Examples of such techniques include overwriting, skipping and averaging. In this section the term rendering is defined loosely to mean any form of graphic procedure by which data values 306 are converted into graphic objects, either in computer memory or directly onto a display screen. According to the illustrative embodiment, the first and default method for displaying a larger number of values within a small display space is to perform graphic overwriting, that is the complete number of columns or rows is mapped to a fixed number of pixels (here the number of values is larger than the number of pixels). During the rendering process multiple values are written to the same pixel(s), display region, and only the final value's representation is displayed. Although the attribute reduction subsystem 102 in conjunction with the GUI 106 render the entire data set, only those values 306 drawn last are actually displayed.

An optimization for overwriting is skipping, where instead of rendering all the columns and records to the display, only those values that will actually be displayed are selected. In other words, the operator, through the attribute reduction subsystem 102, defines the number of columns and records to be skipped, not to be displayed, along with a starting position for the first column and record. Alternatively, the operator defines a fixed display region along with the desired cell size from which the attribute reduction subsystem 102 can determine the appropriate number of columns and rows to skip. For very large data sets, this second methodology results in a significant performance increase.

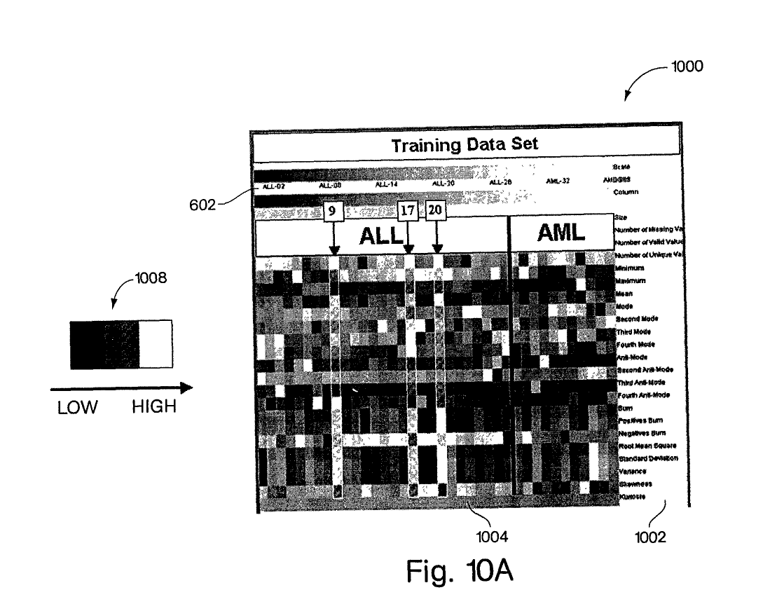

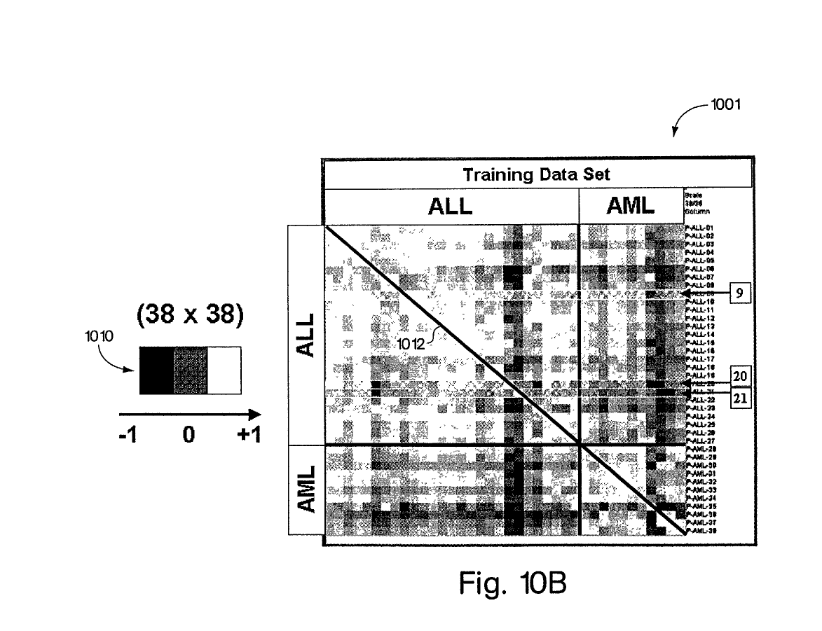

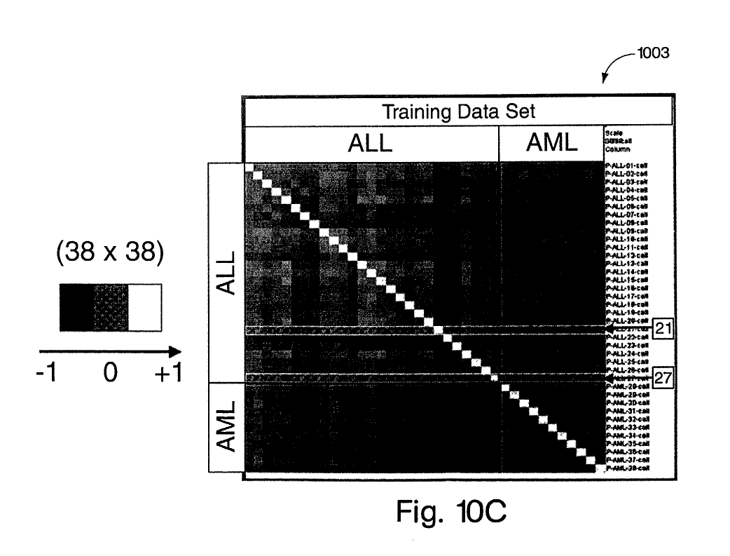

The third approach, termed averaging, like the overwriting method, entails reading all of the column and record values, but rather than displaying only the final values, the record reduction subsystem 102 computes and displays the average value for the overlapping collection of column or record values. In addition, as discussed below with respect to FIG. 10A-10C, the attribute reduction subsystem 102 also displays other statistical values including the maximum, minimum, mode, and median. This method generates a display, such as the display 1000 of FIG. 10A, to summarize the data, but hides the details. In contrast, the overwriting and skipping provides a display of partial details and assumes the displayed data subset generalizes to the entire data set.

FIGS. 4A-4D are screenshots of the type displayed by the GUI 106 depicting a binning process according to an illustrative embodiment of the invention with respect to a magnified view 400 of a portion of the table 300 in proximity to the record 308. As shown in FIG. 4A, the illustrative attribute reduction subsystem initially formats the attributes (e.g., variables 1-16) 304 as alphanumeric values in the table 300. In the illustrative embodiment, numeric values represent an expressed quantity with respect to particular attributes 304. By way of example, the numeric values in FIG. 4A represent levels of expression of particular genes. Alphabetical characters represent classifications with respect to particular attributes/variables. By way of example, in FIG. 4A, the variable 1 alphabetical value may identify from which of a plurality of hospitals the data came. In the illustrative embodiment, the attribute reduction subsystem 102 employs a three level gray scale 402 to indicate whether a particular attribute value 306 is considered to be low (dark gray/black 402a), medium (medium gray 402b) or high (light gray 402c). As shown at 404, a value of 1.94 for attribute 4 is considered to be low, while a value of 2.42 is considered to be medium and a value of 2.67 is considered to be high. As shown at 406 in FIG. 4B, the value D for attribute 2 is considered to be a high value, whereas the value A is considered to be a low value and the value B is considered to be a medium value. FIG. 4C depicts gray scale binning, along with the actual numerical values, for all of the values 308. FIG. 4D depicts the gray scale binning of FIG. 4C, as it would be displayed to an analyst, without numerical values present. Note that the number of bins may be different for each column.

Subsequent to binning, the illustrative attribute reduction subsystem 103 processes the records and binned attributes to determine a result-effective subset of attributes, the values of which, when taken in combination, are sufficient to divide the record set into at least two categories.

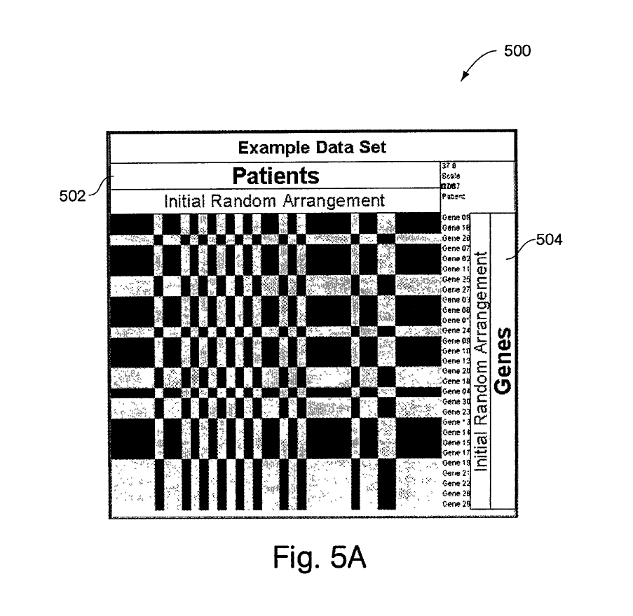

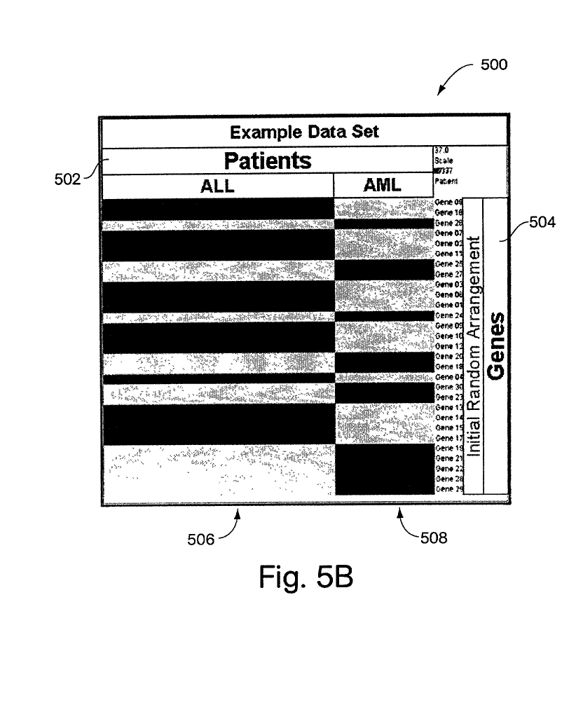

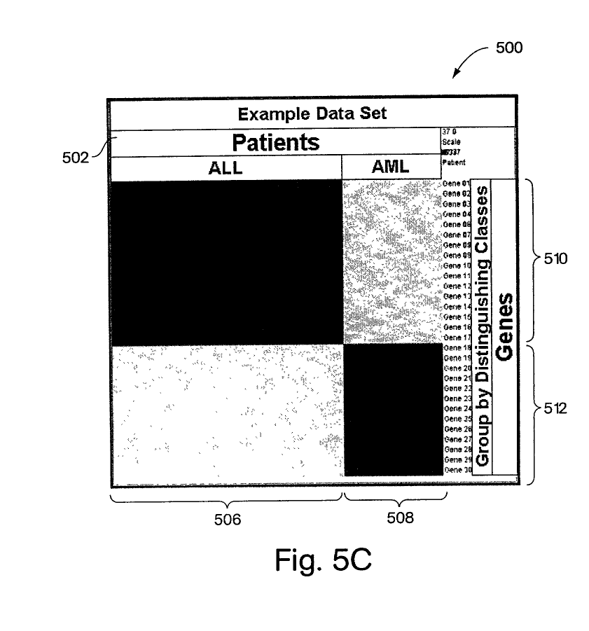

FIGS. 5A-5C are a series of display screens of the type generated by the GUI 106 depicting an attribute reduction process according to an idealized illustrative embodiment of the invention. Specifically, FIG. 5A is a display screen depicting a binned table 500 displaying idealized unsorted data for a group of records 502 (in this example patients) known to have either ALL- or AML-type leukemia. The table 500 of FIG. 5A assigns each record 502, about which the table 500 includes information, to a column, and assigns each attribute 504 (in this example gene expressions), about which information has been collected for each of the records 502, to a row. It should be noted that the data of FIG. 5A is pivoted with respect to the data of FIG. 3 (i.e., row and column assignments have been swapped). The table 500 employs two level gray scale binning, where dark gray/black indicates that a particular gene is not expressed for a particular patient and light gray indicates that a particular gene is expressed for a particular patient. Once the data is organized in a binned table, such as the table 500, the illustrative attribute reduction subsystem 102 begins attribute and/or record reordering to identify recognizable groupings or outliers of records and/or attributes. According to one feature, the illustrative attribute reduction subsystem 102 employs data processing algorithms in the form of computer programs that discriminate among patterns to select for display only patterns that meet some predefined criteria. In the illustrative embodiment, such predefined criteria may relate to classification and/or prediction.

According to the illustrative embodiment, the attribute reduction subsystem 102 provides a number of table layout attribute reduction features. These define the order of the columns and rows on the axes based on the data and operator options. One such illustrative feature is that the user can select individual columns and/or rows, or subsets of columns and/or rows, and move them via either drag-and-drop mechanisms or by predefined visualization operators (such as, for example, move up/move left, move down/move right, to top/to left, to bottom/to right, and invert). Another such feature is that the columns and rows can be set up randomly using a variety of distributions dependent on the data or operator-definable. A further such feature is that the attribute reduction subsystem 102 can sort the columns and rows on the axes using some specified ordering algorithm, including the application of a stable sort (a sorting algorithm that maintains previous sorts). According to another sorting feature, the attribute reduction subsystem 102 can perform a sum sort for rows, columns or both. Furthermore, groups of columns and/or rows can be defined and bound together for sorting and clustering methods. Another feature is that the columns and rows can be organized based on other computational algorithms.

Along with sorting features, the illustrative attribute reduction subsystem 102 also provides a number of clustering methods. By way of example, the attribute reduction subsystem 102 can apply a genetic algorithm to order the columns and rows based on some information-based fitness function. Additionally, a K-means algorithm can be applied on the columns and rows on the axes to identify similar columns and/or rows. A number of mathematical functions can be used to compare columns and/or rows including Pearson's correlation coefficients, Euclidean distances or other correlation functions.

According to another illustrative approach, the attribute reduction subsystem 102 considers class discrimination, where the attributes are ordered by their ability to distinguish classes based on some statistic or other metric. This statistic is operator selectable. According to one embodiment, for all h classes and n attributes, an h by n matrix of statistics is computed which gives an indication of how well attributed j discriminates class i from all of the other classes. In one example we use the class of the maximum value which gives a class assignment for the attribute; the “discrimination level” (the difference between the maximum value and the next largest value) which gives a measure of the attribute's effectiveness for that single class; and the range (the difference between the maximum and minimum values) which gives an overall measure of an attribute's effectiveness in distinguishing classes. Selected attributes are sorted first by discrimination level, and then (using a stable sort) by class assignment. The resulting order determines the table layout. For more than two classes, the illustrative attribute reduction subsystem 102 permutes the order of classes. Another technique uses computations of pairwise class discrimination values for each attribute. Another technique uses alternative metrics.

According to a further approach, the illustrative attribute reduction subsystem 102 employs the novel principal uncorrelated row sorting (PURS) algorithm, the principal uncorrelated column sorting (PUCS) algorithm and/or the super sort algorithm, all of which are discussed in detail below with respect to FIGS. 7-9 to manipulate the rows and/or columns of the table 600 to identify a result-effective subset of attributes.

According to the illustrative embodiment of FIGS. 5A-5C, the attribute reduction subsystem 102 is used to process training data (e.g., the records are known to divide into two or more known categories). Referring to FIG. 5B, the illustrative attribute reduction subsystem 102 first sorts the data of table 500 by patient until patients having the same gene expression levels are grouped and the gene expression level groups are divided by those patients 502 having ALL-type leukemia, and those patients 502 having AML-type leukemia. Referring to FIG. 5C, in this idealized example, the attribute reduction subsystem 102 then sorts based on attribute values 504 inside of each group 506 and 508 to group genes having the same expression level. As shown in the completely sorted view of FIG. 5C, in the idealized example, expression of genes 1-17 form a result-effective subset 510, the presence of which is indicative of AML-type leukemia. Similarly, genes 18-30 form a result-effective subset 512, the presence of which is indicative of ALL-type leukemia. Both sets 1-17 and 18-30 look promising as forming a result-effective subset of genes to differentiate between AML- and ALL-type leukemia.

A feature of the illustrative embodiment is that the result-effective subsets identified by the attribute reduction subsystem 102 may be used either to diagnose or to predict the possible future occurrence of either ALL- and AML-type leukemia. Such predictive capabilities render the attribute reduction subsystem 102 a powerful tool in such other fields as geology (e.g., resource discovery, earthquake occurrence prediction and volcano activity prediction), biology (e.g., genomics, proteomics and metabolomics) and chemistry (e.g., toxicology and efficacy prediction).

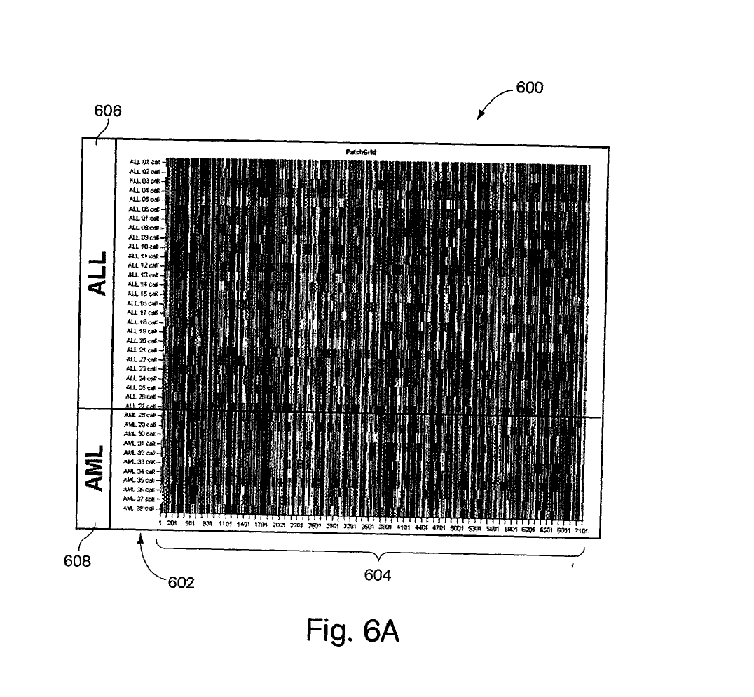

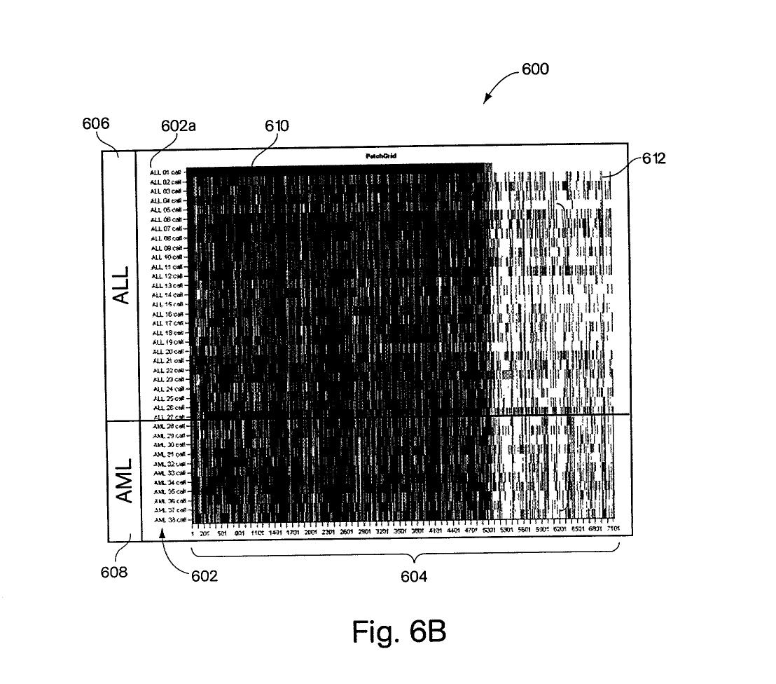

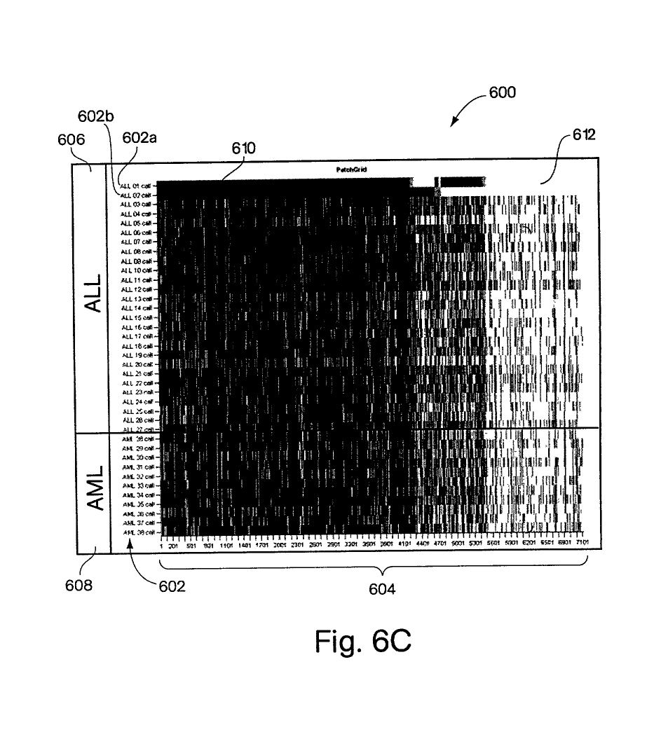

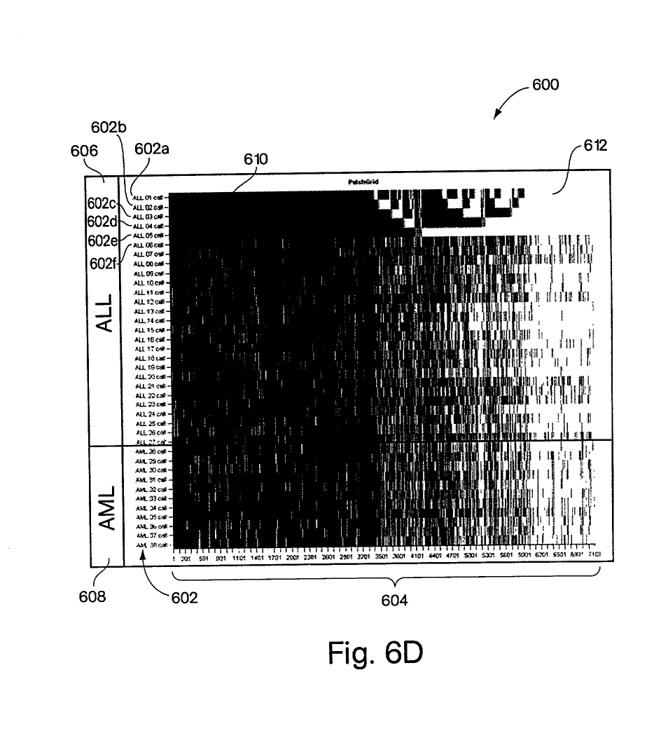

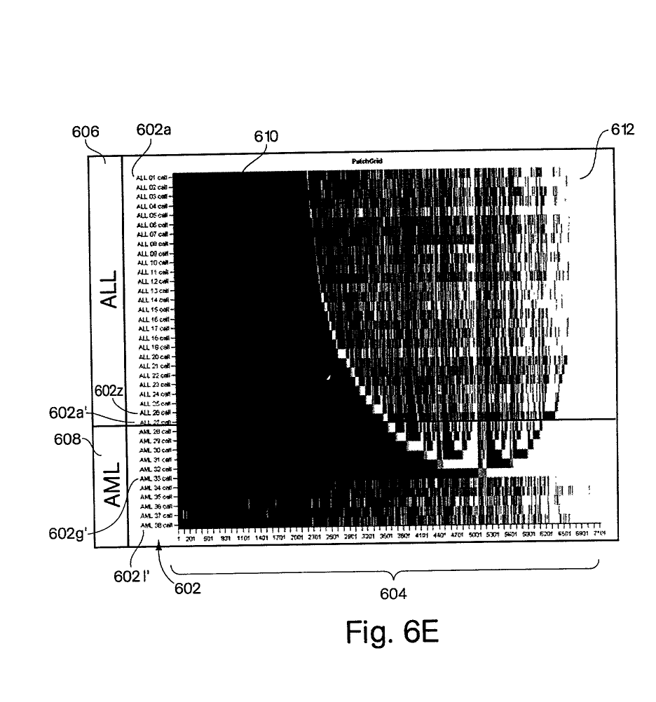

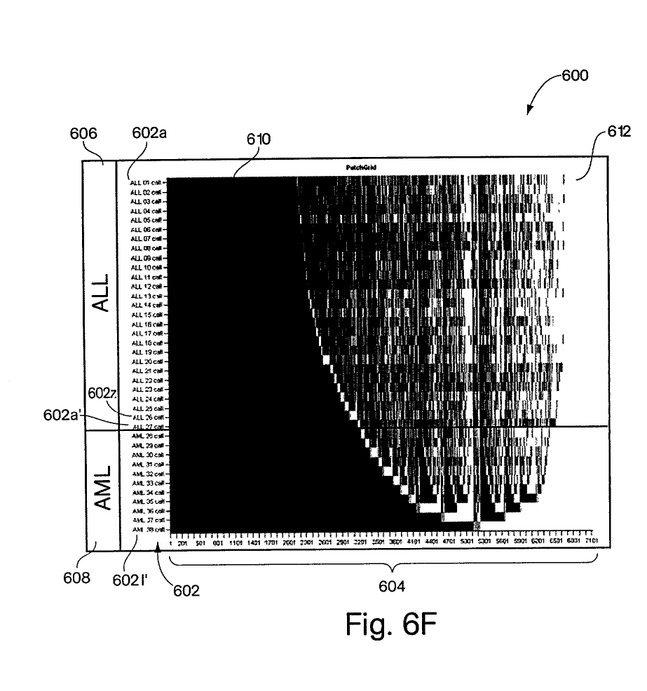

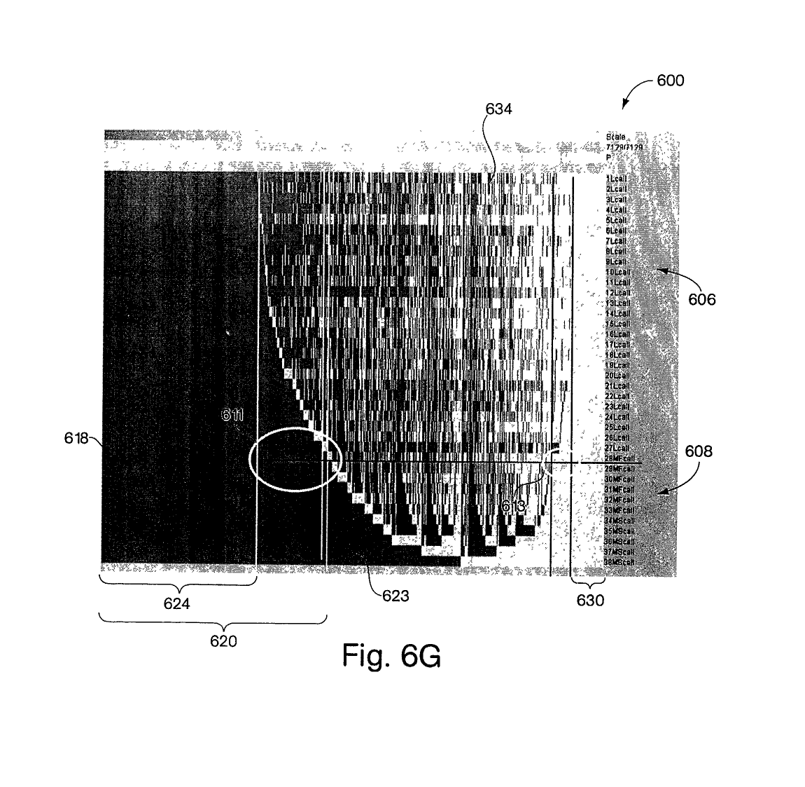

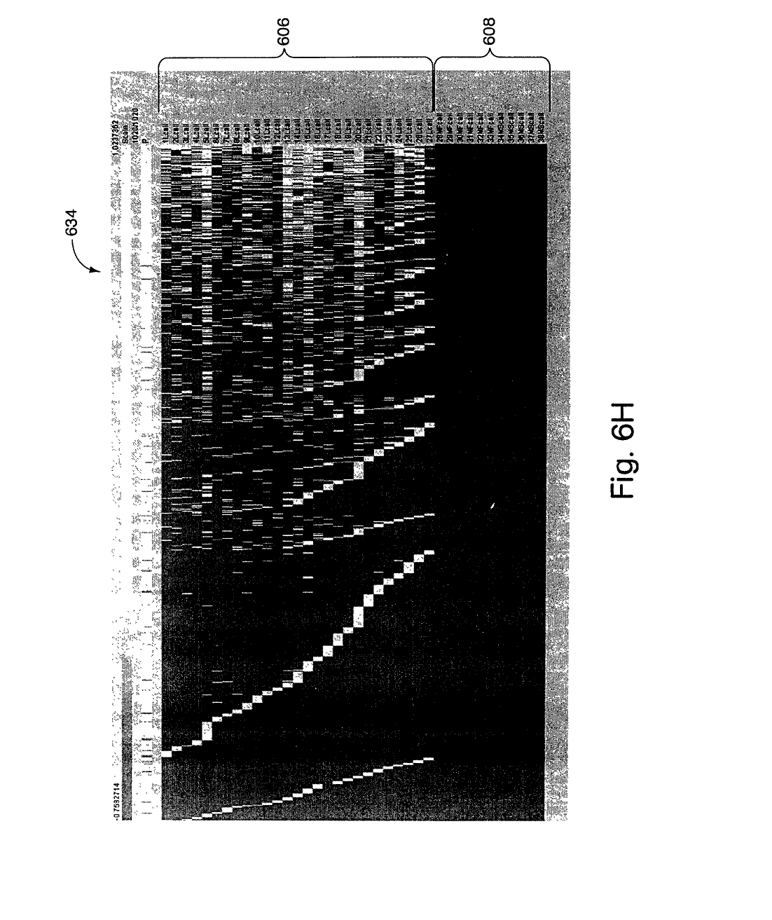

As mentioned above, the illustrative example of FIGS. 5A-5C depicts an idealized case. In reality, data collected does not divide so neatly into categories. Accordingly, FIGS. 6A-6G show a series of display screens, of the type generated by the GUI 106, depicting operation of the illustrative attribute reduction subsystem 102 with respect to an actual data set.

More specifically, FIG. 6A is a display screen showing a binned table 600 displaying actual data for 7101 attributes 604 (in this example genes) associated with 38 records 602 (in this example patients) known to have either ALL- or AML-type leukemia. The data set of FIG. 6A is the Golub, Slonim, et. al. Gene Expression data set (referenced as Golub and Slonim data set), available from The Whitehead Institute of Cambridge, Mass. and referenced in the seminal paper Golub, T. R., Slonim, D. K., Tamayo, P., Huard, C., Gaasenbeek, M., Mesirov, J. P., Coller, H., Loh, M. L., Downing, J. R., Caligiuri, M. A., Bloomfield, C. D., Lander, E. S. (1999): Molecular Classifications of Cancer: Class Discovery and Class Prediction by Gene Expression Monitoring, Science, Vol. 286, October, 531-537. In FIG. 6A, the attribute reduction subsystem 102 assigns each of the individual patients 602 to a row and each of the specific genes 604 to a column, and initially sorts the data based on which type of leukemia (AML or ALL) each patient 602 has. The ALL-type leukemia patients 606 are located at the top of the table 600 and the AML-type patients 608 are located at the bottom of the table 600. Each expression value is binned as one of three possible values: dark gray/black corresponding to absent; medium gray corresponding to marginal; and light gray/white corresponding to present. The Affymetrix™ gene set provides a numerical value for the expression of some chemical, such as a protein, associated with a specific gene. For each gene 604, a numerical value greater than a first threshold corresponds to the presence of the gene (or its effect) and less than a second threshold corresponds to the absence of the gene. A numerical value falling between the thresholds corresponds to a marginal result. The attribute reduction subsystem 102 assigns the gray scale indicators accordingly. In FIGS. 6B-6F below, the attribute reduction subsystem 102 performs a stable sort on the table 600. This means that if the value for two genes are the same, then which ever way they were previously sorted, will be the new sort order. If each column is sorted in this way, the butterfly pattern of FIG. 6F emerges. According to one feature of the invention, the attribute reduction subsystem 102 performs a stable sort of all columns automatically in a single step.

FIG. 6B is a display screen showing a first intermediate state of the table 600 subsequent to sorting on a first dimension (gene expression) within each patient type (ALL type leukemia 606 and AML type leukemia 608). In the instant example, sorting on a first dimension involves selecting a gene 604 as a starting point and any of the sorting algorithms discussed herein until patients having the same expression for that gene within the AML and ALL categories are grouped. As can be seen in FIG. 6B, sorting on the first dimension (602a) begins to show a true negative gene expression region 610 and a true positive gene expression region 612. FIG. 6C is a display screen showing a second intermediate state of the table 600 subsequent to the illustrative record categorization subsystem 102 sorting on two dimensions (gene expressions) 602a and 602b. Similarly, FIG. 6D is a display screen showing a third intermediate state of the table 600 subsequent to the attribute reduction subsystem 102 sorting on six dimensions 602a-602f; FIG. 6E is a display screen showing a fourth intermediate state of the table 600 subsequent to the attribute reduction subsystem 102 sorting on thirty-three dimensions 602a-602g′; and FIG. 6F is a display screen showing a final sorted state of the table 600 subsequent to the attribute reduction subsystem 102 sorting on all thirty-eight dimensions 602a-602l′ (i.e., patients). As can be seen in FIG. 6F, the region of true negatives 610 and the region of true positives 612 are both easily discernable subsequent to the attribute reduction subsystem 102 sorting on all thirty-eight of the patients 602. However, it is the regions along the borders of the true positive and true negative outcomes that is interesting with respect to determining a result-effective subset of attributes for further processing. The significance of the information contained in FIG. 6F is more clearly depicted in FIG. 6G.

FIG. 6G shows a display screen of the type generated by the GUI 106, depicting differential gene expression information of FIG. 6F, but showing cursor tools, such as the circles 611 and 613, to highlight relevant information. The demarcation line 618 shows the division between the patients 602 known to have ALL-type leukemia 606 and AML-type leukemia 608. As shown, the genes 624 falling within the demarcation box 614 show true negative for both ALL and AML and therefore do not provide a result-effective subset of genes, the expression of which can be used to distinguish between the two classes. Likewise, the genes 630 falling within the demarcation box 628 show true positive for both types of leukemia and therefore do not provide a result-effective subset of genes, the expression of which can be used to distinguish the two classes.

Genes that are always absent or always present in all patients in either leukemia class are of little interest in creating a predictor for which type of leukemia a person may have a propensity. Those genes that are positioned at the absent/present boundaries, such as the ragged curved boundary 623, or the ALL/AML boundary 618 are good candidates for predictor selection. The circle cursors 611 and 613 enclose boundary gene sets that may provide candidates for predictor selection.

The attribute reduction subsystem 102 includes a number of novel panning and zooming mechanisms that make it easier for the operator to interact and find patterns within the data. According to the illustrative embodiment, the attribute reduction subsystem 102 provides the operator with rendering commands such as table width, table height, width skip factor, height skip factor, starting column/ending column/active columns, and starting record/ending record/active records. Additionally, starting from a GUI display screen for the attribute reduction subsystem 102, the operator can pan and zoom by adjusting these controls and thus reveal more details within the data set by viewing less of the whole data set. The invention also provides an interactive viewing filter. The filter defines variable skip values within a single table display, enabling dynamic detail views without loss of the global data view. Consequently, regions of interest will have a skip value less than the surrounding skip values, meaning more of the actual data is displayed relative to the number of values used outside the area of interest.

Along with these features, the attribute reduction subsystem 102 also includes the following set of user-selection operators. These include point and rectangular selection devices, support for multiple selected regions, Boolean selection operators, and selection inversion. In support for selection, the attribute reduction subsystem 102 also includes a probing mechanism to reveal the underlying data within a selected binned region.

From the display 600 one can easily select the “all absent” genes 624 or “all present” genes 630 for further analysis or deletion. Additionally, a unique “drill down” mechanism can be used to expand the region 634. The region 634 is expanded in FIG. 6H. After expansion, a sum sort is done on the data to get the genes that are all absent (dark gray) in one group of columns (one class) and mostly present (light gray) in another group of columns sorted to the right. The sum sort works by taking the sum of all attribute values and sorting from low to high (left to right). In this example, the genes selected on the right of the display can be used to discriminate multi-class problems. In the same manner three other combinations of absent-present genes may be selected to help discriminate normal from disease tissue. The binary-tertiary sorting and display of the attribute reduction subsystem 102 can be extended to n-ary data and other sorting mechanisms used.

The illustrative data processing system 100 uses predictors (e.g., a result-effective attribute subset) to express records in terms of associated attribute values. Highly correlated attributes add little to such an express record. In the event that a number (p) of attributes are highly correlated, it is useful to select a single attribute from the set of (p) attributes to use as a surrogate for all of the (p) attributes in a predictor. A significant problem that arises when the number of available predictors is large (e.g., the 6817 genes of the Affymetrix™ data set) is that the mathematical burden of performing a correlation between every possible pair of predictors (e.g., attributes) is to find a result-effective subset of uncorrelated predictors.

According to the illustrative embodiment, the PURS and PUCS algorithms eliminate highly correlated attributes, organized as either columns (PUCS) or rows (PURS) of a data set, such as the data set of FIG. 3, in an automatic and incremental fashion. Since the methodology of PURS and PUCS is essentially the same except that one reduces rows and one reduces columns, only the PURS algorithm is described below in detail.

In an illustrative overview, an operator selects a correlation threshold, incremental threshold, and the number of records desired from the data set. PURS then generates a number of random selections of rows and eliminates the rows that correlate by higher than the threshold value to the random selections. If no rows are eliminated, PURS reduces the correlation threshold by the incremental value and repeats the procedure until the desired number of rows remain. If the incremental threshold is 0, then the analysis and elimination stops when no rows higher than the initial threshold are found. The reduced data set provides a result-effective subset of the original data set and is used, as described above, in clustering, classifying and other data mining techniques.

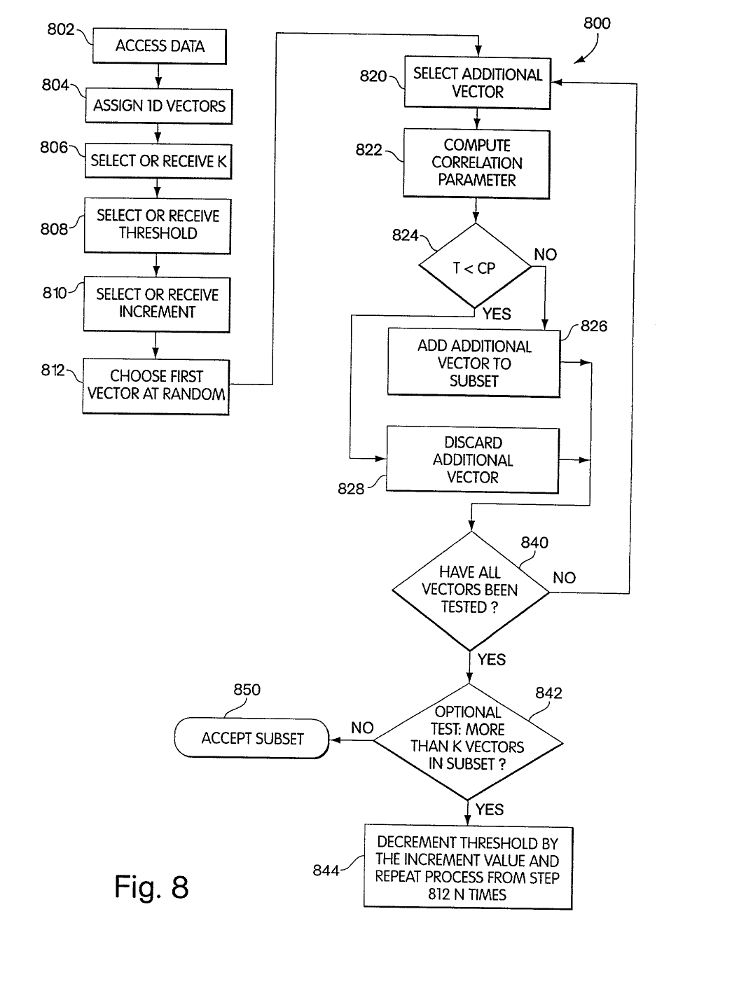

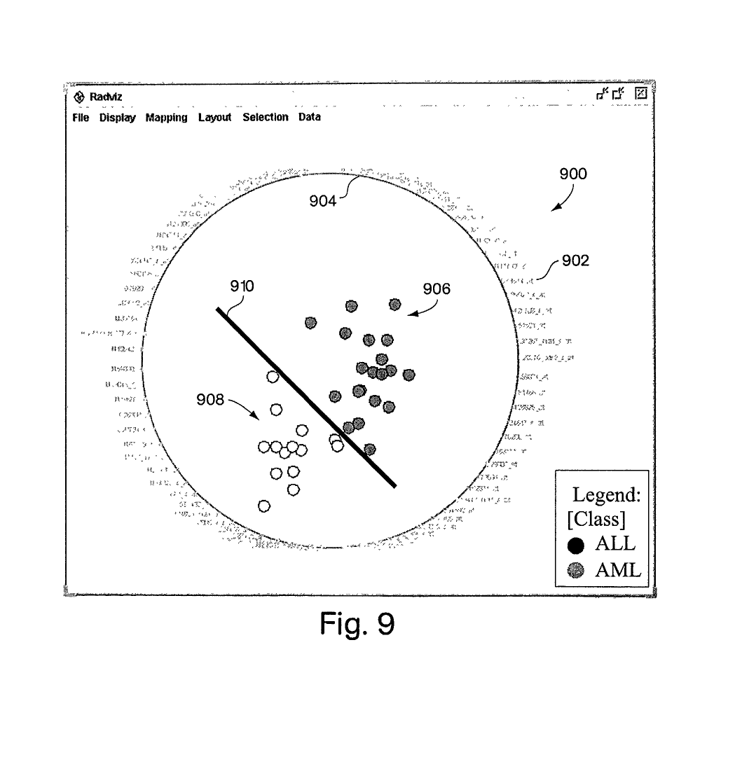

FIG. 7 shows a display screen 700 of the type generated by the illustrative GUI 106 for enabling an operator to control aspects of PURS. To use PURS, the operator first selects a data set to be processed, such as the data set of FIG. 3. The operator then selects a correlation threshold 702, which is a numerical value between 0 and 1. In FIG. 7, the value indicated is 0.5, which is a fairly low correlation coefficient. The GUI 106 also enables the operator to either accept a computer selected increment value 704 or to enter the value 704 in the screen 700. Use of the increment value 704 is explained in further detail below with respect to FIGS. 8 and 9. A value of 0 for the increment 704 is depicted in FIG. 7. The GUI 106 further enables the operator either to enter a record count value 706 or to accept a computer selected record count value 706. Use of the record count value 706 is discussed in further detail below with respect to FIGS. 8 and 9. A default value of 10 for the record count 706 is depicted in FIG. 7. The buttons 708 and 710 enable the user to either accept the selected parameters and begin PURS processing or cancel the analysis, respectively.

FIG. 8 is a schematic flow diagram depicting a specific illustrative embodiment of PURS. As indicated in step 802, PURS accesses a data set of the type described with respect to FIG. 3. As indicated in step 804, PURS assigns as a class of vectors a selected one of the records and the attributes of the data set. As indicated in step 806, PURS selects, or receives from the operator, via the screen of FIG. 7, an integer value K for the record count 706, where K is a maximum number of uncorrelated vectors to be identified from the class of vectors. As indicated in step 808, PURS further selects, or receives from the operator, via the screen 700, a start threshold value 702. As indicated in step 810, PURS also selects, or receives from the operator, via the screen 700, an increment value 704. As indicated in step 812, PURS chooses, substantially at random, a first vector from the class of vectors as a member of an uncorrelated set of vectors.

Next, PURS iteratively performs the following steps until all vectors in the class of vectors are analyzed. First, as indicated in step 820, PURS selects an additional vector from the class of vectors, again substantially randomly. As indicated at step 822, PURS then computes a correlation parameter between the first vector and the additional vector. As indicated in step 824, PURS then compares the correlation parameter to the threshold value. As indicated at step 826, PURS adds the additional vector to the uncorrelated set of vectors if the correlation parameter is not greater than the threshold value, so as to determine a set of vectors that are uncorrelated. PURS then proceeds to step 840. Alternatively, if the correlation parameter is greater than the threshold value, at step 828 PURS discards the additional vector and then proceeds to the decision block 840.

Next, as indicated at step 840, PURS determines if the entire set of vectors has been examined. If the entire set of vectors has not been examined, PURS returns to step 820 to test another vector. If the entire set of vectors has been examined, PURS determines, as indicated at decision diamond 842, whether there are more than K vectors in the subset of uncorrelated vectors. As indicated at decision diamond 842, if there are more than K vectors in the subset, PURS subtracts the increment 704 from the threshold 702 and repeats N number of times, the steps from: choosing a first vector in step 812 to the end of the process. Alternatively, if there are K or fewer vectors in the subset of uncorrelated vectors, PURS ceases testing for additional vectors and accepts the subset of K or fewer vectors as the set of attributes to use in further data analysis, as indicated in step 850.

If PURS repeats the analysis N times, the following steps take place. PURS determines N sets of vectors that are uncorrelated, and determines whether there are K or fewer vectors in any of the N sets, so as to determine an uncorrelated set of vectors having no more than K members. In some embodiments, K is 10, as indicated by the value 706 of screen 700.

If the number of uncorrelated vectors is too large, for example greater than K, PURS optionally perform further analysis. Alternatively, upon a determination by PURS or the operator that no set of uncorrelated vectors has no more than K members, PURS reduces the threshold value 702 by the increment value 704 and repeats the steps 812 through 828.

PURS can further execute the steps of determining whether there are more than K vectors in the set of uncorrelated vectors (step 842), and if there are more than K vectors in the set, repeating an integer M number of times, the steps from: selecting the threshold value (step 808) through keeping or discarding the vector analyzed based on the result of the calculation (steps 826 and 828).

Thus, according to the illustrative embodiment, PURS determines M sets of vectors that are uncorrelated and determines whether there are K or fewer vectors in any of the M sets, so as to determine an uncorrelated set of vectors having no more than K members.

As an indication of the efficacy of the illustrative PURS methodology described above, FIG. 9 shows an illustrative radial visualization 900 of the type described in detail below with respect to the record categorization subsystem 106 and FIGS. 12A-12C. The records are plotted using a result-effective seventy-six gene subset of the above mentioned 6817 gene Affymetrix™ data set identified by the PURS algorithm. As in the case of FIGS. 12A-12C described below, the attributes 902 are plotted along the periphery of a circular locus 904. As shown, using the seventy-six gene subset identified by the PURS algorithm, the record categorization subsystem 104 cleanly divides the records 906 representing ALL patients (filled circles) and the records 908 representing AML patients (open circles) along the classifier 910.

One way the data analysis system 100 and related methods of the invention depart from conventional systems is by performing an exploratory overview of the data under analysis. By way of example, according to the illustrative embodiment, the system 100 examines statistical metadata for the data set under analysis. The system 100 then employs the GUI 106 to portray the statistical metadata to an operator. The system 100 then employs the attribute reduction subsystem 102 (discussed above), the record categorization subsystem 104 (discussed in more detail below with respect to FIGS. 12A-16) and data processing algorithms 108 (discussed in more detail above with respect to FIGS. 7-10 and below with respect to FIG. 12C) to enable the operator to interactively manipulate and analyze the metadata and to generate subsequent information regarding the data set under analysis.

FIG. 10A shows a display screen 1000 of a statistical metadata visualization according to an illustrative embodiment of the invention. In this example, the statistics 1102 about gene expression levels for each of the thirty-eight patients 602 of FIG. 6A are displayed in relative comparison. Standard statistical measurements, such as for example, the number of missing values, the number of valid values, the number of unique values, minimum, maximum, mean, mode, second mode, third mode, fourth mode, anti-mode, second anti-mode, third anti-mode, fourth anti-mode, sum, positives sum, negatives sum, rout mean square, standard deviation, variance, skewness, kurtosis, thresholding, filtering and the like are shown in the display of FIG. 10A. As in the above described examples of the illustrative attribute reduction subsystem 102, in the display of FIG. 10A, values of each patient across each statistic are binned into three gray scale levels 708 (dark gray/black—low, medium gray—medium, and light gray/white—high).

From the display of FIG. 10A, an operator may observe particular patients who have statistics that deviate significantly (e.g., either having higher or lower values) from the norm. By way of example, in FIG. 10A, one observes that samples 9, 17 and 20 have constantly higher values for substantially all of the statistics. Thus, this analysis indicates that samples 9, 7 and 20 should be tracked for interesting or deviant contributions to results, including category separation, as analysis progresses. If these samples significantly influence results, it may also indicate that the operator should repeat the analysis omitting samples 9, 17 and 20.

FIG. 10B is another exploratory overview display screen 1001 showing gray scale binned values for the Pearson Correlation Coefficient for the gene expression level for each pair wise set (i.e., 1 and 2, 1 and 3, 2 and 3, 1 and 4, . . . 37 and 38) of the thirty-eight patients 602 of FIG. 10B. Correlations are colored on a range 1010 of strong negative (dark gray/black) to strong positive (light gray/white), with the expected 1:1 perfect correlation running down the diagonal 1012. As indicated in FIG. 10C, samples from patients 9, 20 and 21 stand out as having an abnormally low correlation with other patients, and thus should be tracked further.

FIG. 10C is an additional exploratory overview display screen 1003. The visualization of the screenshot 1003 is essentially the same as that of FIG. 10B, with the exception that the gene expression levels have been discretized, categorized or binned into absent, marginal or present by an Affymetrix™ algorithm. As can be seen, applying the Affymetrix™ binning alters the interpretation of the data, as potentially would any thresholding, filtering or binning applied to the raw data. However, according to the illustrative embodiment, the data analysis system 100 can employ any such method, as desired, to pre-process data. As shown, the preprocessing patients 21 and 27 stand out as having an abnormally low correlation with other patients, and thus are candidates for further tracking. This shows how data processing and transformation (binning) along with the Metadata coefficients can find additional suspect samples. Patient 27 will be added to the candidates for further tracking. This tracking will be useful in identifying problematic data, patterns, or structures discovered that include or involve the candidate tracked patients.

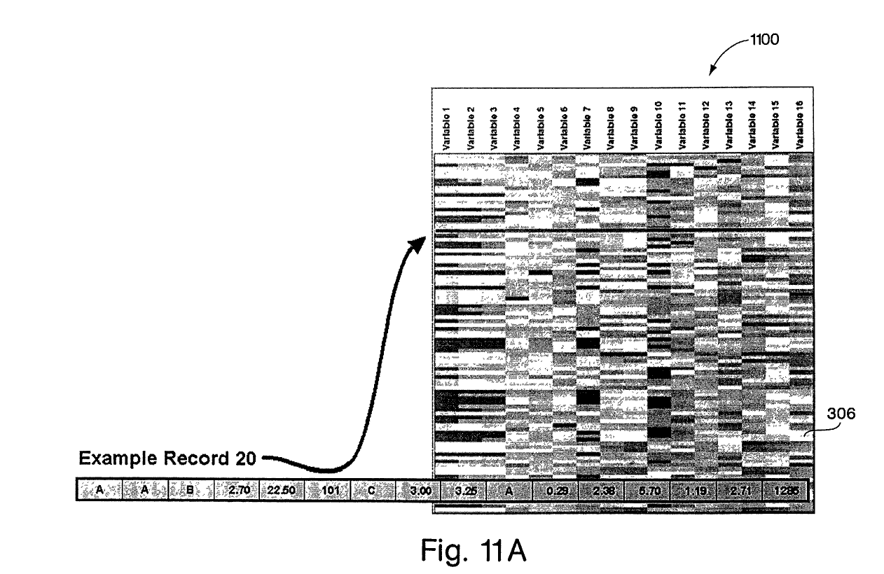

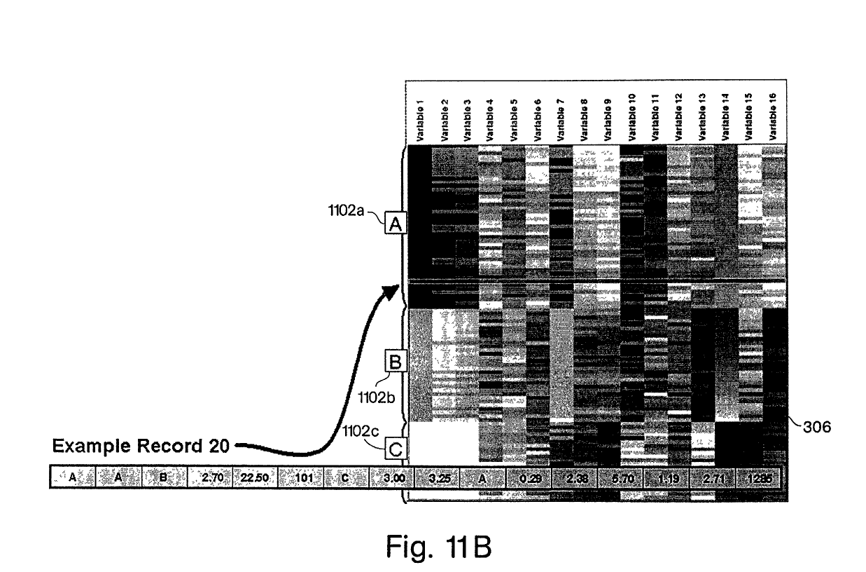

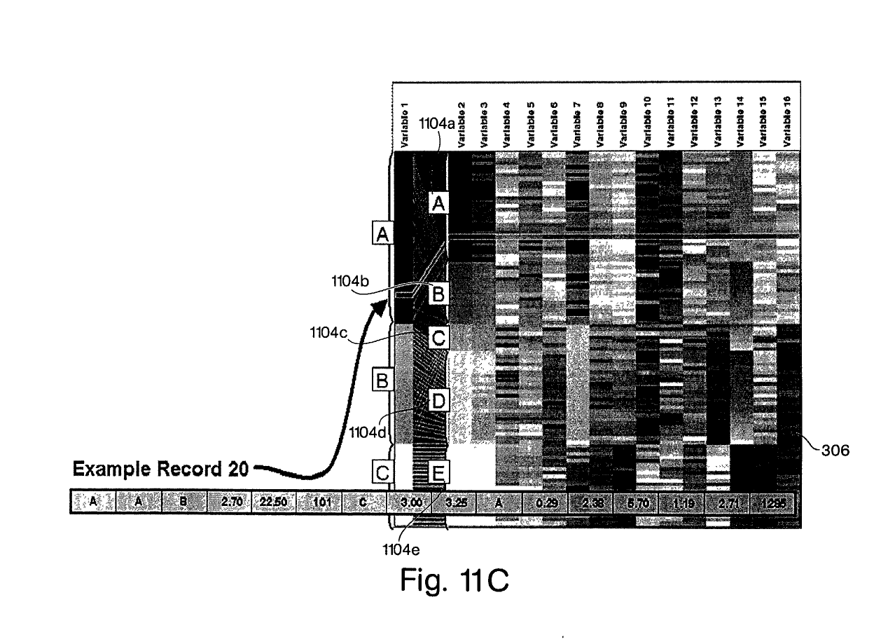

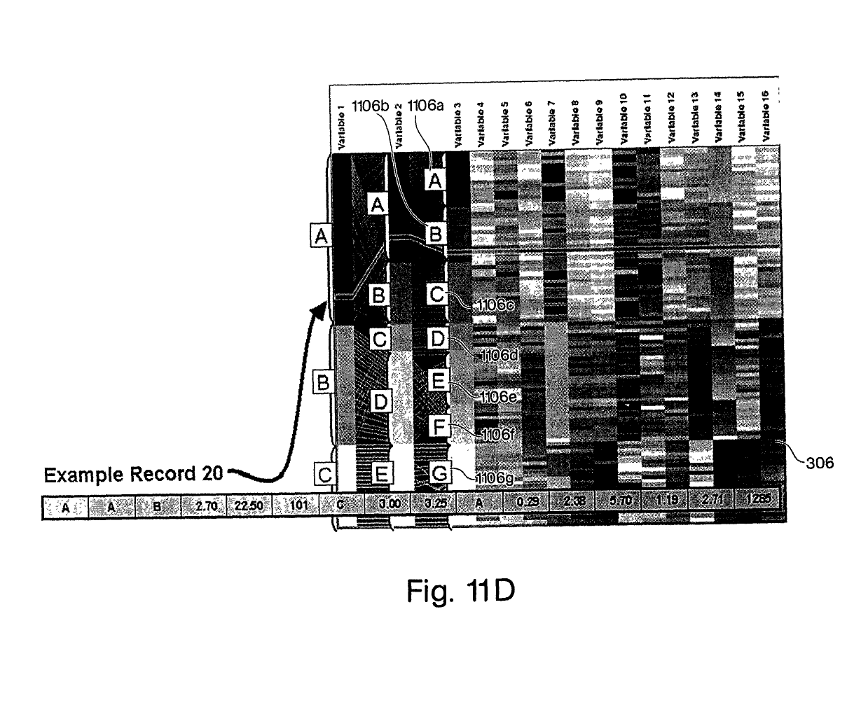

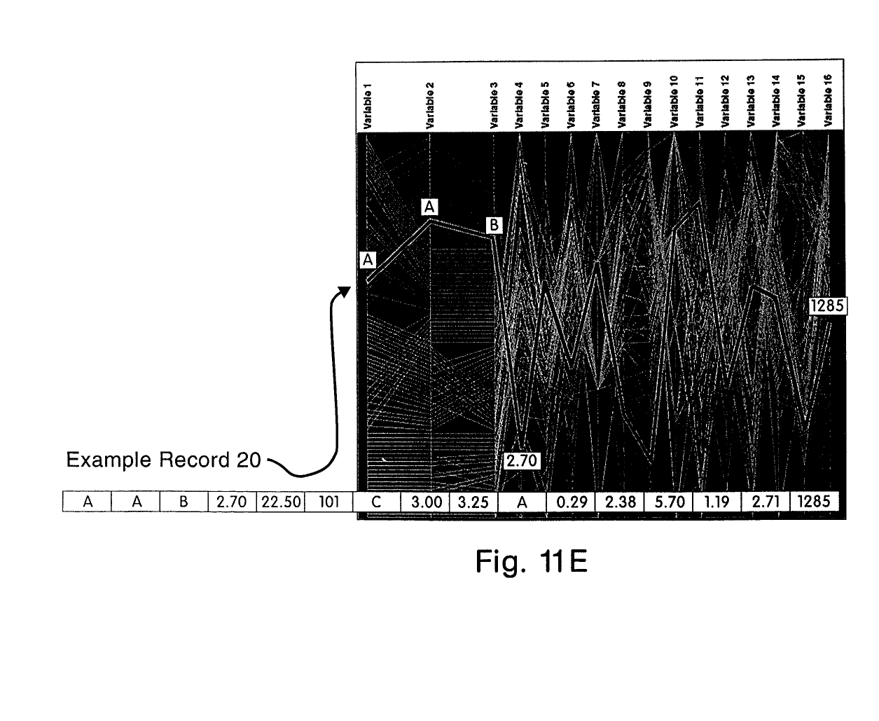

In addition to being able to analyze large amounts of data to determine result effective attribute subsets, the attribute reduction subsystem 102 is also capable of transforming data from the binned display format of the illustrative embodiment of the invention to other display formats. By way of example, FIGS. 11 and 12A-12D depict an illustrative process for transforming data from the binned display format of the invention to a multiple line graph/parallel coordinate display format. More specifically, FIG. 11 A depicts exemplary binned table employing a multi-level gray scale according to an illustrative embodiment of the attribute reduction aspect of the invention. FIG. 11B depicts the table of FIG. 11A tracking an example record 20 subsequent to independently sorting on variable 1 according to any of the illustrative sorting algorithms discussed herein to group each of three bin level values 1102a-1102c of variable 1. FIG. 11C shows the table of FIG. 11B tracking example record 20 subsequent to independently sorting on variable 2 to group each of the five bin level values 1104a-1104e of variable 2. FIG. 11D shows the table of FIG. 11C tracking example record 20 subsequent to independently sorting on variable 3 to group each of the seven bin level values 1106a-1106g. FIG. 11E shows the resultant multiple line graph generated by independently sorting on each of the variables 1-16 according to the illustrative embodiment of the attribute reduction aspect of the invention. As in FIGS. 11A and 11B, example record 20 is particularly tracked for clarity. Although line graphs and parallel coordinates are well understood in the art, graphical transformations of the type illustrated in FIGS. 11A-11D are believed to be novel.

Record Categorization Subsystem

The record categorization subsystem 104 of the invention will now be discussed. As described in summary above, in one illustrative embodiment, the record categorization subsystem 104 provides systems and methods for determining into which of at least two categories records representing study objects divide. According to other features, the record categorization subsystem 104 may also perform attribute reduction operation, by for example, using the AP algorithm (discussed in more detail below with respect to FIG. 12C) or the PURS or PUCS algorithms (discussed in further detail above with respect to FIGS. 7-9) or the super sort binary-tertiary separations from FIG. 6.

As in the case of the attribute reduction subsystem 102, in one preferred embodiment, the record categorization subsystem 104 processes data sets as a multi-dimensional array, such as a table of rows and columns. Moreover, according to the illustrative embodiment, the record categorization subsystem 104 displays records and associated attributes of a data set to an operator via a multi-dimensional graphical representation. By way of example, in one embodiment, the record categorization subsystem 104 assigns attributes (such as the attributes 304 of FIG. 3) to positions on a locus, such as a periphery of the multi-dimensional graphical representation. In the below discussed illustrative embodiment, the locus is a circle. However, in other embodiments, the locus may be any multi-dimensional locus, including, any two-dimensional locus, whether circumscribing a two-dimensional region or piecewise and unenclosed, including any curvilinear shape; ellipse; or polygon, including reentrant polygon, such as a star; a piece-wise connected polygon where the polygon edges are separated; a piece-wise connected polygon where the polygon edges are separated; a piece-wise connected collection of curves where the curve pieces are separated; and any three-dimensional shape, such as a sphere; a volume of revolution; a dimensional polygonal structure, such as a geodesic structure, such as a tetrahedron, cube, dodecahedron, or icosahedron. The record categorization subsystem 104 then assigns each record (such as the records 302 of FIG. 3) to a position within or about the multidimensional representation, based on either an occurrence or a value of one or more of the attributes.

FIG. 12A depicts an example record 20 plotted at a location 1202 on a multi-dimensional graphical visualization 1200 according to an illustrative embodiment of the record categorization subsystem. In the illustrative embodiment of FIG. 12A, the locus 1206 is a circle and the visualization 1200 is termed a radial visualization. The record 20 plotted on the radial visualization 1200 is the record 308 from the records 302 of the data set depicted in the table-like visualization 300 of FIG. 3 and employed with respect to FIGS. 3, 4A-4D and 11A-11E in the above description of the attribute reduction subsystem 102. The attributes (in this example, the variables 2-16 shown at 304 in FIGS. 3, 4A-4D and 11A-11E) are initially plotted at locations at equal distances on the locus 1204. While the attribute reduction subsystem 102 employs binned values for the variables 304, the illustrative record categorization subsystem 104 employs the actual alpha-numerical values to plot the records 302 on the radial visualization 1200. The actual alpha-numerical values for the example record 20 are shown at 1208.

According to the illustrative embodiment, the record categorization subsystem 104 determines the position of each record 302 within or about the locus 1204 by evaluating a relationship, such as an equation or mathematical formula using the values of the variables 304 for the record being plotted. According to one illustrative embodiment, the mathematical sign (positive or negative) of each variable 304 for a particular record, such as the record 308, defines a vectorial direction. That vector direction, at least in part, determines the location of the particular record, such as the record 308. By way of example, for non-negative attribute/variable values, a record will generally lie on or within the locus 1204. Alternatively, for negative attribute/variable values, a record may be located on the exterior of the locus 1204.

According to the illustrative embodiment, the magnitude of each variable 304 represents a coordinate value for each vector, the vectors are viewed to terminate at the location of the particular record, and the particular record is located at an equilibrium point, determined by summing all of the vector forces (including sign and magnitude) acting upon it.

By way of example, referring to FIG. 12A, the illustrative record categorization subsystem 104 positions the record 20 at the location 1202. The locations 1206a-1206o of each variable 304 on the locus 1204 provides a point of origin for each associated vector force 1210a-1210o acting upon the record 20. The values (shown at 1208) of each variable 304 define the magnitude for each associated vector force 1210a-1210o. The location 1202 provides a destination point for each of the vector forces 1210a-1210o and forms an equilibrium point determined by summing all of the vector forces 1210a-1210o acting upon the record 20.

In a further illustrative embodiment, the magnitudes of the vector forces 1210a-1210o (i.e. of the variables 304) represent spring force constants and each record, such as record 20, is considered to be connected to each of the attribute positions 1210a-1210o on the locus 1204 by way of a plurality of springs (one for each attribute) represented in FIG. 12A by the vector forces 1206a-1206o. The other end of the springs are viewed to be connected together at the record location 1202. According to this illustrative embodiment, the record categorization subsystem 104 determines the record position 1220 as an equilibrium point calculated by summing the spring forces exerted on the record 20 by each of the vector forces 1210a-1210o in accordance with Hooke's Law.

According to another illustrative embodiment, the record categorization subsystem 104 determines the equilibrium point 1202 for each record 302 by summing the squares of the magnitude of the spring forces 1210a-1210o exerted on the record 20. In another illustrative embodiment, the record categorization subsystem 104 uses the logarithm of the magnitude of the vector forces 1210a-1210o to determine the equilibrium point.

FIG. 12B shows the radial visualization 1200 of FIG. 12A, subsequent to having all of the records 302 plotted according to the above described spring constant embodiment. The records 302 are from a training data set having records about which category information is known. Accordingly, even prior to category separation processing by the record categorization subsystem 104, the illustrative display 1200 gray scale codes the records 302 to differentiate between the patients known to have AML-type leukemia (represented by the black/dark gray dots), the patients known to have ALL-type leukemia (represented by medium gray dots) and the patients surprisingly (as this was not discovered by the Golub and Slonim group) to have T-ALL leukemia disease (represented by light gray/white dots). As can be seen, upon initial placement by the record categorization subsystem 104, no particular grouping of AML and ALL patients occurs. As discussed above with respect to binning, although the illustrative embodiment of FIG. 12B employs gray scale coding to differentiate between record grouping, any visually distinct symbols, such as colors or other symbols, may be used.

According to the illustrative embodiment, subsequent to initial record placement on the visualization 1200 of FIG. 12B, the record categorization subsystem 104, either automatedly or with operator interaction, manipulates one or more aspects of the radial visualization 1200 to enhance category separation. Such manipulations include, for example, manipulating the position of one or more attributes 304 on the locus 1204, the sign (positive or negative) of the vector forces, the magnitude scaling of the vector forces, and one or more points on the locus 1204 to change the locus shape. Such manipulations may also include breaking the locus 1204 into multiple pieces and manipulating the position and/or shape of the resultant pieces. By iterating such manipulations, either under operator, operator-assisted, or automated processor control, the record categorization subsystem 104 determines the variable positions on the locus 104 that cause the records 302 to visually divide along the known category divisions.

According to the illustrative embodiment, the record categorization subsystem 104 can employ any available sorting and/or pattern recognition algorithms to determine one or more variable/attribute placement layouts that enhance record category separation. According to one illustrative embodiment, the data processing algorithms 108 employed by the record categorization subsystem 104 use class distinction metrics (classifiers) to assign the positions of the attributes 302 on the locus 1204. As described above with respect to FIG. 2, classifiers define a relationship, for example, by way of equations or regions of a visual display, that yields a result which classifies a study object as belonging to (or not belonging to) a particular category or class. According to the illustrative embodiment, the record categorization subsystem 104 employs any of neural networks, support vector machines, Naïve Bayes, logistic regression, IBK (K-nearest neighbor) analysis, t-statistics (with equal and unequal variances for the classes) and/or F-statistics, AP algorithm, PURS, super sort binary-tertiary portioning, PURS, Principal Component Analysis, and other techniques to build classifiers.

As mentioned above, according to the illustrative embodiment, the record categorization subsystem 104 employs an array for organizing the attributes 304 and records 302, much in the same way as the attribute reduction subsystem 102. Thus, according to one feature, the illustrative record categorization subsystem 104 may employ the same attribute reduction algorithms employed by the attribute reduction subsystem 102.

FIG. 12C shows the radial visualization 1200 subsequent to determining the attribute positions that cause the records 302 to divide into the known categories (in this example, AML-type leukemia, B-ALL-type leukemia, and T-ALL type patients). More particularly, variable 2 is now at position 1206m rather than position 1206a; variable 3 is now at position 1206l rather than 1206b; variable 4 is now at position 1206b rather than position 1206c; variable 5 is now a position 1206o rather than position 1206d; variable 6 is now at position 1206g rather than position 1206e; variable 7 is now at position 1206n rather than position 1206f; variable 8 is now at position 1206d rather than position 1206g; variable 10 is now at position 1206e rather than position 1206i; variable 13 is now at position 106a rather than position 1206l; variable 15 is now in position 1206l rather than position 1206n; and variable 16 is now at position 1206c rather than position 1206o. Although in the illustrative embodiment of FIG. 12C, the variables/attributes 304 remain spaced equidistant from each other, this is not necessarily a requirement. A preferred arrangement is to have the classes separated by pie-shaped segments with additional space between classes. Also, altering the location of as few as one of the attributes/variables (also known as dimensional anchors) 304 may be sufficient to achieve the desired record movement. Additionally, a plurality of attribute 304 layouts that achieve the desired category separations may be possible. Further, the result-effective subset of attributes employed may or may not be minimized and may or may not be unique without deviating from the scope of the invention.

According to another illustrative feature of the invention, the attribute reduction subsystem 102 and the record categorization subsystem 104 provide techniques for processing time series data. One such technique is applicable when attributes displayed on a visualization, such as the previously discussed radial visualization 1200 of FIG. 12B, include different time samples. If the number of time samples displayed on the radial visualization are equal to one cycle of data, then each time sample on the circular locus corresponds to a particular phase in the time cycle data. Using this technique, an operator can observe, for example, which phases are more dominant in a particular data set. Additionally, the operator can search for the fundamental frequency in the data set by varying the positions of the attributes and/or which attributes are laid out on the circular locus.

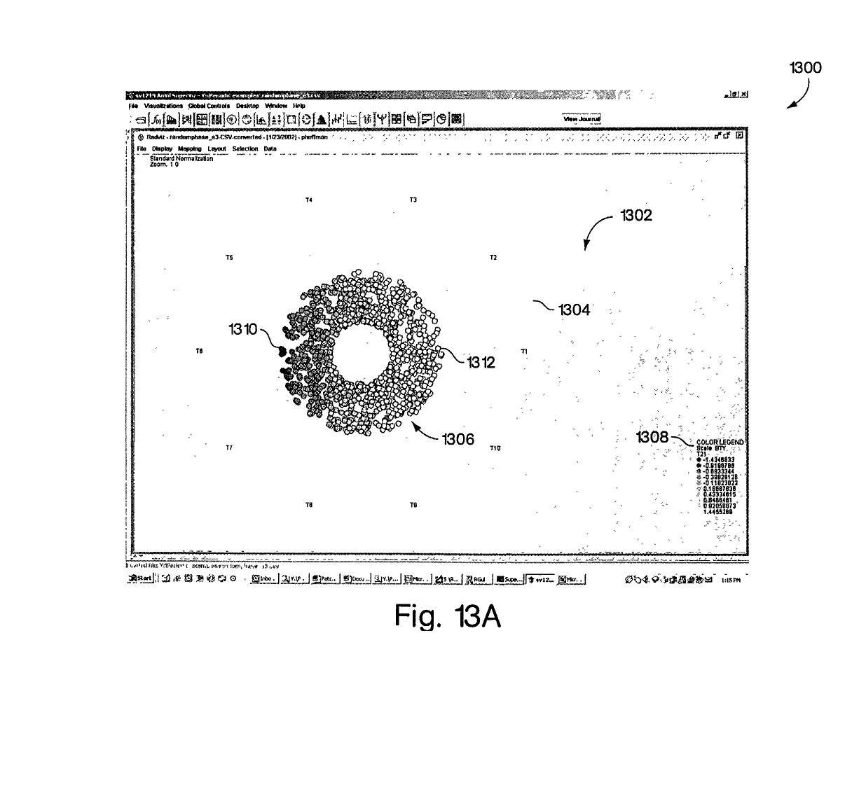

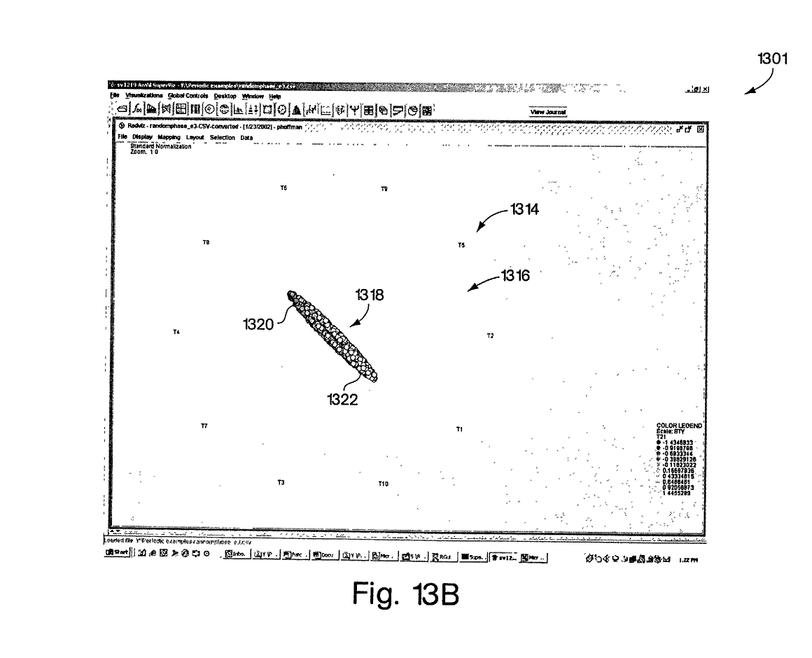

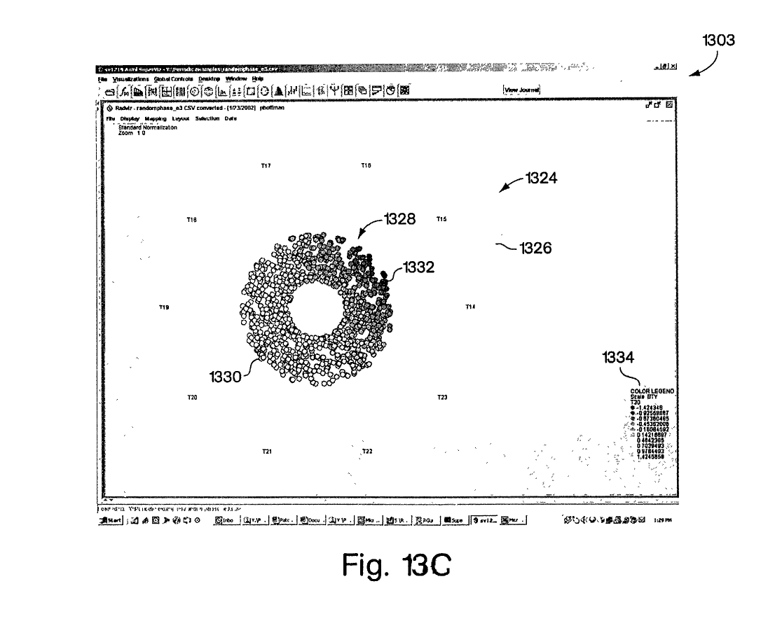

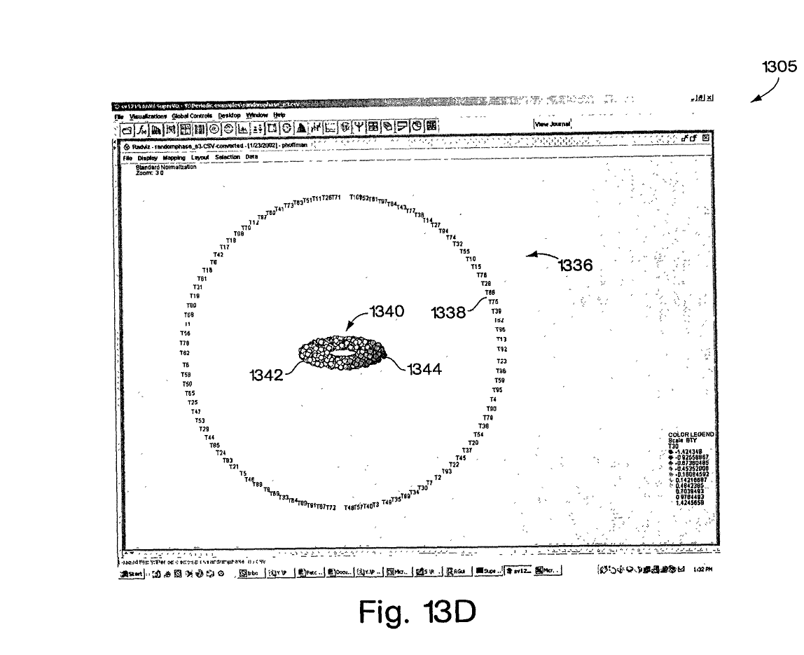

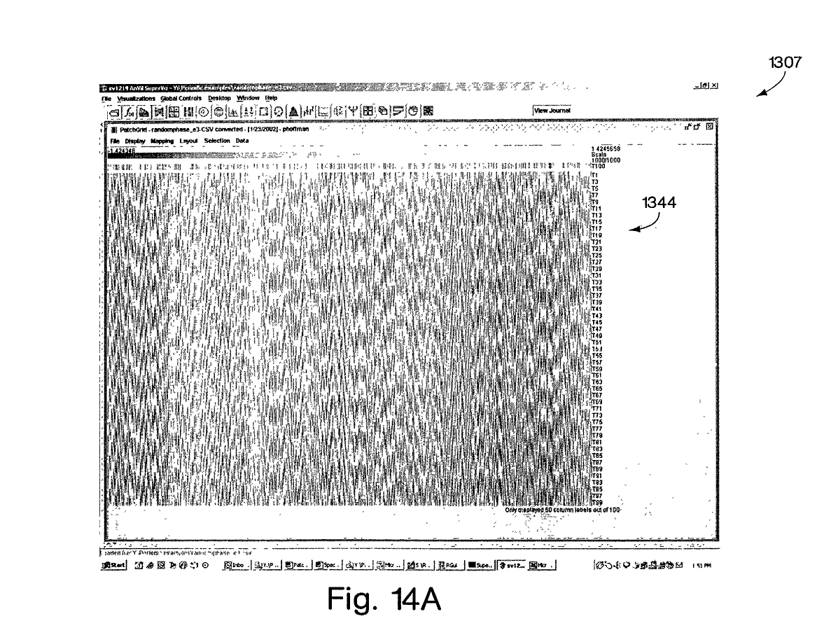

An extension of this technique is animating the display, where the attribute positions along the locus are consecutively shifted by a skip factor, such as one. That is, a fixed number of attributes (called a frame) are laid out on the locus. The number of attributes per frame is equal to the period of the time cycle data. The total number of attributes plotted typically includes several frame cycles worth. The radial visualization is then animated to show consecutive frames of data. Each individual display of the animation shows the same attributes, but with the attribute locations incremented by the skip factor. One advantage of this technique is that it can show data points that have unique time varying dependencies that are not seen in other visualizations. Some examples are discussed below with respect to FIGS. 13A-13G.

FIG. 13A is a GUI display screen 1300 depicting a radial visualization 1302. The radial visualization 1302 has a plurality of time samples T1-T10 laid out as attributes along the periphery of a circular locus 1304. Each dot 1306 plotted within the locus 1304 represents a particular gene for a single patient. The location of a particular gene (dot 1306) is determined from the value of the gene's expression at each of the ten time samples T1-T2. More specifically, the gene expression value at each of the ten time samples T1-T10 may be take as a spring force, with the plotted location of the gene being determined by a sum of the spring forces. The legend 1308 depicts the correspondence between the shade of a dot and a gene expression value. The legend 1308 in the instant example is taken from expression values at T21. As can be seen by comparing the gene expression shading of T21 with the gene expression shading of the visualization 1302, the period of the plotted data set is 10 time intervals. As also shown, the darkest shaded genes (lowest expression values) 1310 are ninety degrees out of phase with the lightest shaded genes (highest expression values) 1312.

FIG. 13B is a GUI display screen 1301 depicting the data set of FIG. 13A plotted on a radial visualization 1314 where the attributes T1-T10 are plotted in a substantially random manner around the locus 1316. As seen, the circular pattern of FIG. 13A is replaced with an elliptical pattern. However, it should be noted that the darkest shaded genes (lowest expression values) 1320 are still ninety degrees out of phase with the lightest shaded genes (highest expression values) 1322.

FIG. 13C is a GUI display screen 1303 depicting another radial visualization 1324 having a different set of time samples T14-T23 arranged along the periphery of a circular locus 1326. As once again shown, the lightly color (high gene expression) dots 1330 remain ninety degrees out of phase with the darkly colored (low gene expression) dots 1332. The display 1303 includes a legend 1334 depicting expression level/shading correspondence for T30. As can be seen by comparing the legend 1334 with the record shading of the visualization 1324, the T30 time sample attribute values are in phase with the T20 attribute values.

FIG. 13D is a GUI display screen 1305 depicting another radial visualization 1336 having all of the time samples T1-T100 arranged substantially randomly along the periphery of a circular locus 1338. As shown such random layout results in an elliptical grouping of genes 1340. Once again, the lightly color (high gene expression) dots 1342 remain ninety degrees out of phase with the darkly colored (low gene expression) dots 1344.

FIG. 13E is a GUI display screen 1307 of a table-like display 1344 of the type generated by the attribute reduction subsystem 102 of the invention. In the table 1344, the time samples T1-T100 are shown along the right margin. Each column of the table 1344 represents one of a thousand genes. The binned shading represents the gene expression values at each of the one hundred time samples T1-T100. However, with the time samples clustered and the records sorted by T1, in accord with the methods discussed herein, ten groups 1346a-1346k of time intervals T1-T100 emerge. We can also see that the time samples T1, T11, T21, . . . , T91 are in phase with each other, but ninety degrees out of phase with the time samples T6, T16, T26, . . . T96. Thus, the table 1344 provides additional information regarding analysis of time varying dependencies. The sinusoidal nature of the time dependencies of the data set of FIGS. 13A-13F is further illustrated in the display 1311 of FIG. 13G, which displays a multiple line graph representation of the data of FIG. 13F. An illustrative process for such transformation is discussed above with respect to FIGS. 11A-11E.

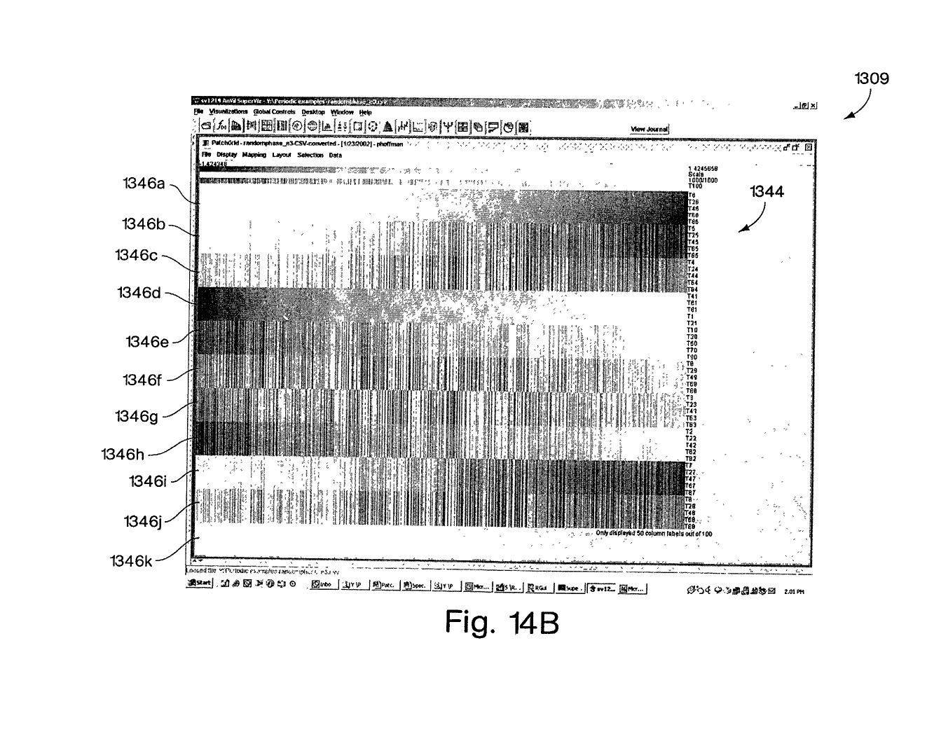

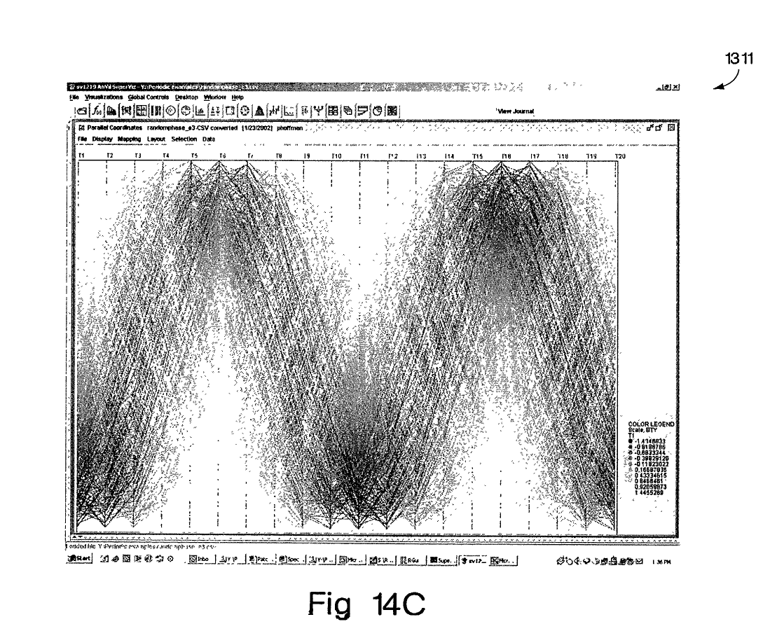

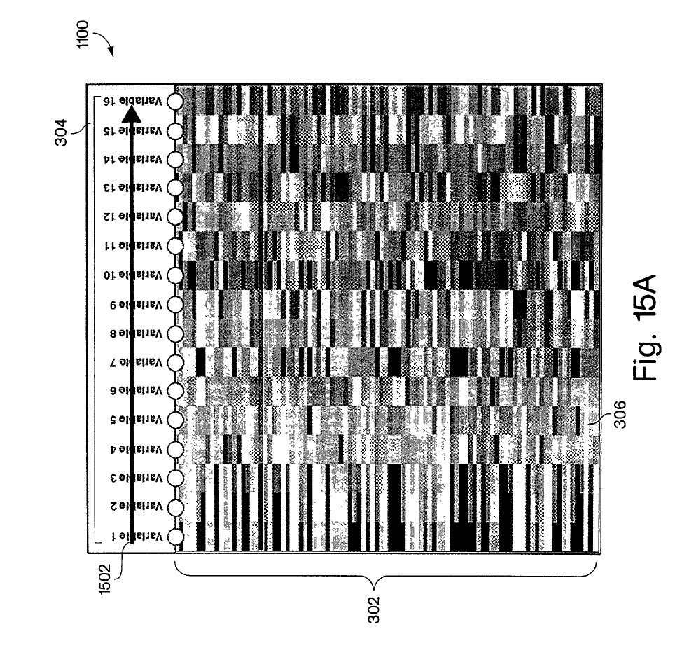

As described above, according to the illustrative embodiment, the record categorization subsystem 104 employs the AP layout algorithm to determine the attribute positioning to realize the category separations of FIG. 12C. Details of the illustrative AP algorithm are described next with respect to FIGS. 14A-14C.

FIG. 14A is a display screen of a radial visualization 1400 showing a 76 gene attribute subset 1402 of the Affymetrix™ gene set randomly arranged on the perimeter of a circular locus 1404. The records (patients) 1406 are plotted within the locus 1404 in a manner such as described with respect to FIGS. 12A-12C. The dark dots 1408 indicate patients known to have ALL-type leukemia, while the light gray dots 1410 indicate patients known to have AML-type leukemia. To test the 76 gene subset to determine if it is result-effective and/or to calibrate the radial visualization 1400, the illustrative record categorization subsystem 104 employs the AP algorithms.

The AP algorithms use class distinction 1402 metrics to assign the positions of the attributes on the locus 1404. In the illustrative embodiment, the metric employed is t-statistics. The t-statistic is calculated for each column (gene attribute 1402) by comparing all of the ALL values with all of the AML values in each column. The t-statistic is a standard statistical test for comparing two groups using the means and standard deviations. The t-statistic for each attribute 1402 determines the order of the attributes 1402 around the perimeter of the locus 1404.

Referring to FIG. 14B, the genes or columns 1402 that have higher values for ALL are laid out in the top half 1412 of the locus 1404, the genes or columns 1402 that have higher values for AML are laid out in the bottom half 1414 of the locus 1404. The order of the genes 1402 are by t-statistic value. In the top half 1412 of the locus 1404, the genes 1402 are ordered right to left with the most significant gene 1416 on the right and the least significant gene 1416 on the left. In the bottom half 1414 the genes 1402 are ordered with significance going from left 1420 to right 1422.

The columns (genes 1402) are laid out around the locus 1404 perimeter with the column that has the highest t-statistic (negative) value at gene 1416 in the diagram. Gene 1416 is most significant for having a higher mean for ALL than AML. Gene or column 1420 is most significant for having higher mean values for AML than ALL.

As can be seen in FIG. 14B, use of the AP algorithms result in a relatively clean separation between the patients 1408 having AML-type leukemia and the patients 1410 having ALL-type leukemia.

Since the illustrative AP algorithm described above ranks the significance of the attributes 1402, the operator may also employ the AP algorithms for attribute reduction. More specifically, subsets of the most significant attributes 1402 may be examined to determine further reduced, result-effective attribute subsets. By way of example, FIG. 14C is a screen shot of a radial visualization 1424 employing the top five most significant genes for ALL 1426 and AML 1428. As can be seen using this attribute subset, the AML-type patients 1408 and the ALL-type patients 1410 continue to clearly divide. Thus, the AP algorithms employed by illustrative record categorization subsystem 104 not only provide record categorization features, but also attribute reduction features.

By determining at least one attribute positioning layout that achieves the known category separation for the known data set, the record categorization subsystem 104 verifies that the result-effective subset of attributes identified by the attribute reduction subsystem 102 is valid. Using the identified, result-effective attribute subset, the record categorization subsystem 104 is now essentially calibrated to determine which, if any, of the three categories (AML-type leukemia, B-ALL-type leukemia or T-ALL type leukemia) of records about which category information is unknown, fall.

Although the illustrative record categorization subsystem 104 is described above with respect to a result-effective subset of attributes determined by the attribute reduction subsystem 102, in other illustrative embodiments, the record categorization subsystem 104 analyzes data sets without use of the illustrative attribute reduction subsystem 102. In such embodiments, the record categorization subsystem 104 may employ its own attribute reduction features or, alternatively, process the data set under examination using its full set of attributes.

As described above with respect to the multiple line graph example of FIGS. 11A-11E, according to one feature, the illustrative system 100 is adapted to convert from one visualization to another to aid an operator in analyzing data. According to the illustrative embodiment, the system 100 is particularly adapted to transform data from the binned, table-like visual representations of the attribute reduction subsystem 102 to the visual representations of the record categorization subsystem 104.

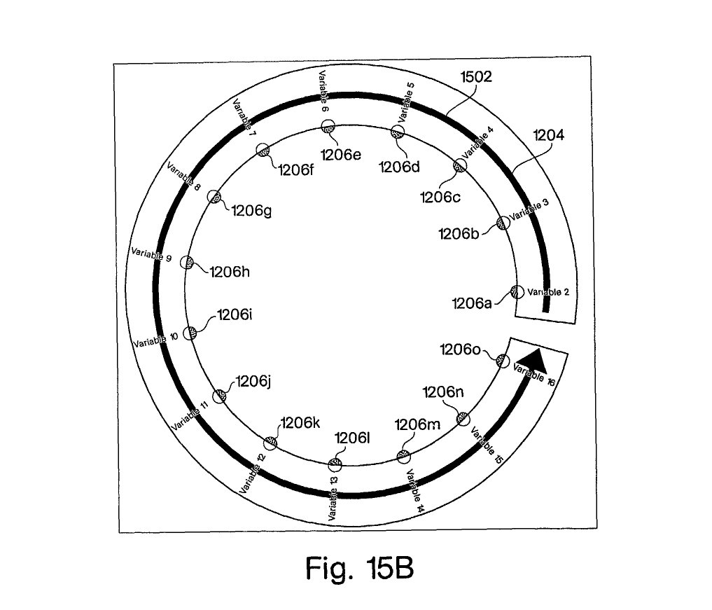

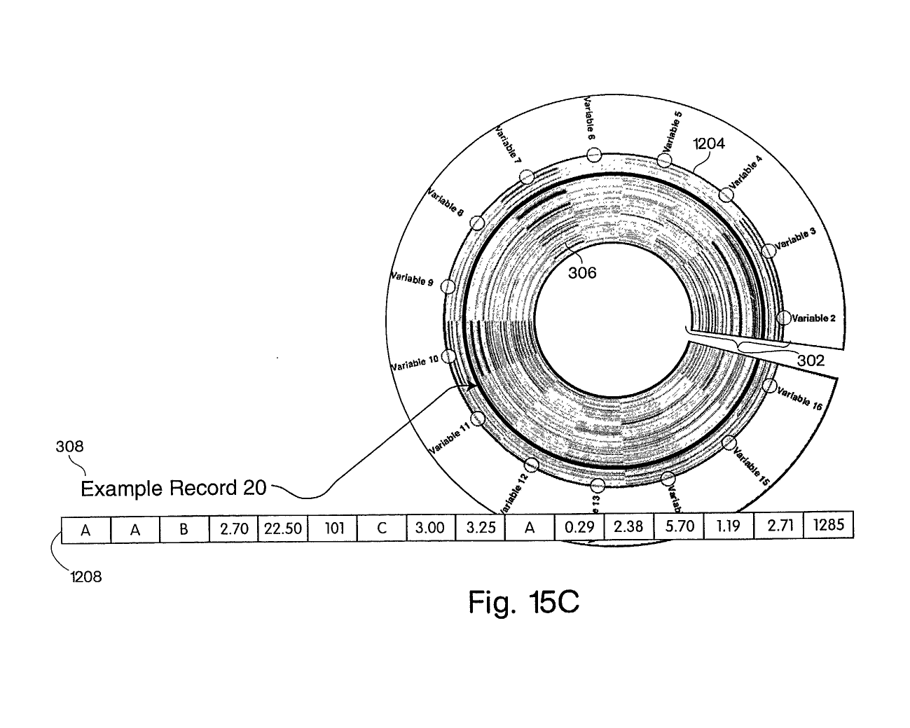

FIGS. 15A-15C depict conceptual intermediate stages of transforming a data set from the binned, table-like visualization of the attribute reduction subsystem 102 to, for example, the radial visualization depicted in FIGS. 12A-12C. More specifically, FIG. 15A depicts the binned data 306 from the previously discussed table-like visualizations of FIGS. 3, 4A-4D and 12A-12F annotated with an arrow 1502 to aid in tracking the transformation process.

FIG. 15B depicts the locus 1204 described with respect to FIGS. 12A-12C. The arrow 1502 sweeps around the locus 1204 to illustrate how the attributes 302 map onto the locus 1204 at positions 1206a-1206l. According to the illustrative embodiment, system 100, at least initially, positions the attributes 304 equidistant from each other on the locus 1204.

FIG. 15C depicts the binned values 306 of each of the variables 1-16 for each of the records 302. To illustrate how the system 100 plots the records 302 within or about the locus 1204 to form the radial visualization of FIGS. 12A-12C, FIG. 15C also highlights record 20, along with its numerical values 1208, for each of the variables 302. Once the attributes are located around the locus 1204, the record categorization subsystem 104 plots the records 302 within or about the locus 1204 in accord with the processes described above with respect to FIGS. 12A-12C.

As described above, the record categorization subsystem 104 enables the operator to manipulate the shape of the periphery of the locus 1202, changing it from, for example, a circle to any shape, connected or disconnected.

It should be noted that according to the illustrative embodiment of the invention, the above described attribute location, force control and locus shape manipulation features may be accomplished under operator, processor or a combination of operator and processor control.

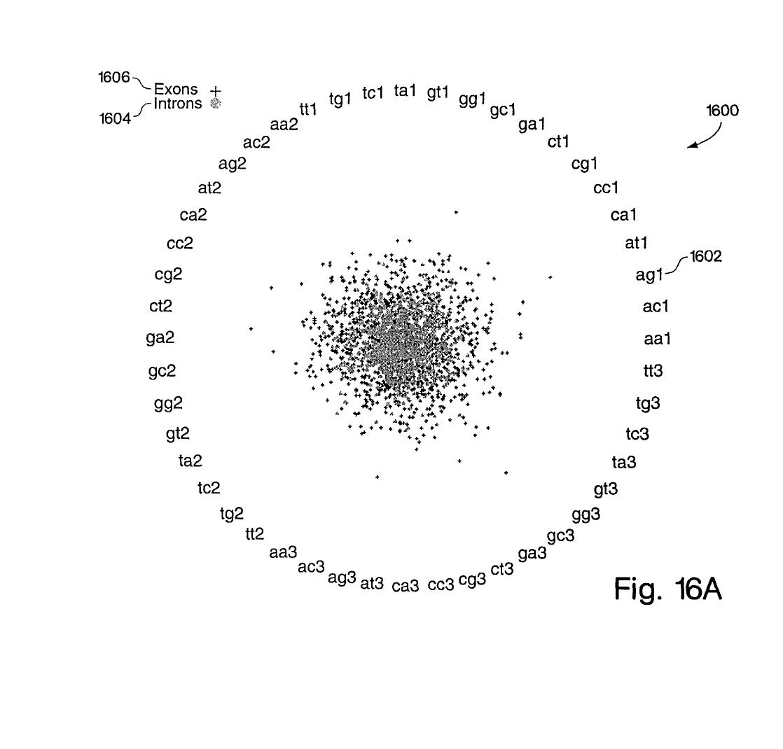

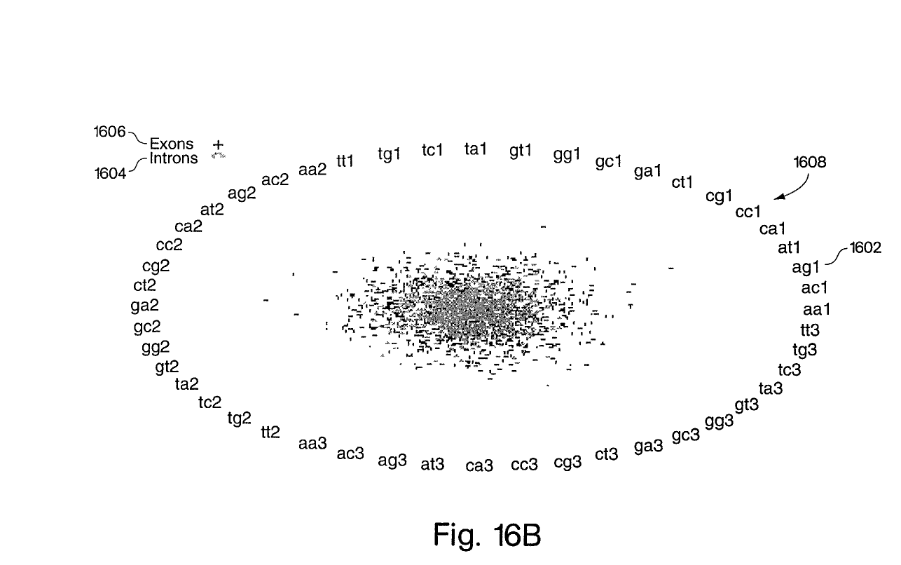

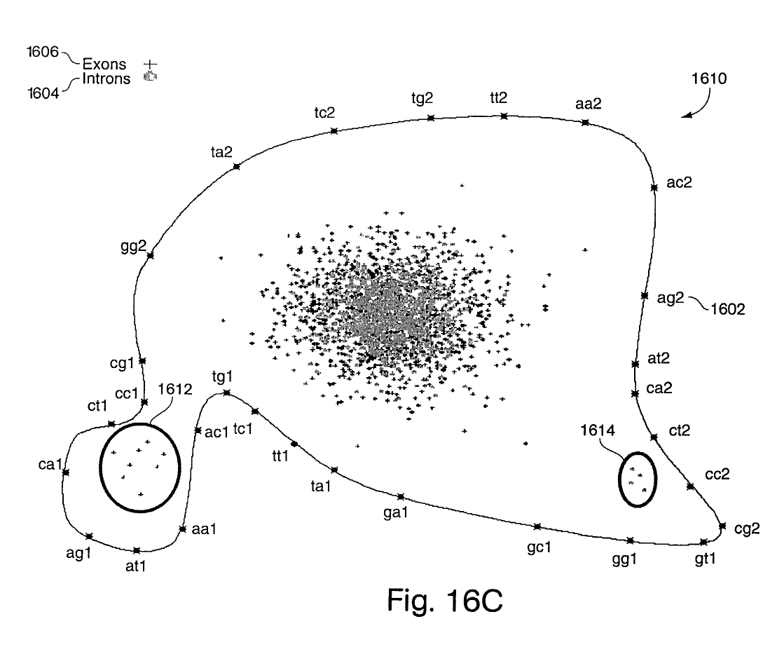

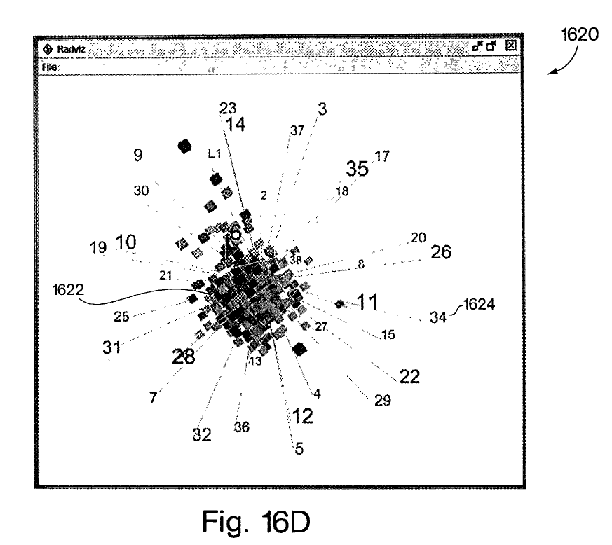

FIGS. 16A-16D illustrate a variety of locus shapes along with some of the aspects of the above described shape control features of the record categorization subsystem 104. More particularly, FIG. 16A depicts a circular locus 1600 of the type described above with respect to FIGS. 12A-12C. In a similar fashion to FIGS. 12A-12C, the attributes 1602 are located on the locus 1600. Two categories of records are plotted: introns 1604 (represented by light gray dots) and exons 1606 (represented by dark gray crosses). Using the above described shape control features, the record categorization subsystem 104 can change the geometrical shape of the radial visualization 1600 to any other shape to aid in determining category separation.

FIG. 16B depicts the attributes 1602, introns 1604 and exons 1606 plotted on an elliptical locus 1608, subsequent to the record categorization subsystem 104 effecting a locus shape change according to an illustrative embodiment of the invention. As can be seen from FIG. 16B, by changing the locus from a circle to an ellipse, the record categorization subsystem 104 effectively spreads out the records (i.e., the introns 1604 and the exons 1606).

FIG. 16C depicts the attributes 1602, introns 1604 and exons 1606 subsequent to the record categorization subsystem 104 changing the shape of the locus 1600 to an arbitrary spline shape 1610 and relocating the locations of the attributes 1602. By employing such arbitrary locus shapes, the record categorization subsystem 104 is able to create specialized effects, such as the movement of records that happen to be highly associated with specific dimensions and their specific attributes 1602. A unique cluster is discovered. Should records overlap, a spread of the attributes along opposite sides would spread the overlapping records providing information about which attributes most influence the overlap. Should some records be outliers (closer to the locus) a spread such as the one in FIG. 16C helps identify unique clusters as before as well as identify the attributes most influential. This is also useful for detailed presentations to emphasize a collection of variables. This mapping is equivalent, although not perceptually as strong, as grouping attributes on the locus. As shown, the illustrative methodology of FIG. 16C causes a plurality of exons 1606 to group at 1612 and 1614.

Multi-dimensional radial visual displays include two- and three-dimensional displays, as well as displays having greater numbers of dimensions. For example, an additional dimension can represent the flow of time. FIG. 16D shows a static three-dimensional radial visualization 1620, according to an illustrative embodiment of the invention. In FIG. 16D, the multi-dimensional display space 1620 is a sphere and the records 1622 are displayed as being within or on the surface of the sphere for the values of the attributes 1624 that are under consideration. A user can observe clusters of data records 1622 in one or more regions of the sphere. In another embodiment, the multi-dimensional visualization is a three dimensional polygonal visualization. In a further embodiment, a multi-dimensional radial visualization having N attributes, where N is an integer, is displayed on an M-dimensional display space, where M =3, N>M. This provides a 3 dimensional display space, such as a sphere, a regular solid such as a tetrahedron, a cube, a dodecahedron, an icosahedron, a structure analogous to a “Buckyball” (e.g., a carbon structure having 60 carbon atoms), a solid of revolution, or the like.

Graphical User Interface (GUI)

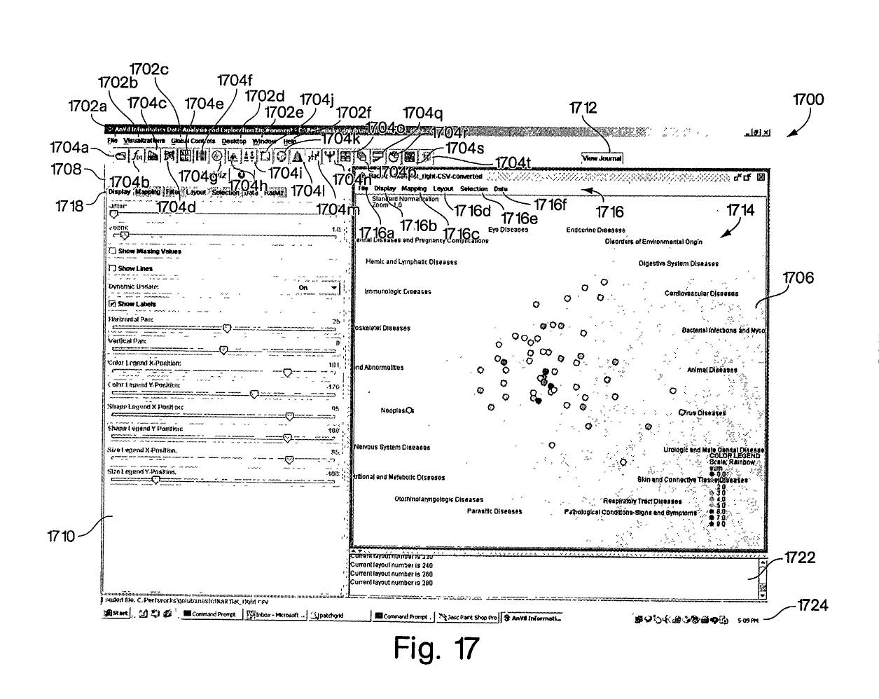

As discussed above, the illustrative embodiment of the system 100 provides a comprehensive GUI 106 to enable an operator to interact with features of the attribute reduction subsystem 102, the record categorization subsystem 104 and the data processing algorithms 108. Illustrative aspects of the GUI 108 are discussed now with respect to FIGS. 17-33.

FIG. 17 depicts a GUI screen image 1700 for interacting with features of the system 100 according to an illustrative embodiment of the invention. The screen 1700 includes a menu bar 1702, a menu bar 1704, a display panel 1706, a control panel 1708, and a status panel 1710.

The menu bar 1702 includes the menu entries “File” 1702a, “Visualizations” 1702b, “Global Controls” 1702c, “Desktop” 1702d, “Window” 1702e, and “Help” 1702f. The menu entries 1702a-1702f provide access to various commands, for example, by way of a drop down menu list. The “File” command 1702a provides access to file manipulation commands, such as opening, importing, writing, saving and closing files. The “Visualizations” command 1702b provides access to a plurality of visualization tools that individually invoke a type of visualization and provide suitable controls in the control panel 1708 during the period that the visualization is active. Entries that are provided by an operator in the status panel 1710 of the control panel 1708 are held in variables in computer-readable memory and become the default values until changed. The “Global Controls” command 1702c activates controls in the control panel 1708 that are globally applied by the system and methods of the invention during the operation. In general, each control in the control panel 1708, whether global or specific to a particular menu selection, first appears with a default value. The “Desktop” command 1702d activates a menu which enables the operator to select a desktop display in tiled or cascaded formats, to iconify visualizations, to redraw visualizations, or to close visualizations. The “Window” command 1702e provides commands that control the appearance of one or more regions of the display screen 1700. The “Help” command 1702f, when invoked, provides an on-line help feature, including guidance as to how to perform one or more commands available in the system 100.

The iconic commands 1704 each invoke functionality of the system. The icons, from the left to the right, control the functionality of the following features: file operations 1704a, statistics 1704b, a dendograms display mode 1704c, parallel coordinates display mode 1704d, a scatterplot matrix display mode 1704e, a (patchgrid) display mode 1704f, a multi-dimensional radial visualization display mode 1704g, a scatter plot display mode 1704h, a survey plot display mode 1704i, a Kohonen Self-Organizing Maps display mode 1704j, a multi-dimensional polygonal visualization display mode 1704k, a class histograms display mode 1704l, a multi-line visualization display mode 1704m, a data conversion module 1704n, a display mode in which visualizations are tiled 1704o, a display mode in which visualizations are cascaded 1704p, a display mode in which visualizations are iconified 1704q, a command that redraws all visualizations 1704r, a display mode in which all visualizations are closed 1704s, and a neural network display mode 1704t.

The display panel 1706 provides a real-time display of one or more aspects of the system 100, such as the radial visualization 1714. The display panel 1706 also has a menu bar 1716 that is used in the illustrative embodiment to provide pull-down menus.

The screen 1700 further includes a “view journal” button 1712, which, when activated, shows the operator the sequence of commands and visualizations issued during a particular session up to the time when the button 1712 is activated.

The control panel 1708 includes both tabs 1718 and an interactive portion 1710. The interactive portion 1710 varies according to the functionality that is activated in the display panel 1706.

The screen 1700 also includes a status panel 1722, which reports information regarding the status of the system 100 and the progress of an operation that the system 100 is performing. In an embodiment that uses Windows™ as an operating system, the customary Windows™ indicators as to files open and system capabilities appear in the systray 1724, and will not be remarked on further.

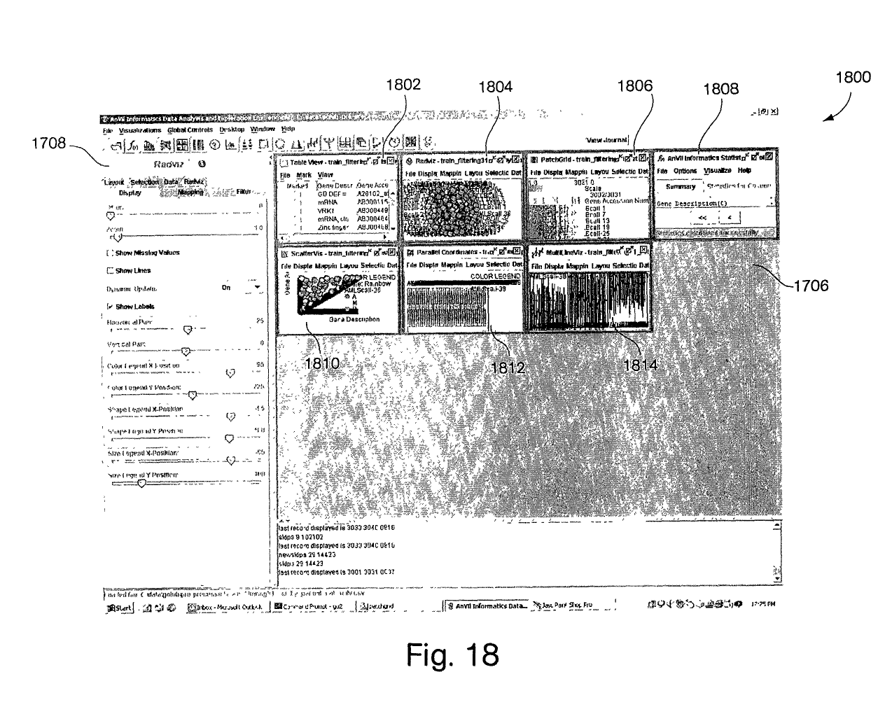

FIG. 18 depicts a GUI screen image 1800 in which seven functional interfaces of the attribute reduction 102 and record categorization 104 subsystems are simultaneously displayed in tiled format in panel 1706. The functional interfaces, which are described in greater detail below, include: a table view 1802 listing data available for processing and display by the system 100; a multi-dimensional radial visualization display 1804 of the record categorization subsystem 104; a gray scale binned and sorted table display 1806 of the attribute reduction subsystem 102; a statistical analysis display 1808 which enables the user to perform numerous types of statistical analysis on datasets; a scatter plot visualization 1810, a parallel coordinates visualization 1812, and a multi-line visualization 1814. In FIG. 18, the control panel 1708 displays commands appropriate for the multi-dimensional radial visualization 1804.

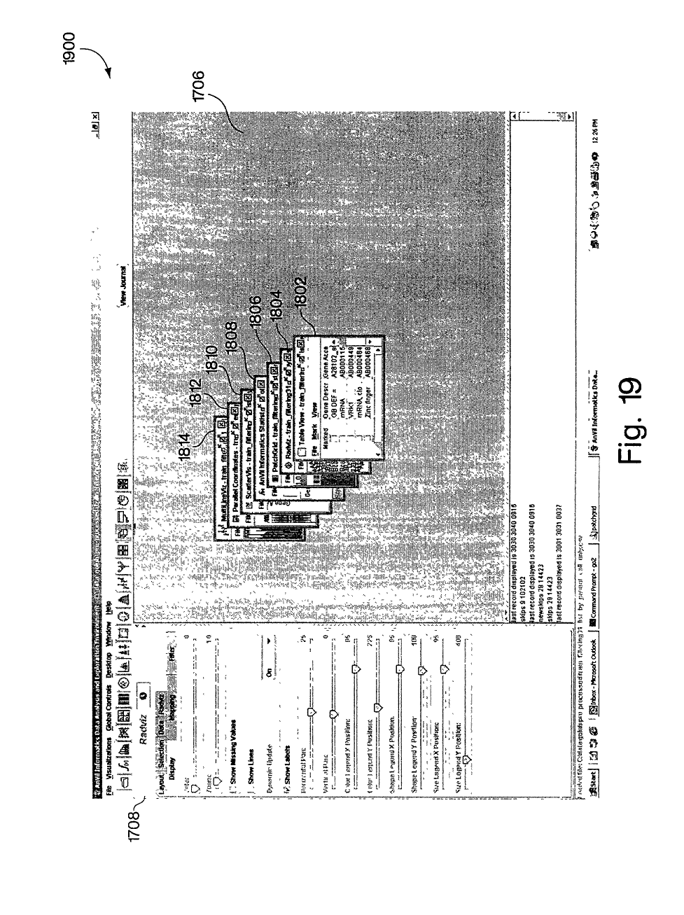

FIG. 19 depicts a GUI screen image 1900 in which the seven functional interfaces 1802-1814 of FIG. 18 are simultaneously displayed in cascaded format in the display panel 1706.

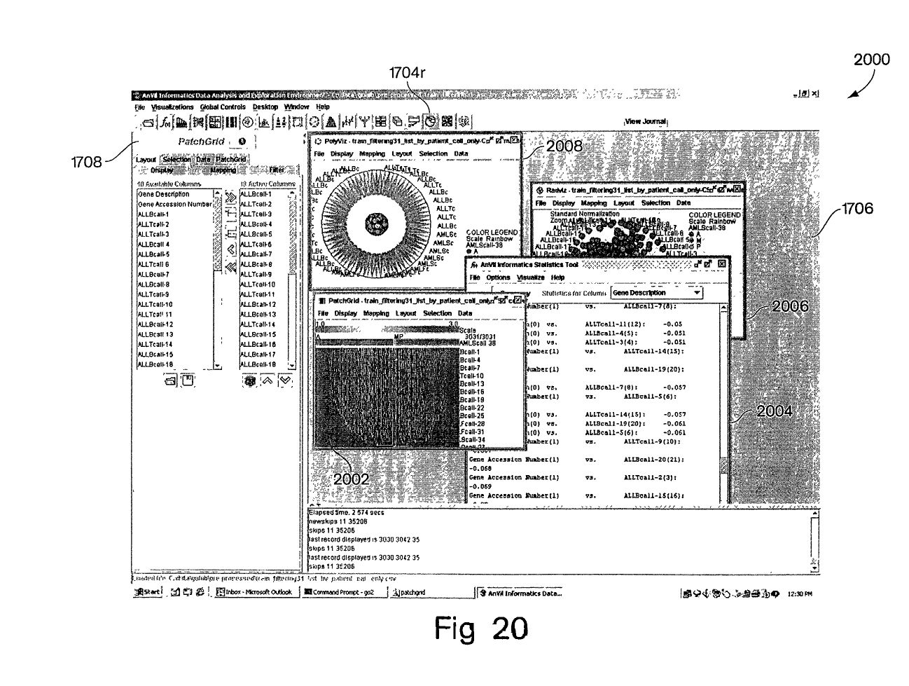

FIG. 20 depicts a GUI screen image 2000 in which four functional interfaces are simultaneously displayed in cascaded format in the display panel 1706. The functional interfaces include: a gray scale binned and sorted table display 2002 of the attribute reduction subsystem 102; a statistical analysis display 2004 which enables the operator to perform numerous types of statistical analysis on datasets; a multi-dimensional radial visualization display 2006 of the record categorization subsystem 104, and a polygonal visualization 2008, also of the record categorization subsystem 104. In FIG. 20, the control panel 1708 displays commands appropriate for the table display 2002. The icon 1704r is depicted as active, indicating that the various visualizations are redrawn in real-time.

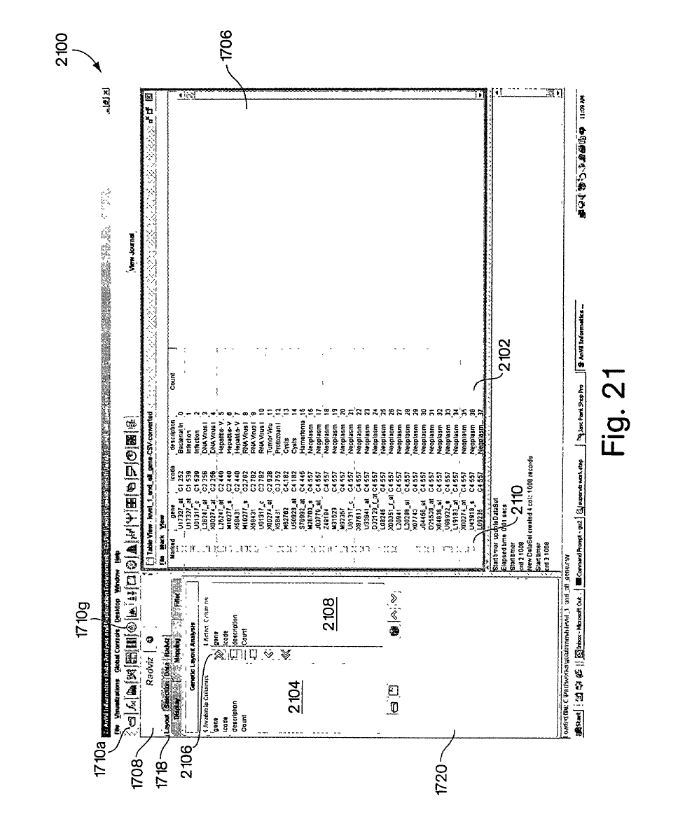

FIG. 21 is a GUI screen image 2100 depicting an illustrative interface for interacting with the record categorization subsystem 104. Initially, an operator activates the open file icon 1710a. In response, the GUI 106 presents the operator with a listing of one or more data files that the operator can select. Alternatively, the operator can enter a path and file name to command the record categorization subsystem 104 to open a particular data file. The GUI 106 displays the screen 2100 in response to the operator selecting a data file for processing. In this illustrative example, the control panel 1708 displays a list 2104 of available columns of data in the selected dataset. The operator selects from the available columns of list 2104, for example, by highlighting each desired column with a mouse pointing device and activating a command to select the highlighted items, such as the arrow 2106. The operator selections are displayed in the list 2108. As shown in the list 2108, in the illustrative example of FIG. 21, the operator has selected all available columns. In response to the column selecting of the list 2108, the GUI 106 displays the data of the selected columns in a table 2102. The operator can select entries from the table 2102 in a row-wise manner by activating a checkbox 2110 in the table 2102.

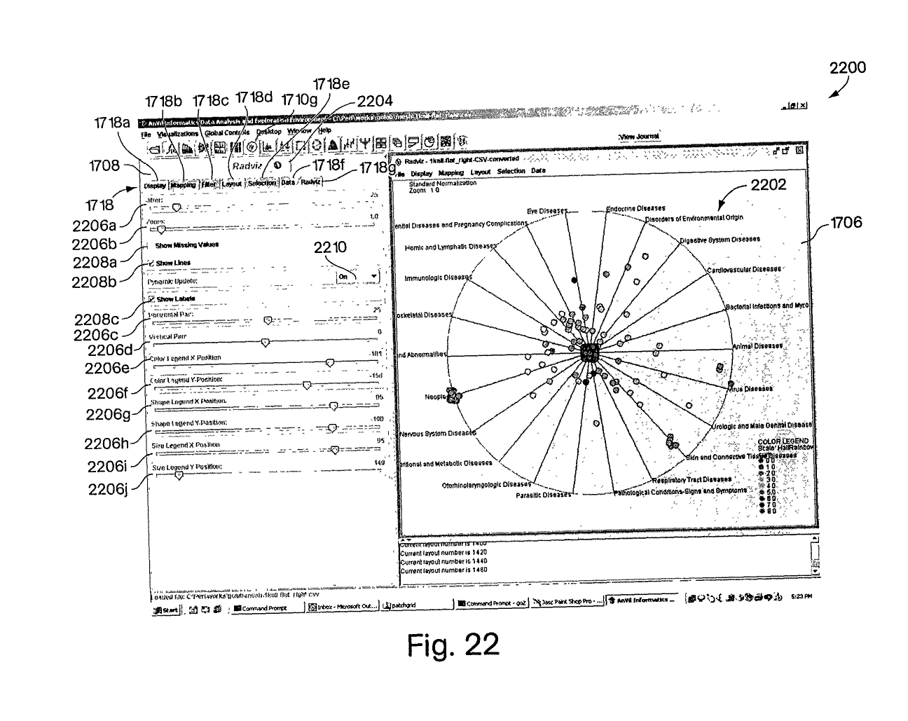

To display the selected entries of table 2102 in a radial visualization, the operator activates the icon 1710g. In response, the GUI 106 provides the screen display of FIG. 22.

FIG. 22 is a GUI screen image 2200 depicting in the display panel 1706 a radial visualization 2202 of operator selected data from the lists 2102 and 2108 of FIG. 21. In the control panel 1708 a button 2204 is available to activate global parameters during the display of the radial visualization 2202.

The tabs 1718 provide a plurality of control functions. As mentioned above with respect to FIG. 17, these functions include “Display” 1718a, “Mapping” 1718b, “Filter” 1718c, “Layout” 1718d, “Selection” 1718e, “Data” 1718f, and “Radviz” 1718g. In FIG. 22, the operator has activated the Display 1718a button to display the radial visualization 2202 in panel 1706. The screen 2200 also provides a series of controls in the form of sliders 2206a-2206j. The sliders control display details of the panel 1706, including jitter (2206a), zoom (2206b), horizontal pan (2206c), vertical pan (2206d), color legend X position (2206e), color legend Y position (2206f), shape legend X position (2206g), shape legend Y position (2206h), size legend X position (2206i) and size legend Y position (2206j). The screen 2200 also includes a plurality of check box controls 2208a-2208c, which activate or deactivate display features, including show missing values check box 2208a, show lines check box 2208b, and show labels check box 2208c. There is also a pull-down menu box 2210 that enables the operator to control the on/off state of the dynamic update control feature.

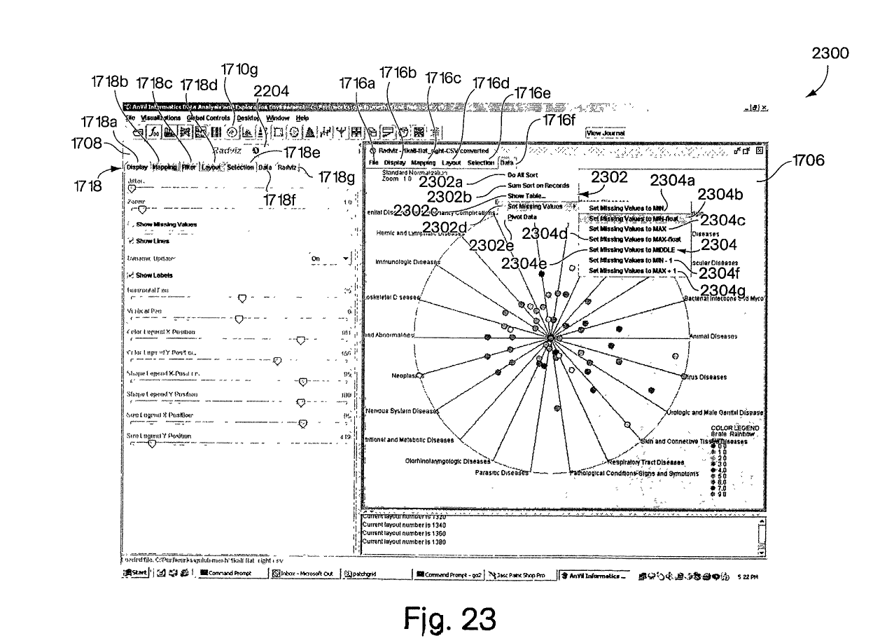

The GUI 106 provides further display controls in the display panel 1706. More specifically, referring to FIG. 23, a screen image 2300 display panel 1706 provides interactive controls as pull down menus from individual entries 1716a-1716f in the menu bar 1716. The entries on the menu bar 1716 are “File” 1716a, “Display” 1716b, “Mapping” 1716c, “Layout” 1716d, “Selection” 1716e, “Data” 1716f, and have functions similar, but not necessarily identical to, the corresponding tabs 1718a-1718g.

In FIG. 23, the menu entry “Data” 1716f is active, and a pull-down menu 2302 is displayed. The pull-down menu 2302 includes the commands “Do All Sort” 2302a, “Sum Sort on Records” 2302b, “Show Table . . . ” 2302c, “Set Missing Values” 2302d, and “Pivot Data” 2302e. The entry “Set Missing Values” 2302d is active, and a second level of pull-down menu 2304 is displayed. The pull-down menu 2304 includes the commands “Set Missing Values to MIN” 2304a, “Set Missing Values to MIN-float” 2304b, “Set Missing Values to MAX” 2304c, “Set Missing Values to MAX-float” 2304d, “Set Missing Values to MIDDLE” 2304e, “Set Missing Values to MIN−1” 2304f, and “Set Missing Values to MAX+1” 2304g. Each of the commands 2304a-2304g performs a particular calculation and enters the result of that calculation in any value that is missing in a particular set of data. As those of skill in the computer programming arts will appreciate, many different commands and many different functions having plural levels of pull-down menus can be implemented without deviating from the scope of the invention. The illustrative example presented here is to be taken as one example of a control function provided by the GUI 106. As shown next, the GUI 106 also provides control functions that enable the operator to introduce operator-selected information. Other missing value imputations are possible.

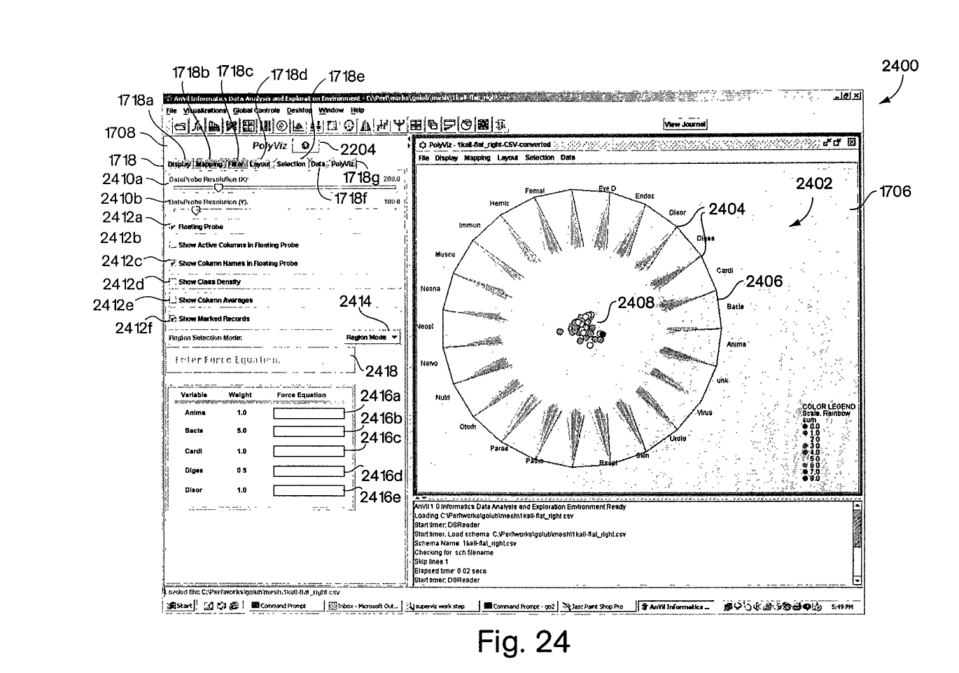

FIG. 24 is a GUI screen image 2400 depicting a multi-dimensional polygonal visualization 2402 in the display panel 1706 according to an illustrative embodiment of the invention. The polygonal visualization 2402 includes a number of records 2408 disposed at locations determined in relation to a plurality of attributes 2404 by way of the methodology discussed above with respect to FIGS. 14A-15C. The attributes on the locus of the circle are extended to form lines. This line now represents the attribute with the minimum value at one end of the line and the maximum value at the other. Thus, it is an axis and this yields a polygonal display. Each record in the display has a value for that attribute and the line from the attribute value points to the record. In many cases the values for each attribute have a distribution which is represented on the attribute line, thus yielding multiple lines pointing to the records. This is similar to parallel coordinates for which the lines represent the axes. In FIG. 24, the control panel 1708 includes a button 2404 which enables an operator to activate global parameters during the display of the polygonal visualization 2402, and slider controls 2410a and 2410b which control the resolution of data in the X and Y directions, respectively. The control panel 1708 of FIG. 24 also includes a plurality of check boxes 2412a-2412f. The check boxes 2412a-2412f control whether a floating probe is displayed, and if so, the features of the information displayed using to the floating probe. The floating point probe displays actual attribute values. The control panel 1708 further includes a pull-down menu 2414 which selects a region mode. The region mode menu 2414 enables an operator to select a region of the visualization 2402 for display and/or analysis by way of a pointing device, such as a mouse. The control panel 1708 also provides a series of user interactive dialog boxes 2416a-2416e for manipulating the forces applied to the records 2808 during plotting on the locus 2406. An operator enters a desired force equation in the dialog box 2418. To enter a force equation into any of the dialog boxes 2416a-2416e, the operator enters the force equation in the dialog box 2418 and then selects one or more dialog boxes 2416a-2416e to indicate to which of the attributes the entered force equation is to be applied.

As described above, the illustrative record categorization subsystem 104 uses the force equations to plot the records 2408 on the locus 2406. By way of example, an equation for “spring” force as defined by the classic Hooke's Law may be entered into any or all of the dialog boxes 2416a-2416e.

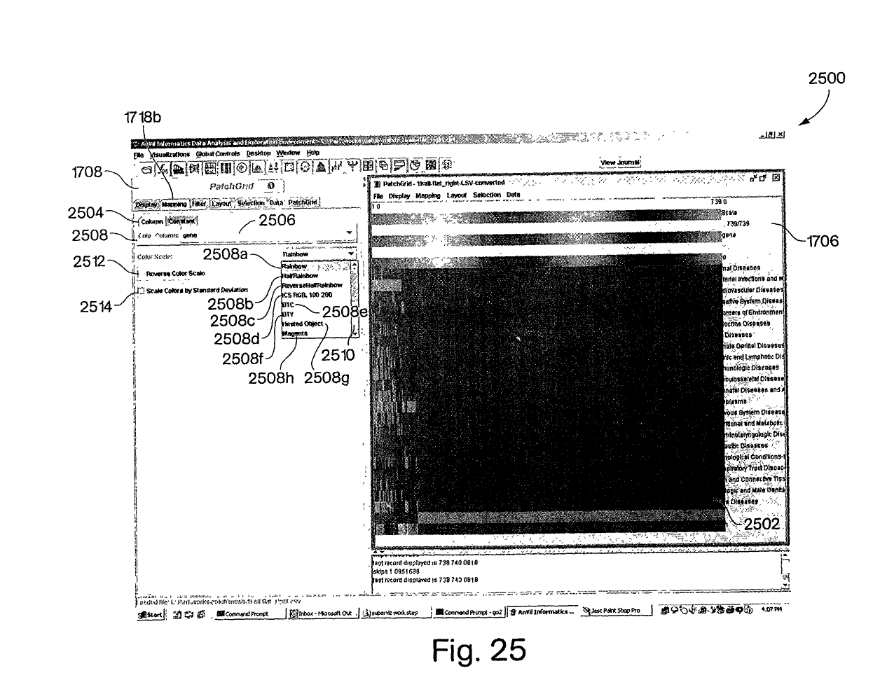

FIG. 25 is a GUI screen image 2500 depicting an interface for interacting with the attribute reduction subsystem 102 according to an illustrative embodiment of the invention. As shown, the display panel 1706 of FIG. 25 is displaying a binned table 2502 according to an illustrative embodiment of the attribute reduction subsystem 102. The control panel 1708 of the screen 2500 has the “Mapping” control tab 1718b activated. The operator also has the “Column” tab 2504 selected, causing a series of controls to be visible in control panel 1708. These controls include a “Color Column” pull-down menu 2506 which has as the selected column “gene.” There is a “Color Scale” pull-down menu 2508, which has “Rainbow” 2508a as the active selection out of the possible selections “Rainbow” 2508a, “HalfRainbow” 2508b, “ReverseHalfRainbow” 2508c, “ICS RGB, 100-200” 2508d, “BTC” 2508e, “BTY” 2508f, “Heated object” 2508g, and “Magenta” 2508h. The color scale pull-down menu 2508 also includes a slider control 2510 for accommodating longer lists of color scale options. The control panel 1708 also includes the “Reverse Color Scale” checkbox 2512 and the “Scale Colors by Standard Deviation” checkbox 2514.

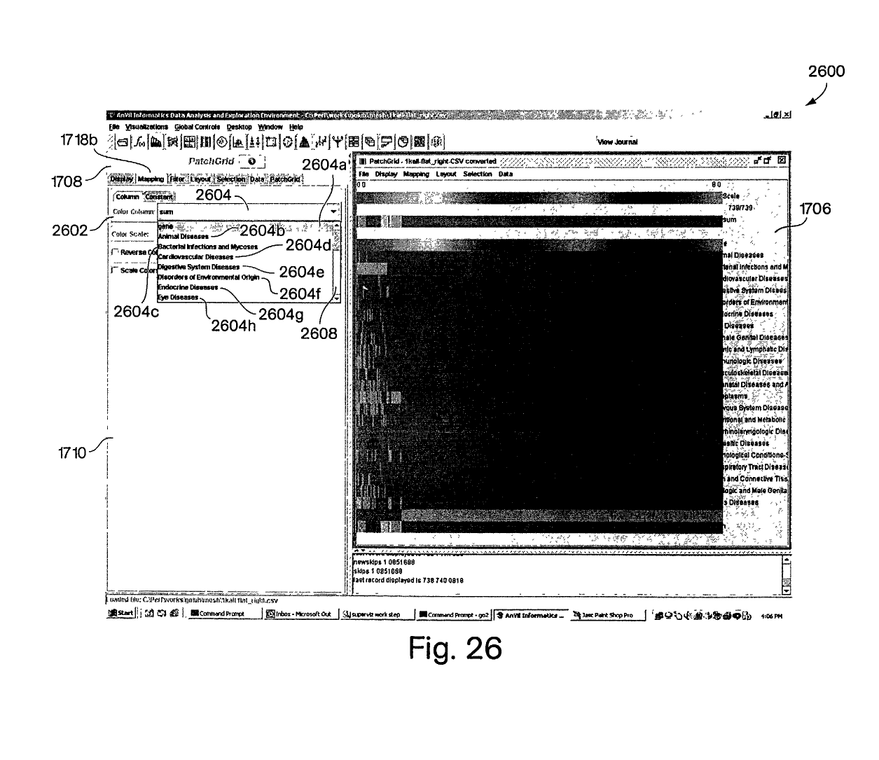

FIG. 26 is a GUI screen image 2600 depicting the visualization of FIG. 25, subsequent to the operator selecting the “Color Columns” box 2602 and the “Sum” pull-down menu 2604. The control panel 1708 of FIG. 26 has the “Mapping” control button 1718b activated. Selection of the “Sum” pull-down menu lists the column selections “gene” 2604a, “Animal Diseases” 2604b, “Bacterial Infections And Mycoses” 2604c, “Cardiovascular Diseases” 2604d, “Digestive System Diseases” 2604e, “Disorders Of Environmental Origin” 2604f, “Endocrine Diseases” 2604g, and “Eye Diseases” 2604h. The slider control 2608 enables more possible selections to be displayed.

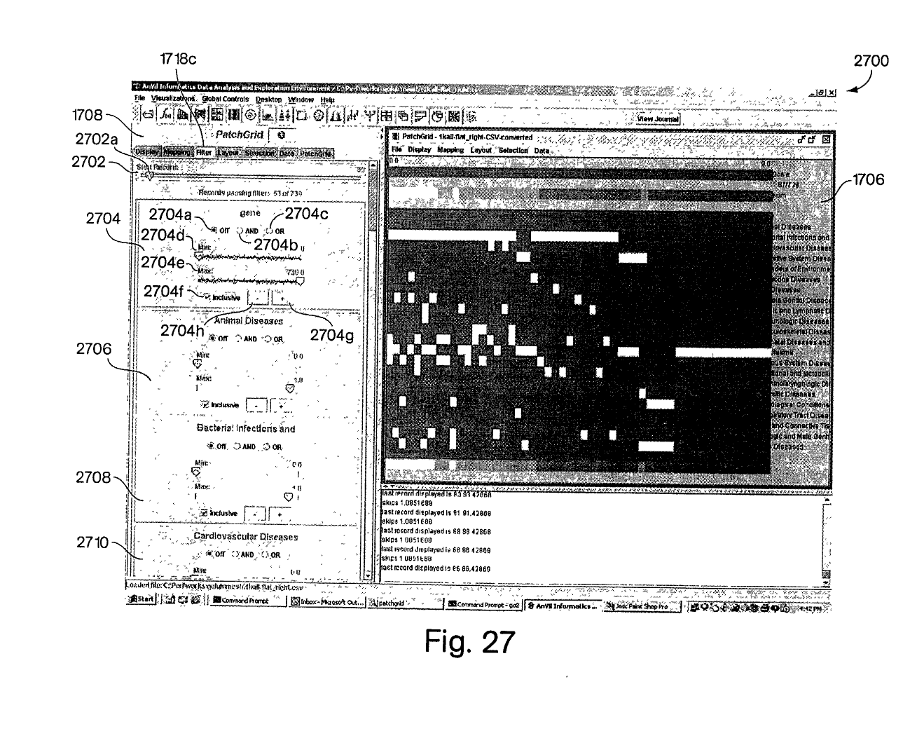

As discussed above, the illustrative attribute reduction subsystem 102 provides the operator with a variety of analytical tools, such as mathematical filters to improve the ability of the operator to investigate data sets. FIG. 27 is a GUI screen 2700 adapted to enable the operator to apply selected analytical tools during operation of the attribute reduction subsystem 102. In FIG. 27, the display panel 1706 displays a binned data table according to an illustrative embodiment of the attribute reduction subsystem 102. The control panel 1708 of FIG. 27 has the “Filter” control button 1718c activated. The control panel 1708 of FIG. 27 includes a plurality of subpanels 2702-2710. The subpanel 2702 has a slider control 2702a that allows the operator to select a first record for filtering from the entire set of records in a dataset. The subpanels 2704-2710 each enables the operator to define details of the processing of a particular dataset. Only subpanel 2704 will be described in detail, as the other panels function in a similar manner. According to the illustrative embodiment, the GUI 106 provides a subpanel similar to the subpanel 2704 for every dataset in the accessible library of datasets.

The subpanel 2704 includes a group of radio button controls “Off” 2704a, “AND” 2704b and “OR” 2704c. Activating one of the radio buttons 2704a-2704c automatically ANDs or ORs all records. The subpanel 2704 also provides the slider controls “Min” 2704d and “Max” 2704e, which enables an operator to define a minimum and a maximum attribute number for inclusion in the a result-effect attribute subset. The “Inclusive” check box control 2704f, when checked, enables the operator to determine the range between the maximum and minimum attributes that are included. When not checked, the “Inclusive” check box 2704f causes the attributes below the Min and above the Max to be included. The “Plus” push-button control 2704g and “minus” push-button control 2704h, when activated, cause the selected values between Min and Max to increment for plus, and decrement for Minus, by the quantity defined by Max minus Min.

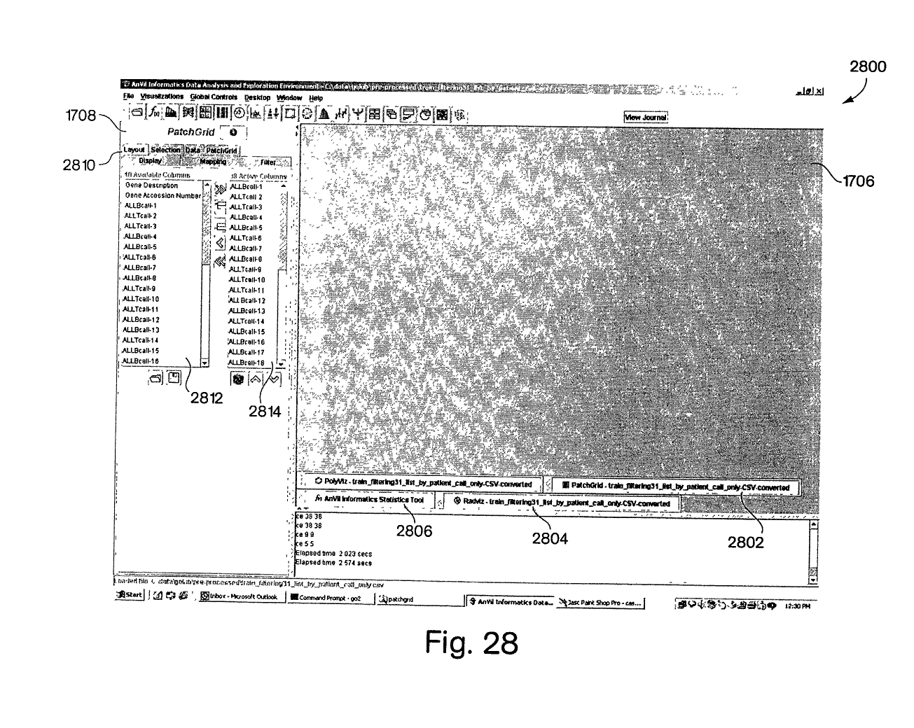

FIG. 28 is a GUI screen 2800 illustrating various table layout features of the illustrative attribute reduction subsystem 102. In FIG. 28, the display panel 1706 displays icons representing the attribute reduction subsystem (icon 2802), a record categorization subsystem embodiment employing a radial visualization (icon 2804), a record categorization embodiment employing a polygonal visualization (icon 2806), and a statistical tool (icon 2808). The control panel 1708 of FIG. 28 has the “layout” tab 2810 activated. With the “layout” tab 2810 activated, the control panel 1708 displays a list of available columns 2812, and a list of active columns 2814.

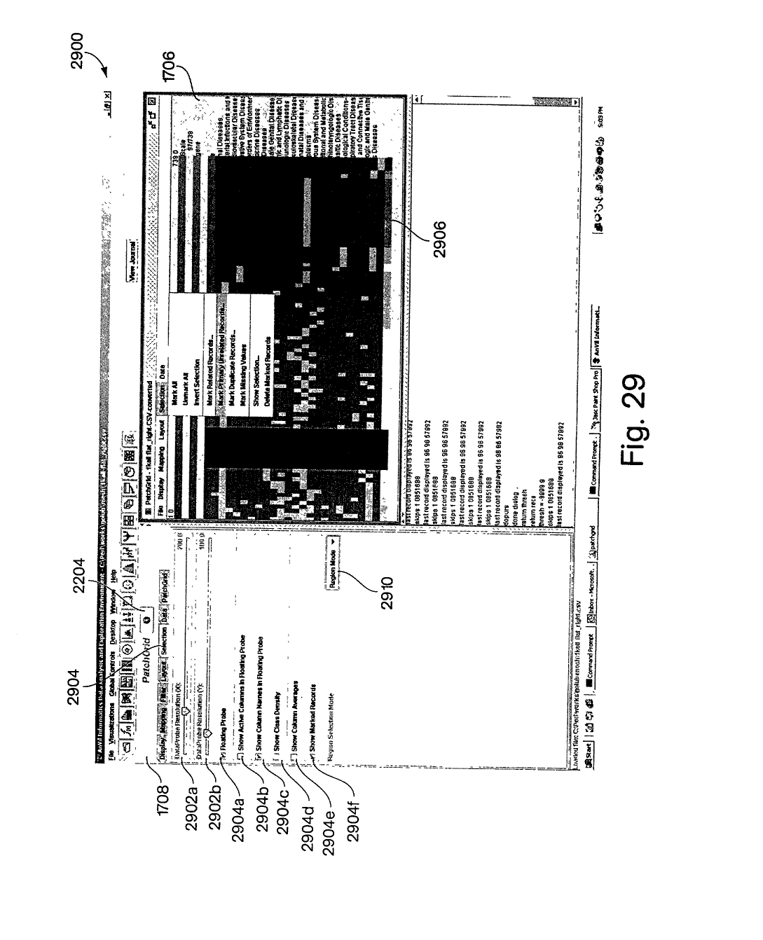

FIG. 29 is a GUI screen image 2900 illustrating attribute reduction subsystem 102 features available with the “Selection” tab active. In FIG. 29, a gray scale binned table 2906 is displayed in the display panel 1706. The control panel 1708 of FIG. 29 includes a button 2204 which enables the operator to activate global parameters, along with a series of slider controls 2902a, 2902b which control the resolution of data in the X and Y directions, respectively. The control panel 1708 also includes a series of check box controls 2904a through 2904f, which control whether a floating probe is displayed, and that features of information displayed using the floating probe. The control panel 1708 further include a pull-down menu control 2910, which selects a region mode.

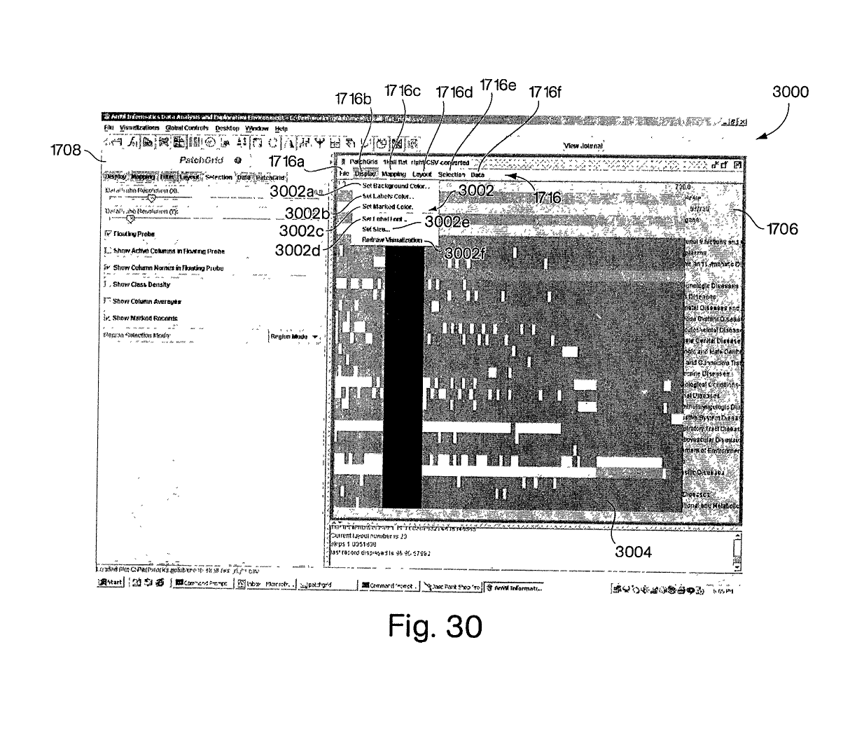

FIG. 30 a GUI screen image 3000 illustrating the “Display” pull-down menu. In FIG. 30, the entry “Display” menu 1716b has been activated. The resulting pull-down menu 3002 is shown to include entries “Set Background Color . . . ” 3002a, “Set Labels Color . . . ” 3002b, “Set Marked Color . . . ” 3002c, “Set Label Font . . . ” 3002d, “Set Size . . . ” 3002e, and “Redraw Visualization” 3002f. The use of the pull-down menu commands 3002a-3002f follows the conventional method of highlighting a command with a mouse or other pointing device and activating the highlighted command with an action such as a mouse button click. The commands 3002a-3002c are used to set a color for a specific feature or region of a visualization. The “Set Label Font . . . ” command 3002d sets the font used in a label. The “Set Size . . . ” command 3002e sets the size of the gray scale binned table 3004 in an analogous fashion to zooming. The “Redraw Visualizations” command 3002f causes the display panel 1706 to be refreshed with one or more visualizations 3004 using the most current information.

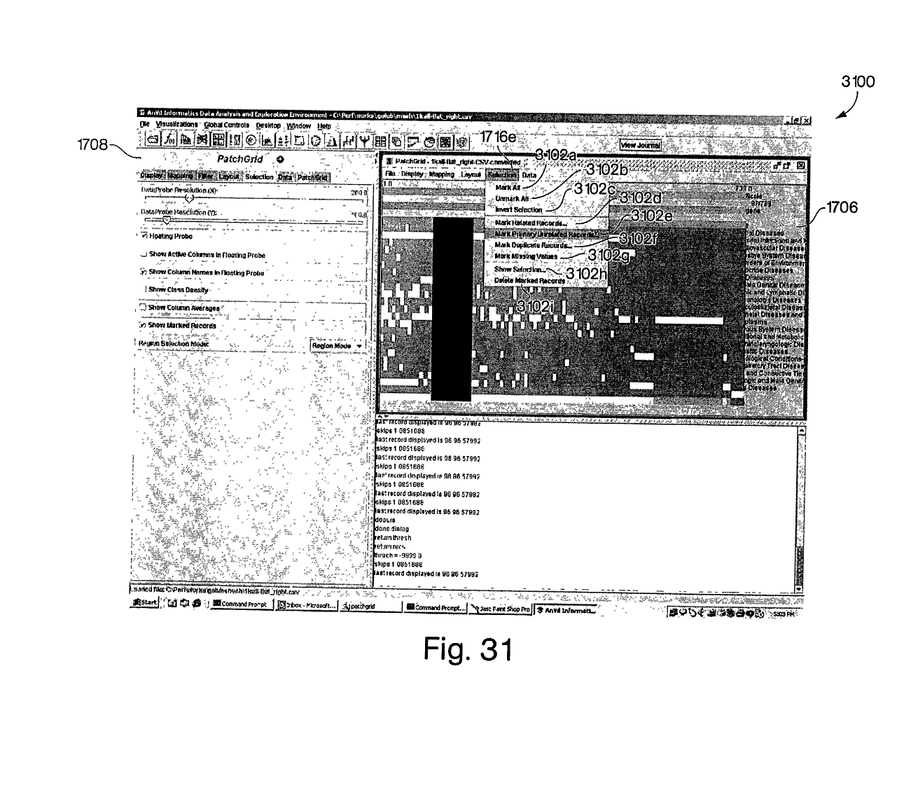

FIG. 31 is a GUI screen image 3100 illustrating the features of the “Selection” pull-down menu 1716e. In FIG. 31, the “Selection” menu 1716e has been activated. The resulting pull-down menu 3102 includes entries “Mark All” 3102a, “Unmark All” 3102b, “Invert Selection” 3102c, “Mark Related Records . . . ” 3102d, “Mark Primary Unrelated Records . . . ” 3102e, “Mark Duplicate Records . . . ” 3102f, “Mark Missing Value” 3102g, “Show Selection . . . ” 3102h, and “Delete Marked Records” 3102i. The use of the pull-down menu commands 3102a-3102i follows the conventional method of highlighting a command with a mouse or other pointing device and activating the highlighted command with an action such as a mouse button click. The “Mark”/“UnMark” commands 3102a, 3102b, 3102d-3102g and 3102i are used to identify the records or values that comport with the specific condition. The “Invert Selection” command 3102c selects the previously unselected entries and unselects the previously selected entries. The “Show Selection . . . ” command 3102h causes the display panel 1706 to present the numerical values corresponding to the selected items.

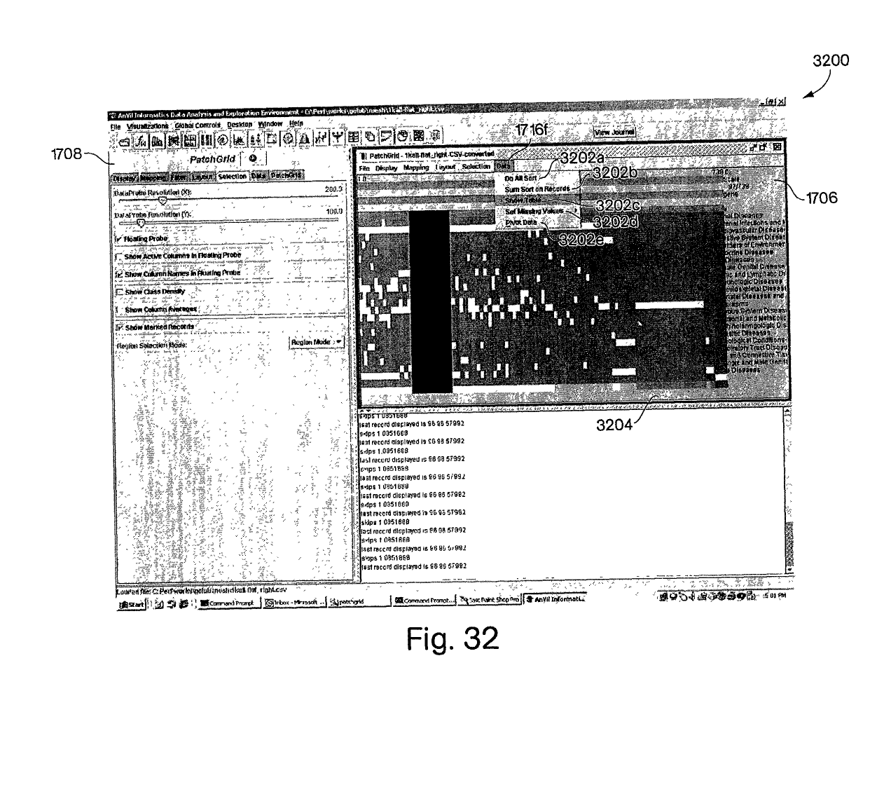

FIG. 32 is a GUI screen image 3200 illustrating the “Data” pull-down menu 1716f. In FIG. 32, the “Data” 1716f menu has been activated. The resulting pull-down menu 3200 includes entries “Do All Sort” 3202a, “Sum Sort of Records” 3202b, “Show Table . . . ” 3202c, “Set Missing Values” 3202d, and “Pivot Data” 3202e. The use of the pull-down menu commands 3202a-3202e follows the conventional method of highlighting a command with a mouse or other pointing device and activating the highlighted command with an action such as a mouse button click. The “Sort” commands 3202a and 3202b are used to sort by rows or columns in the gray scale binned table 3204. The “Show Table . . . ” command 5360c displays the numerical data corresponding to entries in the table 3204. The “Set Missing Values” command 3202d inserts missing values according to the condition assigned by the operator for missing values, as discussed above, or in the absence of such action by the operator, inserting default values. The “Pivot Data” command 3202e causes the exchange of rows and columns in the table 3204.

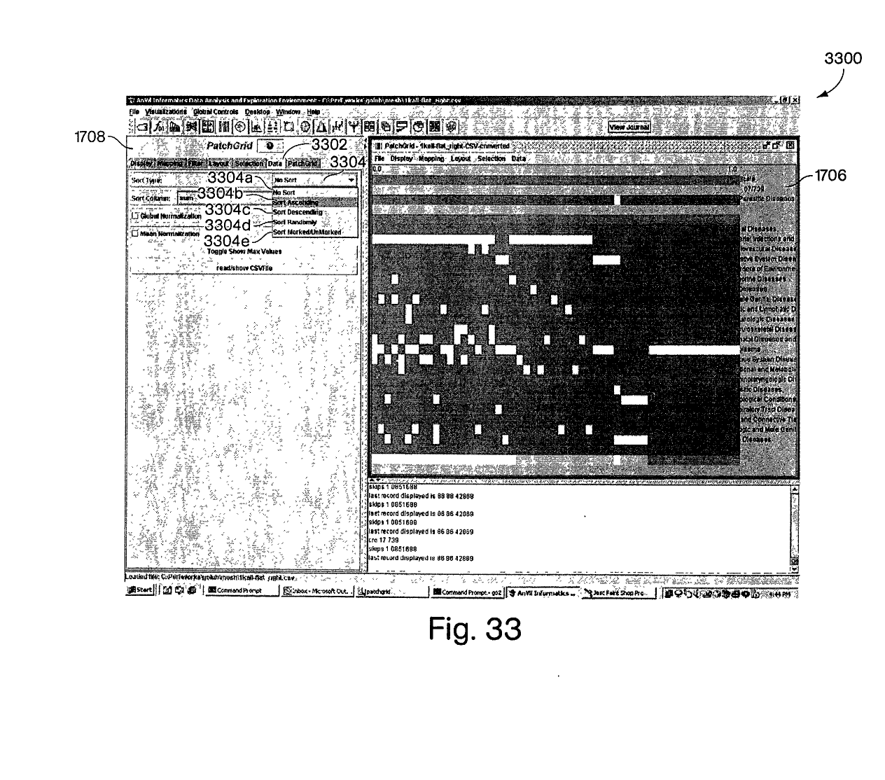

FIG. 33 is a GUI screen image 3300 illustrating features of the “Data” tab 3302 of the control panel 1708. In FIG. 33, “Data” tab 3302 and a pull-down menu 3304 are active. The pull-down menu 3304a includes the commands “No Sort” 3304a, “Sort Ascending” 3304b, “Sort Descending” 3304c, “Sort Randomly” 3304d, “Sort Marked/Unmarked” 3304e. The sort commands 3304a-3304e control whether a sort will be performed, and if so, how the sort will be organized. The “No Sort” command 3304a inhibits sorting. The “Sort Ascending” command 3304b provides a sort beginning with a lowest number or earliest letter in the alphabet as the identifier. The “Sort Descending” command 3304c provides a sort beginning with a highest number or latest letter in the alphabet as the identifier. The “Sort Randomly” command 3304d provides a sort that is randomized, using any of the well known random number generators, including a hardwired random number generator. The “Sort Marked/Unmarked” command 3304e provides a sort in which marked entries are grouped together, and unmarked entries are grouped in a separate group.

It is contemplated that the foregoing methods and computer systems have a variety of applications in many different and diverse fields. For example, it is contemplated that the methods and compositions of the invention may be used to advantage in the exemplary fields of geology, biology, chemistry, genomics, proteomics, metabolomics, toxicology, health care, administration, finance, sales and marketing, manufacturing, security, and consumer products.

Biotechnology Applications

With regard to the health care field, it is contemplated that the methods and systems of the invention may be used to identify individuals susceptible or predisposed to developing a particular disorder. As a result, this information may be used prophylactically and/or therapeutically in patient management. With regard to prophylactics, the individual may be educated to modify lifestyle, for example, diet or exercise, so as to reduce the risk of developing a particular disorder. With regard to therapeutics, the information can be used to provide a treatment regime (for example, a drug treatment regime) tailored to that particular individual. This type of information, referred to as pharmacogenomics or proteomics, can be used to maximize treatment efficacy and/or minimize side effects during a therapeutic protocol.

More particularly, use of the invention permits the skilled artisan to identify attributes, for example, biological markers, that correlate with a particular phenotype, for example, a disease affected phenotype. For example, the invention can be used identify a plurality of markers that are present in tissue or fluid sample that correlate with the incidence of a particular disease state. By analyzing the same attributes in an individual of interest using the multi-dimensional representations of the invention, the skilled artisan can determine whether the individual has a particular phenotype or has a predisposition to developing the particular phenotype. As mentioned above, the skilled artisan may use this information prophylactically and/or therapeutically.

It is contemplated that the predisposition to any particular phenotype may be identified in any organism for interest. Preferred organisms include mammals, which include, for example, farm animals, for example, a member of the bovine, equine and porcine species as well as domestic animals, for example, a member of the canis and feline species. More preferably, however, the organism of interest is a human.

It is contemplated that the methods and systems of the invention can be used to identify a predisposition to a variety of disorders or disease states. For example, it is contemplated that the methods and systems can be used to determine whether an individual is susceptible to one or more medical disorders. Exemplary medical disorders, include, for example, susceptibility to infection, cardiovascular disorders (including, for example, high blood pressure, heart failure, congenital heart disease, pericardial disease, atherosclerosis, myocardial infraction, ischemic heart disease), respiratory tract disorders (including, for example, asthma, pneumonia, cystic fibrosis, pulmonary hypertension, sleep apnea), renal disorders (including, for example, acute or chronic renal failure, glomerulopathies, hereditary tubular disorders), gastrointestinal disorders (including, for example, peptic ulcers, ulcerative colitis, Crohn's disease, irritable bowel syndrome, hepatitis, cirrhosis, bilirubin metabolism acute and chronic pancreatitis), immune disorders, disorders of the joints (including, for example, arthritis, for example, rheumatoid arthritis and osteoarthritis), disorders of endocrinology and metabolism (including, for example, thyroid disorders, diabetes, growth disorders, disorders of lipoprotein metabolism, lysosomal storage diseases, glycogen storage diseases, galactosemia), disorders of bone and mineral metabolism (including, for example, Paget's disease, metabolic bone disease), neurological disorders (including, for example, migraines, seizures, epilepsy, Alzheimer's disease, Parkinson's disease, motor neuron diseases), disorders of nerve and muscle (including, for example, chronic fatigue syndrome), alcoholism and drug dependency.

In addition, the methods and systems of the invention can be used to (i) identify in an individual a susceptibility to cancer, (ii) identify a susceptibility to subforms of cancer, (iii) identify individuals that may respond to a particular treatment modality so as to optimize efficacy and where ever possible to minimize side-effects. It is contemplated that the methods and systems can be used to advantage in the management of the following types of cancer which include, for example, a carcinoma (for example, adenocarcinoma, basal cell carcinoma, bile duct carcinoma, breast carcinoma, bronchogenic carcinoma, cervical carcinoma, choriocarcinoma, colorectal carcinoma, embryonal carcinoma, hepatocellular carcinoma, medullary carcinoma, melanocarcinoma or melanoma, ovarian carcinoma, pancreatic carcinoma, papillary adenocarcinoma, papillary carcinoma, prostate carcinoma, renal cell carcinoma, sebaceaous gland carcinoma, seminoma, squamous cell carcinoma, sweat gland carcinoma, teratocarcinoma testicular carcinoma, and transitional cell carcinoma), adenoma (including, for example, bronchial adenoma), sarcoma (including, for example, angiosarcoma, chondrosarcoma, endotheliosarcoma, Ewing's sarcoma, fibrosarcoma, Kaposi's sarcoma, liposarcoma, lymphangiosarcoma, mesotheliosarcoma, myxosarcoma, osteogenic sarcoma, rhabdomyosarcoma, and synoviosarcoma), leukemia (including, for example, acute myeloid leukemia, acute lymphoblastic leukemia, chronic myelogenous leukemia, chronic lymphocytic leukemia, monocytic leukemia, and hairy cell leukemia), lymphoma (including, for example, Hodgkin's lymphoma, malignant lymphoma, and non-Hodgkin's lymphoma (for example, Burkitt's lymphoma, Diffuse large cell lymphoma, and lymphoblastic lymphoma)) and myeloma (including, for example, multiple myeloma or plasacytoma).

In particular, it is contemplated that the methods and systems of the invention may be used in the management of bladder cancer, brain cancer, breast cancer, cervical cancer, colon cancer, colorectal cancer, endometrial cancer, kidney cancer, lymphoma, leukemia, liver cancer, lung cancer, ovarian cancer, pancreatic cancer, prostate cancer, sarcoma, skin cancer, stomach cancer, testicular cancer, and uterine cancer.

It is contemplated that the attribute of interest may be measured in any biological sample using techniques well known in the art. For example, the biological sample can include, for example, a tissue sample or a body fluid sample. The tissue sample, can include, for example, a biopsy of any tissue of interest, for example, bladder, blood vessel, bone, brain, cartilage, colon, colorectal tissue, connective tissue, hair, heart, intestine, kidney, liver, lung, muscle, membrane, nerve, pancreas, skin, spleen, stomach, tendon, thyroid, thymus. It is contemplated that the body fluid can include, for example, ascitic fluid, bile, blood, breast exudate, feces, mucous, peritoneal fluid, plasma, saliva, semen, serum, spinal fluid, sputum, and urine.

Furthermore, it is contemplated the methods and systems are not limited by the types of attributes, namely the biological markers, that can be used to identify or monitor a particular type of predisposition. It is contemplated, however, that the biological marker is a gene expression product. The gene expression product can include, without limitation, a nucleic acid sequence, for example, a DNA sequence or RNA sequence, for example, mRNA, a protein or peptide sequence, a carbohydrate, a fatty acid or lipid, a metabolite, a hormone, or a combination of the foregoing.

Once the biological markers of interest have been identified they may be measured in any test sample of interest. For example, when an individual whose predisposition is unknown, a sample, for example, a tissue or body fluid sample, is drawn from the individual and then the amount of each marker quantified using conventional methodologies in the art.

For example, when the marker is a protein or peptide, the amount of a particular protein or peptide in a sample can be measured using a variety of protein quantitation methodologies known in the art. These may involve direct or indirect quantitation of the marker protein or peptide in the sample.

With regard to the direct quantitation approach, the marker proteins or peptides may be detected using one- or two-dimensional gel electrophoresis techniques known in the art. In one-dimensional gel electrophoresis, the proteins or peptides are separated based on molecular weight. In two-dimensional gel electrophoresis, the proteins are first separated in a pH gradient gel according to their isoelectric point. The resulting gel then is placed on a second polyacrylamide gel, and the proteins separated according to molecular weight.

One or more marker proteins may be detected by first isolating proteins from a sample obtained from an individual of interest. The marker proteins then are separated by gel electrophoresis (either one- or two-dimensional gel electrophoresis) to produce a characteristic gel electrophoresis pattern. The resulting gels then are stained, for example, with Coommassie Blue stain or silver stain. The quantity of the marker proteins may then be estimated by measuring the color present for each marker protein and then comparing the amount of color present against a standard curve prepared using different amounts of the marker protein or peptide separated and stained in the same or similar manner.

In another approach, the amount of a protein or peptide present in a biological sample can be determined by mass spectroscopy. The samples may be analyzed using matrix assisted desorption/ionization-time of flight (MALDI-TOF) mass spectroscopy or by surface enhanced laser desorption/ionization-time of flight (SELDI-TOF) mass spectroscopy. For a more detailed discussion, see, for example, U.S. Pat. No. 5,719,060. In the practice of the SELDI-TOF approach, several different surfaces are available commercially from Ciphergen Biosystems, Inc., Palo Alto, Calif.

With regard to the indirect approaches, the amount of a marker protein or peptide of interest can determined using one or more binding partners or binding moieties. In this approach, the marker protein or peptide is permitted to react with a binding moiety capable of specifically binding the marker protein or peptide. The binding moiety may comprise, for example, a member of a ligand-receptor pair, i.e., a pair of molecules capable of having a specific binding interaction. The binding moiety may comprise, for example, a member of a specific binding pair, such as an antibody-antigen, enzyme-substrate, nucleic acid-nucleic acid, protein-nucleic acid, protein-protein, or other specific binding pair known in the art. Optionally, the binding moiety may be linked with a detectable label, such as an enzymatic, fluorescent, radioactive, phosphorescent or colored particle label. The labeled complex may be detected, e.g., visually or with the aid of a spectrophotometer or other detector.

In a preferred approach, the amount of a marker protein or peptide can be determined using a variety of immunoassays that employ an immunologically reactive binding moiety that binds specifically to an epitope defined by the marker protein or peptide. The immunologically reactive binding moiety may include, for example, an antibody (for example, a monoclonal or polyclonal antibody), antigen binding fragments thereof (for example, an Fv fragment, an Fab fragment, an Fab′ fragment), or a biosynthetic antibody binding site.

In general, immunoassay design considerations include preparation of antibodies (e.g., monoclonal or polyclonal antibodies) having sufficiently high binding specificity for the target protein to form a complex that can be distinguished reliably from products of nonspecific interactions. As used herein, the term “antibody” is understood to mean binding proteins, for example, antibodies or other proteins comprising an immunoglobulin variable region-like binding domain, having the appropriate binding affinities and specificities for the target or marker protein or peptide. The higher the antibody binding specificity, the lower the target protein concentration that can be detected. A preferred binding specificity is such that the binding protein has a binding affinity for the target protein or peptide of greater than about 10⁵ M⁻¹, preferably greater than about 10⁷ M⁻¹.

Antibodies that bind a marker protein which are useful in the practice of the invention may be obtained commercially or generated using standard immunological procedures well known and described in the art. Briefly, an isolated target protein or peptide is used to raise antibodies in a xenogeneic host, such as a mouse, goat or other suitable mammal. The marker protein or peptide is combined with a suitable adjuvant capable of enhancing antibody production in the host, and injected into the host, for example, by intraperitoneal administration. Any adjuvant suitable for stimulating the host's immune response may be used. A commonly used adjuvant is Freund's complete adjuvant (an emulsion comprising killed and dried microbial cells). Where multiple antigen injections are desired, the subsequent injections comprise the antigen in combination with an incomplete adjuvant (e.g., cell-free emulsion).

Polyclonal antibodies may be isolated from the antibody-producing host by extracting serum containing antibodies to the protein of interest. Monoclonal antibodies may be produced by isolating host cells that produce the desired antibody, fusing these cells with myeloma cells using standard procedures known in the immunology art, and screening for hybrid cells (hybridomas) that react specifically with the target protein and have the desired binding affinity.

Antibody binding domains also may be produced biosynthetically and the amino acid sequence of the binding domain manipulated to enhance binding affinity with a preferred epitope on the target protein. Specific antibody methodologies are well understood and described in the literature.

In addition, genetically engineered biosynthetic antibody binding sites, also known in the art as BABS or sFv's, may be used in the practice of the instant invention. Methods for making and using BABS include (i) non-covalently associated or disulfide bonded synthetic V_{H} and V_{L} dimers, (ii) covalently linked V_{H}-V_{L} single chain binding sites, (iii) individual V_{H} or V_{L} domains, and (iv) single chain antibody binding sites. Furthermore, BABS having requisite specificity for the marker protein can be derived by phage antibody cloning from combinatorial gene libraries. Briefly, a library of phage each of which express on their coat surface, BABS having immunoglobulin variable regions encoded by variable region gene sequences derived from mice pre-immunized with the marker protein or peptide are screened for binding activity against immobilized marker protein or peptide. Phage which bind to the immobilized marker protein or peptide are harvested and the gene encoding the BABS sequenced. The resulting nucleic acid sequences encoding the BABS of interest then may be expressed in conventional expression systems to produce the BABS protein.

Once obtained, the binding proteins may be employed in one or more immunoassay formats. For example, the skilled artisan may employ the sandwich immunoassay format to measure the amount of the marker protein in a body fluid sample. Alternatively, the skilled artisan may use conventional immuno-histochemical procedures for measuring the amount of marker protein in a tissue sample, using one or more labeled binding proteins.

In a sandwich immunoassay, two antibodies capable of binding the marker protein generally are used, e.g., one immobilized onto a solid support, and one free in solution and labeled with detectable chemical compound. Examples of chemical labels that may be used for the second antibody include radioisotopes, fluorescent compounds, colored particles and enzymes or other molecules which generate colored or electrochemically active products when exposed to a reactant or enzyme substrate. When a sample containing the marker protein is placed in this system, the marker protein binds to both the immobilized antibody and the labeled antibody, to form a “sandwich” immune complex on the support's surface. The complexed protein is detected by washing away non-bound sample components and excess labeled antibody, and measuring the amount of labeled antibody complexed to protein on the support's surface.

Both the sandwich immunoassay and the tissue immunohistochemical procedure are highly specific and very sensitive, provided that labels with good limits of detection are used. Furthermore, it is contemplated that by using arrays, multiple marker proteins or peptides in a sample may be quantitated simultaneously.

When the marker is a nucleic acid, for example, mRNA, the amount of the particular nucleic acid in a sample can be measured using a variety of quantitation methodologies known in the art. Preferred methods currently employ nucleic acid hybridization and/or amplification techniques.

A target nucleic acid molecule can be detected using a labeled binding moiety, capable of specifically binding the target nucleic acid. The binding moiety may comprise, for example, a protein, a nucleic acid or a peptide nucleic acid. Additionally, a target nucleic acid, such as an mRNA encoding a gene of interest, may be detected and quantitated by conducting, for example, a Northern blot analysis using labeled oligonucleotides, e.g., nucleic acid fragments complementary to and capable of hybridizing specifically with at least a portion of a target nucleic acid. While any length oligonucleotide may be utilized to hybridize an mRNA transcript, oligonucleotides typically within the range of 8-100 nucleotides, more preferably within the range of 10-75 nucleotides, and most preferably within the range of 15-50 nucleotides, are envisioned to be most useful in standard hybridization assays. Complete complementarity is desirable for use as probes, although it may be unnecessary as the length of the probe is increased. It is known in the art that the particular stringency conditions sleeted for a hybridization reaction depend largely upon the degree of complementarity of the binding partner nucleic acid sequence with the target sequence, the composition of the binding sequence, and the length of the binding sequence. The parameters for determining stringency conditions are well known to those of ordinary skill in the art.

The oligonucleotide selected for hybridizing to the target nucleic acid, whether synthesized chemically or by recombinant DNA methodologies, is isolated and purified using standard techniques and then preferably labeled (e.g., with ³⁵S or ³²P) using standard labeling protocols. A sample containing the target nucleic acid then is run on an electrophoresis gel, the dispersed nucleic acids transferred to a nitrocellulose filter and the labeled oligonucleotide exposed to the filter under suitable hybridizing conditions. Other useful procedures known in the art include solution hybridization, and dot and slot RNA hybridization. The amount of the target nucleic acid present in a sample optionally then is quantitated by measuring the radioactivity of hybridized fragments, using standard procedures known in the art.

In addition, it is anticipated that the skilled artisan can use amplification-based procedures for measuring the amount of a particular nucleic acid on a sample. For example, by using a combination of appropriate oligonucleotide primers, i.e., more than one primer, the skilled artisan may determine the level of expression of a target gene in vivo by standard polymerase chain reaction (PCR) procedures, for example, by quantitative PCR. PCR is a technique for amplifying a desired nucleic acid sequence (target nucleic acid sequence) contained in a sample. In PCR, a pair of primers typically are employed in excess to hybridize at the outside ends of complementary strands of the target nucleic acid. The primers then are each extended by a polymerase, for example, a thermostable polymerase, using the target nucleic acid as a template. The extension products become target sequences themselves, following dissociation from the original target strand. New primers then are hybridized and extended by the polymerase, and the cycle is repeated to geometrically increase the number of target sequence molecules.

The Ligase Chain Reaction (LCR) is an alternate method for nucleic acid amplification. In LCR, probe pairs are used which include two primary (first and second) and two secondary (third and fourth) probes, all of which are employed in molar excess of the target nucleic acid sequence. The first probe hybridizes to a first segment of the target strand and the second probe hybridizes to a second segment of the target strand, the first and second segments being contiguous so that the primary probes abut one another in a 5′ phosphate-3′ hydroxyl relationship, and so that a ligase can covalently fuse or ligate the two probes into a fused product. In addition, a third (secondary) probe can hybridize to a portion of the first probe and a fourth (secondary) probe can hybridize to a portion of the second probe in a similar abutting fashion. Once the ligated strand of primary probes is separate from the target strand, it will hybridize with the third and fourth probes which can be ligated to form a complementary, secondary ligated product. The ligated products are functionally equivalent to either the target or its complement. By repeated cycles of hybridization and ligation, amplification of the target sequence is achieved.

For amplification of mRNAs, it is within the scope of the present invention to reverse transcribe mRNA into cDNA followed by polymerase chain reaction (RT-PCR); or, to use a single enzyme for both steps; or to reverse transcribe mRNA into cDNA followed by asymmetric gap ligase chain reaction (RT-AGLCR).

Test samples for detecting target sequences can be prepared using methodologies well known in the art such as by obtaining a sample and, if necessary, disrupting any cells contained therein to release target nucleic acids. In the case where PCR is employed in this method, the ends of the target sequences are usually known. In the case where LCR or a modification thereof is employed, the entire target sequence is usually known. Typically, the target sequence is a nucleic acid sequence such as for example, RNA or DNA.

One PCR approach that can be used to advantage is quantitative PCR using real time detection. Thermal Cycling machines useful for this purpose can be purchased under the trade name ROCHE LIGHTCYCLER. The choice of appropriate primers and amplification conditions may be determined by routine experimentation. Real time detection can be achieved using appropriately labeled molecular real time probes.

Molecular real time probes are single-stranded nucleic acid probes that possess a stem-and-loop structure in which the loop portion of the molecule is a probe sequence complementary to the target nucleic acid sequence. The stem is generated by the annealing of two complementary arm sequences, each located at either end of the probe sequence. The arm sequences are unrelated (i.e., not homologous) to the target sequence and each arm is labeled at its end. A fluorescent moiety is attached to one end of the probe, for example, at the 5′ end, and a fluorescence quencher is attached to the other end, for example, at the 3′ end. In its nascent state, the molecular beacon emits no fluorescence because the fluorescent moiety and quencher pair are selected such that energy gained by the fluorophore is transferred to the quencher and is dissipated as heat, an occurrence that is referred to as fluorescence resonance energy transfer (FRET).

At temperatures slightly above the melting temperature (Tₘ), the stem portion of a molecular beacon unfolds and exposes the probe section of the molecule to target strands. Once exposed, the beacon and target can hybridize to one another. Upon hybridization, the molecular beacon undergoes a conformational change whereby the arm sequences of the beacon are forced apart such that the fluorophore and the quencher become spatially separated from each other relative to their spatial positions in the unhybridized state. When the fluorophore is no longer in the proximity of the quenching molecule, FRET is no longer possible, and the fluorophore then emits detectable light of appropriate wavelength when excited. The increase in fluorescence emission can be detected and correlated with the amount of target nucleic acid in the sample.

While the length of the primers and probes can vary, the probe sequences typically are selected such that they have a lower melting temperature than the primer sequences. Hence, the primer sequences are generally longer than the probe sequences. Typically, the primer sequences are in the range of between 20 and 50 nucleotides long, more typically in the range of between 20 and 30 nucleotides long, more typically in the range of between 20 and 30 nucleotides long. Preferred primer sequences typically are greater than 20 nucleotides long. The typical probe is in the range of between 10 and 25 nucleotides long, more typically in the range of between 15 and 20 nucleotides long. Preferred probe sequences typically are greater than 15 nucleotides long.

Various methods for synthesizing primers and probes are well known in the art. Similarly, methods for attaching labels to primers or probes are also well known in the art. For example, it is a matter of routine experimentation to synthesize desired nucleic acid primers or probes using conventional nucleotide phosphoramidite chemistry and instruments available from Applied Biosystems, Inc. (Foster City, Calif.). Many methods have been described for labeling oligonucleotides such as the primers or probes of the present invention. In one type of approach, a detectable label of interest can be introduced into a nucleic acid probe by conventional nick transaction and/or primer extension protocols. Alternatively, a primary amine can be attached to a 3′ oligo terminus using 3′-amine-ON CPG (Clontech, Palo Alto, Calif.). Similarly, a primary amine can be attached to a 5′ oligo terminus using Aminomodifier II (Clontech, Palo Alto, Calif.). The amines can be reacted to various haptens using conventional activation and linking chemistries.

In addition, it is contemplated that the quantities of each of a plurality of target nucleic acids may be measured simultaneously using conventional gene chip technologies available in the art. Gene chips typically comprise a plurality of nucleic acid probes, each of which is immobilized in a different zone on the surface of a silicon wafer. Nucleic acids sequences from the sample of interest and potentially containing a target sequence then are harvested and labeled with a detectable moiety. For example, when the nucleic acid to be analyzed is mRNA, the RNA from a whole cell can be isolated and the mRNA component reversed transcribed into cDNA using reverse transcriptase in the presence of, for example, oligo dT primers and nucleotides, one or more of which is labeled with a detectable moiety. Once prepared, the labeled sample then is applied to the gene chip under conditions that permit the labeled target sequence, if present in the sample, to hybridize to the immobilized probe. After washing to remove the unbound reagents, bound detectable moiety can be detected using conventional detection techniques known in the art.

Preferred detectable moieties include luminescent labels (including, for example, fluorescent labels, chemi-luminescent labels, bioluminescent labels, and colorimetric labels), light scattering labels (including, for example, metal colloids), and radioactive labels (including, for example, ³²P or ³⁵S).

An analysis of individuals with leukemia using gene chips is described in Golub et al. (1999) Science 286:531-537. The investigators used nucleic acids isolated from bone marrow samples obtained from 38 acute leukemia patients (27 ALL, 11 AML) at the time of diagnosis. RNA prepared from the bone marrow mononuclear cells, after labeling, was permitted to hybridize to a high-density oligonucleotide microarray from Affymetrix containing 6817 human gene probes. The quantitative expression level of each gene of interest then was quantitated for each individual. Using the resulting data, the investigators identified several genes, the expression of which correlated with AML and ALL. The same data set was also analyzed using the methods and systems disclosed herein to identify additional genes useful in classifying the different forms of leukemia. The results of which are discussed in more detail below.

### EXAMPLE 1

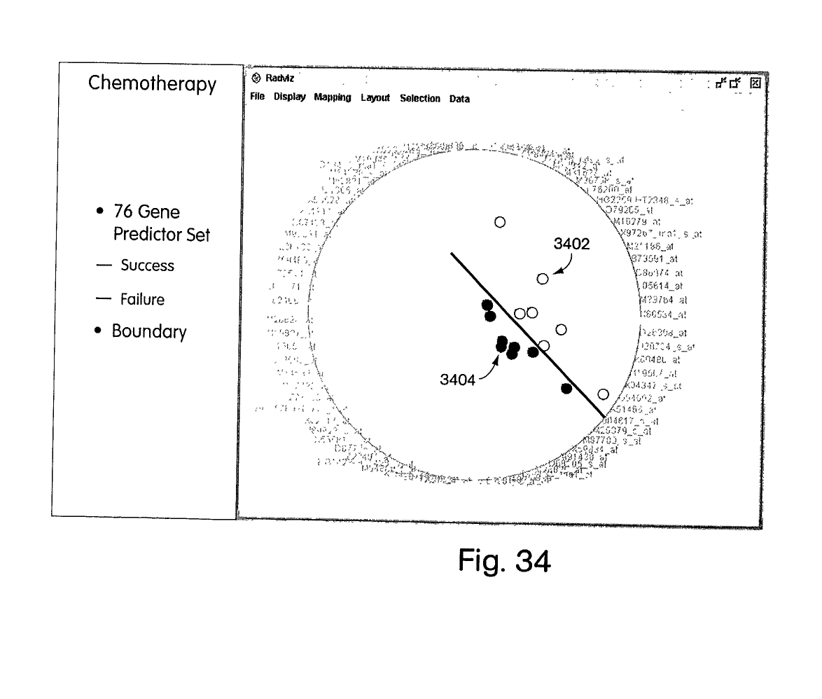

During practice of the invention, it has been discovered that various other subgroups of the 6817 genes, the expression products of which were tested in Golub et al. (1999) supra, can be used to identify and distinguish individuals with AML, B ALL and T ALL. Three classes of genes comprising 76 genes, 57 genes and 3 genes were identified using different forms of the algorithms described herein. For example, 76 gene products have been identified using the methods and systems described herein which can be used to identify AML patients that respond differently to treatment regimes (see, FIG. 34). FIG. 34 shows criteria for distinguishing between individuals 3402 with AML that respond to chemotherapy from those 3404 that do not respond to chemotherapy. The 76 genes are identified in Table 1 below together with their GenBank accession numbers, the sequences of which are incorporated herein by reference. The sequences can be obtained through the National Center for Biotechnology Information (NCBI) web site at www.ncbi.nlm.nih.gov.

TABLE 1
76 Gene Predictor Set for AML.

| | | GenBank |
|---|---|---|
| Gene Product | SEQ. ID. NO.: | Accession No. |
| LST1 mRNA, cLST1/E splice variant | | AF000424 |
| Tumor-associated 120 kDa nuclear | | D13413 |
| protein p120, partial cds | | |
| (carboxyl terminus) | | |
| DEFENDER AGAINST CELL | | D15057 |
| DEATH 1 | | |
| NADPH-flavin reductase | | D26308 |
| GGTB2 Glycoprotein-4-beta- | | D29805 |
| galactosyltransferase 2 | | |
| Ribosomal protein L39 | | D79205 |
| KIAA0220 gene, partial cds | | D86974 |
| KIAA0246 gene, partial cds | | D87433 |
| CAG-isI 7 {trinucleotide repeat- | | D87735 |
| containing sequence} [human, | | |
| pancreas, mRNA Partial, 701 nt] | | |
| Globin, Beta | | HG1428-HT1428 |
| Tubulin, Alpha 1, Isoform 44 | | HG2259-HT2348 |
| Major Histocompatibility Complex, | | HG3576-HT3779 |
| Class Ii Beta W52 | | |
| ANT3 Adenine nucleotide | | J03592 |
| translocator 3 (liver) | | |
| LGALS1 Ubiquinol-cytochrome c | | J04456 |
| reductase core protein II | | |
| EEF1A1 Translation elongation | | J04617 |
| factor 1-alpha-1 | | |
| Cytochorme c oxidase subunit VIII | | J04823 |
| (COX8) mRNA | | |
| GB DEF = Proliferating cell nuclear | | J05614 |
| antigen (PCNA) gene, promoter | | |
| region | | |
| NPY Neuropeptide Y | | K01911 |
| VDAC1 Voltage-dependent anion | | L06132 |
| channel 1 | | |
| High mobility group protein | | L17131 |
| (HMG-I(Y)) gene exons 1-8 | | |
| HnRNP H mRNA | | L22009 |
| Guanylate kinase (GUK1) mRNA | | L76200 |
| Metallothionein-le gene (hMT-le) | | M10942 |
| IMMUNOGLOBULIN J CHAIN | | M12759 |
| ENO1 Enolase 1, (alpha) | | M14328 |
| COAGULATION FACTOR XIII A | | M14539 |
| CHAIN | | |
| MIC2 Antigen identified by | | M16279 |
| monoclonal antibodies 12E7, F21 | | |
| and O13 | | |
| Thymosin beta-4 mRNA | | M17733 |
| LYZ Lysozyme | | M19045 |
| MPO Myeloperoxidase | | M19507 |
| CYBA Cytochrome b-245, alpha | | M21186 |
| polypeptide | | |
| HSPD1 Heat shock 60 kD protein 1 | | M22382 |
| (chaperonin) | | |
| GB DEF = Sickle cell beta-globin | | M25079 |
| mRNA | | |
| PTMA Prothymosin alpha | | M26708 |
| CD1A CD1a antigen (thymocyte | | M28825 |
| antigen) | | |
| CD1B CD1b antigen (thymocyte | | M28826 |
| antigen) | | |
| X BOX BINDING PROTEIN-1 | | M31627 |
| ODC1 Ornithine decarboxylase 1 | | M33764 |
| CD9 CD9 antigen | | M38690 |
| TNFAIP1 Tumor necrosis factor | | M59465 |
| alpha inducible protein A20 | | |
| NATURAL KILLER CELLS | | M59807 |
| PROTEIN 4 PRECURSOR | | |
| HEAT SHOCK 70 KD PROTEIN 1 | | M59830 |
| Transcription factor ETR101 mRNA | | M62831 |
| RPS3A Ribosomal protein S3A | | M84711 |
| (hybridoma H210) anti-hepatitis A | | M87789 |
| IgG variable region, constant region, | | |
| complementarity-determining regions | | |
| mRNA | | |
| GB DEF = Kazal-type serine | | M91438 |
| proteinase (HUSI-II) gene | | |
| CTGF Connective tissue growth | | M92934 |
| factor | | |
| HLA-A MHC class I protein HLA-A | | M94880 |
| (HLA-A28, -B40, -Cw3) | | |
| Brain-expressed HHCPA78 homolog | | S73591 |
| [human, HL-60 acute promyelocytic | | |
| leukemia cells, mRNA, 2704 nt] | | |
| Ribosomal protein L28 mRNA | | U14969 |
| JUNB Jun B proto-oncogene | | U20734 |
| C-myb gene extracted from Human | | U22376 |
| (c-myb) gene, complete primary cds, | | |
| and five complete alternatively | | |
| spliced cds | | |
| PABPL1 Poly(A)-binding protein- | | U68105 |
| like 1 | | |
| Short-chain alcohol dehydrogenase | | U73514 |
| (XH98G2) mRNA | | |
| Macrophage-derived chemokine | | U83171 |
| precursor (MDC) mRNA | | |
| LTB Lymphotoxin-beta | | U89922 |
| Uncoupling protein homolog (UCPH) | | U94592 |
| mRNA | | |
| Metallothionein isoform 2 | | V00594 |
| SOD1 Superoxide dismutase | | X02317 |
| 1 (Cu/Zn) | | |
| Liver mRNA fragment DNA binding | | X04347 |
| protein UPI homologue (C-terminus) | | |
| COX7A2 Cytochrome c oxidase VIIa | | X15822 |
| subunit (liver specific) | | |
| EEF2 Eukaryotic translation | | X51466 |
| elogation factor 2 | | |
| VIL2 Villin 2 (ezrin) | | X51521 |
| JunD mRNA | | X56681 |
| IGHM immunoglobulin mu | | X58529 |
| GLUL Glutamate-ammonia ligase | | X59834 |
| (glutamine synthase) | | |
| H4/g gene for H4 histone | | X60489 |
| CDW52 CDW52 antigen | | X62466 |
| (CAMPATH-1 antigen) | | |
| Mutant coseg gene for vasopressin- | | X62891 |
| neurophysin precursor | | |
| GUANYLATE CYCLASE | | X66534 |
| SOLUBLE, ALPHA-3 CHAIN | | |
| GB DEF = AICL (activation- | | X96719 |
| induced C-type lectin) | | |
| LPAP gene | | X97267 |
| GB DEF = TNNT2 gene exon 11 | | X98482 |
| HSPB1 Heat shock 27 kD protein 1 | | Z23090 |
| RPL8 Ribosomal protein L8 | | Z28407 |

### EXAMPLE 2

During a further practice of the invention, 57 gene products have been identified using the methods and systems herein to identify individuals having AML, B ALL and T ALL. The 57 genes are identified in Table 2 below together with their GenBank accession numbers, the sequences of which are incorporated herein by reference.

TABLE 2
57 Gene Predictor Set for AML, B ALL and T ALL.

| | | GenBank |
|---|---|---|
| Gene Product | SEQ. ID. NO.: | Accession No. |
| Clone 22 mRNA, alternative splice | | AF009426 |
| variant alpha-1 | | |
| Integrin cytoplasmic domain | | AF07024 |
| associated protein (Icap-1a) mRNA | | |
| Trascriptional activator hSNF2b | | D26156 |
| MCM3 Minichromosome | | D38073 |
| maintenance deficient | | |
| (S. cerevisiae) 3 | | |
| Liver mRNA for interferon-gamma | | D49950 |
| inducing factor (IGIF) | | |
| HMG1 High-mobility group | | D63874 |
| (nonhistone chromosomal) protein 1 | | |
| KIAA0159 gene | | D63880 |
| MACMARCKS | | HG1612 |
| ADPRT ADP-ribosyltransferase | | J03473 |
| (NAD+; poly (ADP-ribose) | | |
| polymerase | | |
| SPTAN1 Spectrin, alpha, non- | | J05243 |
| erythrocytic 1 (alpha-fodrin) | | |
| CRYZ Crystallin zeta (quinone | | L13278 |
| reductase) | | |
| Inducible protein mRNA | | L47738 |
| GB DEF = Retinoblastoma | | L49229 |
| susceptibility protein (RB1) gene, | | |
| with a 3 bp deletion in exon 22 | | |
| (L11910 bases 16185) | | |
| FTL Ferritin, light polypeptide | | M11147 |
| ADA Adenosine deaminase | | M13792 |
| Neuromedin B mRNA | | M21551 |
| CD19 CD19 antigen | | M28170 |
| CARCINOEMBRYONIC ANTIGEN | | M29540 |
| PRECURSOR | | |
| MYL1 Myosin light chain (alkali) | | M31211 |
| Oncoprotein 18 (Op18) gene | | M31303 |
| TCF3 Transcription factor 3 (E2A | | M31523 |
| immunoglobulin enhancer binding | | |
| factors E12/E47) | | |
| FAH Fumarylacetoacetate | | M55150 |
| CYP2C18 Cytochrome P450, | | M61853 |
| subfamily IIC (mephenytoin 4- | | |
| hydroxylase), polypeptide 18 | | |
| ATP6C Vacuolar H+ ATPase proton | | M62762 |
| channel subunit | | |
| CDC25A Cell division cycle 25A | | M81933 |
| CD19 gene | | M84371 |
| ACADM Acyl-Coenzyme A | | M91432 |
| dehydrogenase, C-4 to C-12 straight | | |
| chain | | |
| CCND3 Cyclin D3 | | M92287 |
| HKR-T1 | | S50223 |
| MB-1 gene | | U05259 |
| Thymopoietin beta mRNA | | U09087 |
| Thrombospondin-p50 gene extracted | | U12471 |
| from Human thrombospondin-1 gene, | | |
| partial cds | | |
| SRP9 Signal recognition particle | | U20998 |
| 9 kD protein | | |
| C-myb gene extracted from Human | | U22376 |
| (c-myb) gene, complete primary cds, | | |
| and five complete alternatively | | |
| spliced cds) | | |
| DHPS Deoxyhypusine synthase | | U26266 |
| Transcriptional activator hSNF2b | | U29175 |
| Cytoplasmic dynein light chain 1 | | U32944 |
| (hdlc1) mRNA | | |
| Tax1-binding protein TXBP181 | | U33822 |
| mRNA | | |
| Heterochromatin protein p25 | | U35451 |
| mRLNA | | |
| Leukotriene C4 synthase (LTC4S) | | U50136 |
| gene | | |
| PLATELET-ACTIVATING | | U72342 |
| FACTOR ACETYLHYDROLASE | | |
| 45 KD SUBUNIT | | |
| GB DEF = Homeodomain protein | | U82759 |
| HoxA9 mRNA | | |
| Butyrophilin (BTF5) mRNA | | U90552 |
| IRF2 Interferon regulatory factor 2 | | X15949 |
| PRG1 Proteoglycan 1, secretory | | X17042 |
| granule | | |
| CTPS CTP synthetase | | X52142 |
| ADH4 gene for class II alcohol | | X56411 |
| dehydrogenase (pi subunit), exon 1 | | |
| PROTEASOME IOTA CHAIN | | X59417 |
| GTF2E2 General transcription factor | | X63469 |
| TFIIE beta subunit, 34 kD | | |
| RETINOBLASTOMA BINDING | | X74262 |
| PROTEIN P48 | | |
| GLRX Glutaredoxin (thioltransferase) | | X76648 |
| Zyxin | | X95735 |
| LPAP gene | | X97267 |
| RABAPTIN-5 protein | | Y08612 |
| LEPR Leptin receptor | | Y12670 |
| TOP2B Topoisomerase (DNA) II | | Z15115 |
| beta (180 kD) | | |
| Adenosine triphosphatase, calcium | | Z69881 |

### EXAMPLE 3

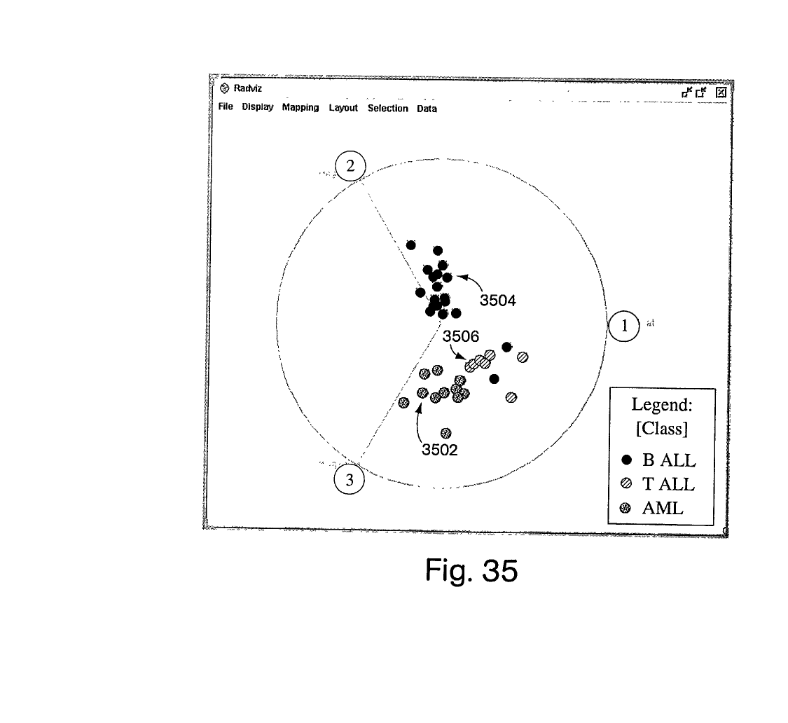

Referring to FIG. 35, using the methods and systems herein 3 gene products have been identified which can be used to identify individuals having AML 3502, B ALL 3504 and T ALL 3506. Although not as reliable as the 57 gene predictor set, the three genes can still be used to great advantage to determine the predisposition of an individual to AML, B ALL and T ALL. The three genes are identified in Table 3 below together with their GenBank accession numbers, the sequences of which are incorporated herein by reference.

TABLE 3
3 Gene Predictor Set for AML, B ALL and T ALL.

| Gene Product | SEQ. ID. NO.: | GenBank Accession No. |
|---|---|---|
| KIAA0102 gene | | D14658 |
| IGB Immunoglobulin- | | M89957 |
| associated beta (B29) | | |
| LEPR Leptin receptor | | U66497 |

Biochemical Applications

Another application for the above described systems and methods of the invention is in predicting the Structural Activity Relationship (SAR) for chemical compounds.

### EXAMPLE 4

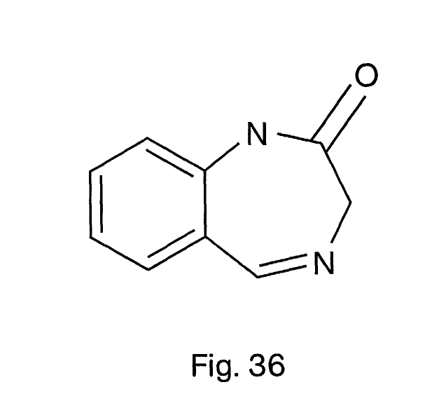

In the below described example, a SAR data set consisting of about 900 chemicals (records) having 20 data fields (attributes) was analyzed. The 20 data fields consist of 4 bookkeeping fields, 10 biological assays, and 6 chemical descriptors. Chemical descriptors are numbers computed from a chemical structure. The goal of the following exemplary analysis was to provide intuitive visual representations of analysis results showing relationships between biological activity and chemical structure. FIG. 36 depicts that chemical structure for Benzodiazepines, the class of chemicals which contains Valium®.

In this example, there are two biological assays being performed. In one case, the goal is to completely inhibit one enzyme (with a low IC50) (Assay 1) and not affect another enzyme (there would be a high IC50 for the same chemical) (Assay 2). The selectivity index is computed by taking the ratio of Assay 2 to Assay 1. A selectivity index of at least about 1000 (three orders of magnitude) is preferable.

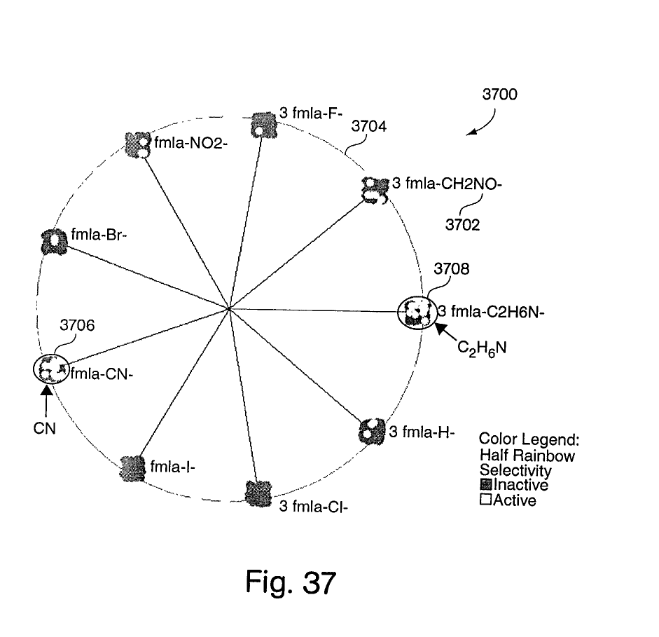

FIG. 37 depicts a radial visualization 3700 of the type employed by the record categorization subsystem 104. In FIG. 37 the SAR data set was “flattened” to enumerate each of the Substituent (R)-groups as specific fields in a data record. The process of flattening takes a single column, labeled R3, in which there are several possible values and creates a column for each specific R3 Under each of these columns is placed a 0 or a 1 to represent the absence or presence, respectively, of that specific R-group member. The radial visualization 3700 shows each member of the R3 group as an attribute 3702 arranged around the periphery of the circular locus 3704. The data records, representing chemical compounds, are plotted as either black dots (indicating an insufficient selectivity index) or light gray dots (indicating a sufficient selectivity index). In the radial visualization, if the attributes for a given record are all zero (or the lowest normalized value) except for one attribute, then the position of the data record becomes exactly at the spring anchor point or the locus of the attribute. In FIG. 37, all chemicals (data records) have only one attribute that is not zero, that is the particular R3 group member. Therefore, all data records are positioned at an anchor point for that attribute. The points have been “jittered” (i.e., moved in a small random X and Y position) so that clusters can be seen more easily.

From this visualization 3700, it can be seen that data records are clustered into the individual groups represented by each member of the R3 group. Also, some of the R3 groups have more “active” (sufficiently high selectivity index) records than other R3 groups. As shown the cyano (CN-) 3706 and the ethyamino (C2H6N-) 3708 moieties have the largest occurrence of “active” records.

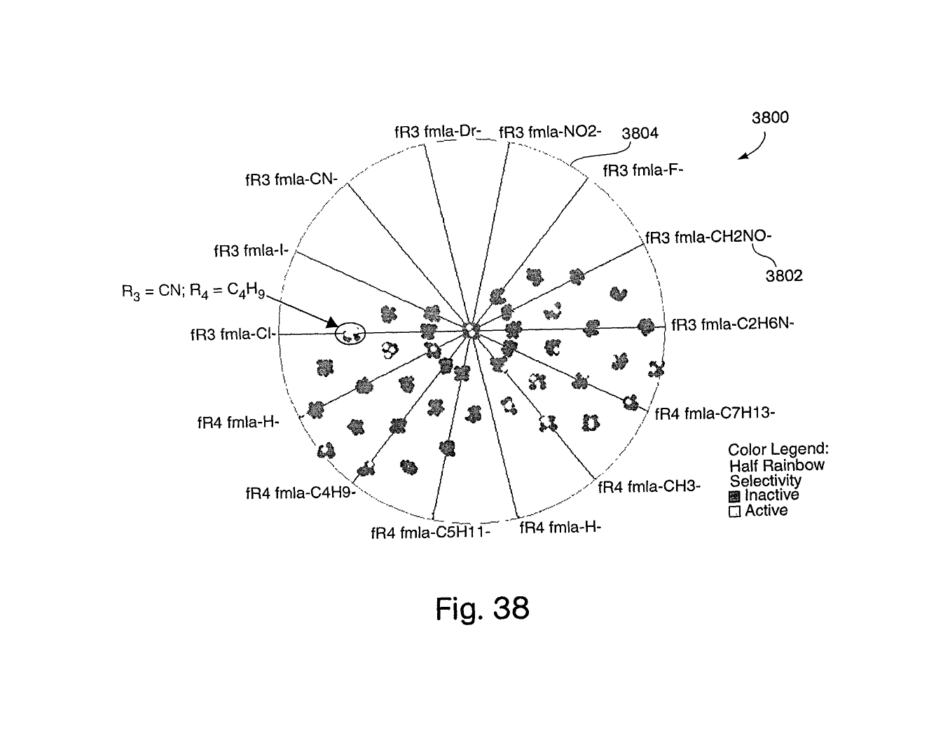

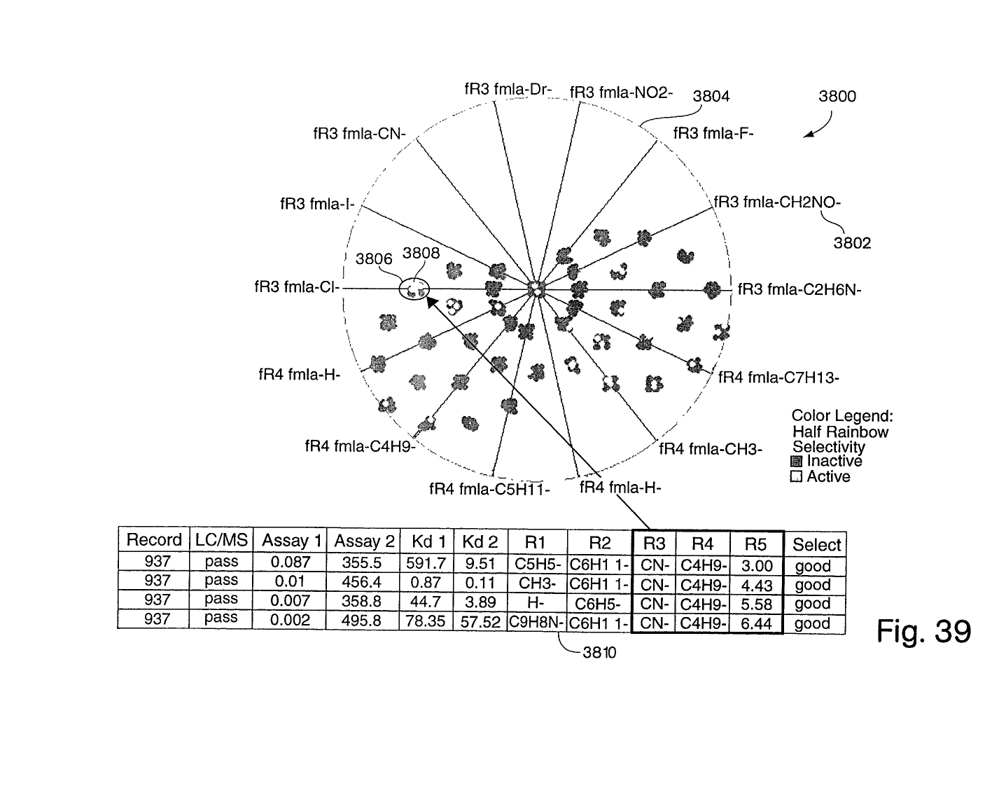

FIG. 38 depicts a radial visualization 3800 showing the R3 and R4 groups together from the flattened SAR data set. In the visualization 3800, the members of the R3 and R4 groups are plotted as attributes 3802 along the periphery of the circular locus 3804. From the visualization 3800, a number of record clusters can be seen. In the portion of the visualization 3800 enclosed by the oval 3806, there are four light gray dots 3808 (representing active records) that are part of a cluster. It can also be seen that the active records 3808 correspond to an R3 of CN-(cyano) and an R4 of C4H9 (n-butyl). FIG. 39 depicts the radial visualization 3800 of FIG. 38, augmented with a table 3810 presenting the actual data for each of the four active records 3808. In the radial visualization, when two groups of mutually exclusive binary attributes are arranged together, clusters can be seen that have the same values for each attribute. In this case, in FIGS. 38 and 39, all chemicals in each cluster have the same R3 and R4 values.

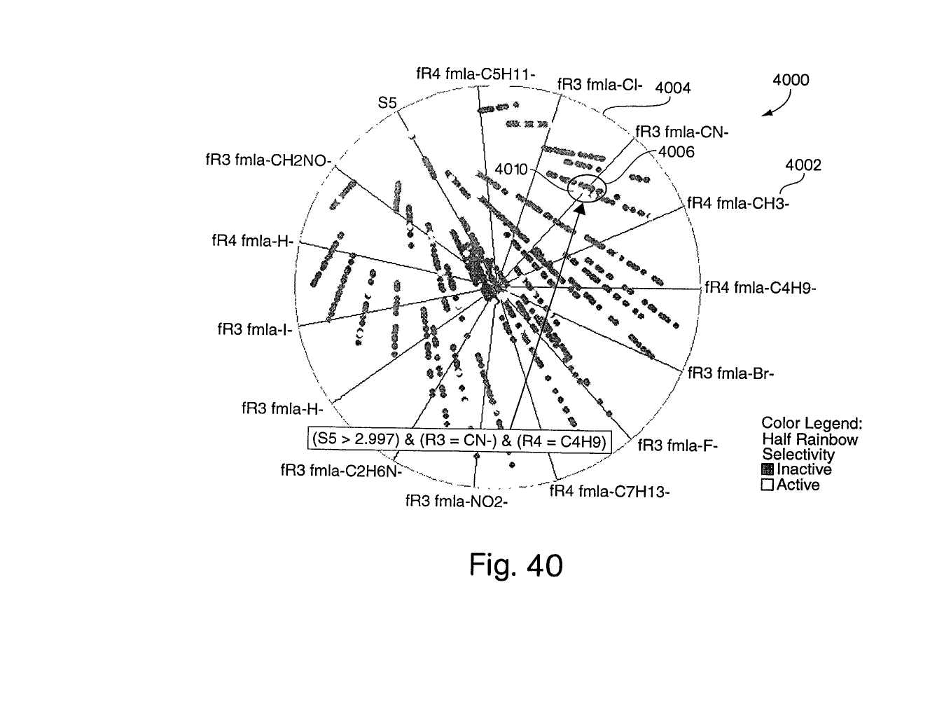

FIG. 40 depicts a radial visualization 4000 showing the R3, R4 together from the flattened SAR data set. In the visualization 4000, the members of the R3 and R4 groups are plotted as attributes 4002 along the periphery of the circular locus 4004. S5, representing an electrotopological state variable from MolConn-Z is also plotted as an attribute. From the visualization 4000, it can be seen that a number of record groupings form lines. In each of the line-shaped record groupings, it can also be seen that the line points to the S5 attribute location on the periphery of the locus 4004. It can also be seen that in the portion of the visualization enclosed by the oval 4006, there are six light gray dots (representing Active records 4010) lined up in a record group, with the left most dots group signifying a relatively higher S5 value than the right most dots of the group.

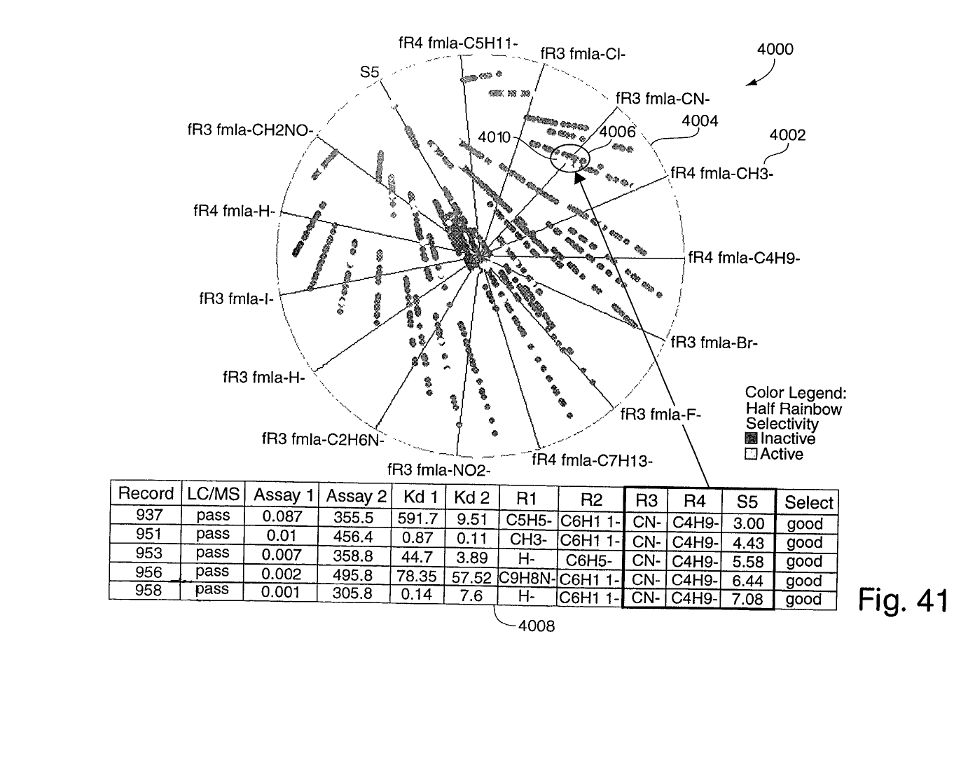

The result depicted in the visualization 4000 was confirmed against the following association rule algorithm: Active Records=S5>2.997&(R3=CN-)&(R4=C4H9), with the following results. 5 records: 0.52% of all records, 100% confidence. FIG. 41 depicts the radial visualization 4000 of FIG. 40, augmented with a table 4008 presenting the actual data for each of the active records 4010. Association rules are a standard machine learning technique, but it is clear in this example that the flattening and layout mechanisms in the radial visualization can visually show association rules without special association rule algorithms.

Predictive Toxicology Applications

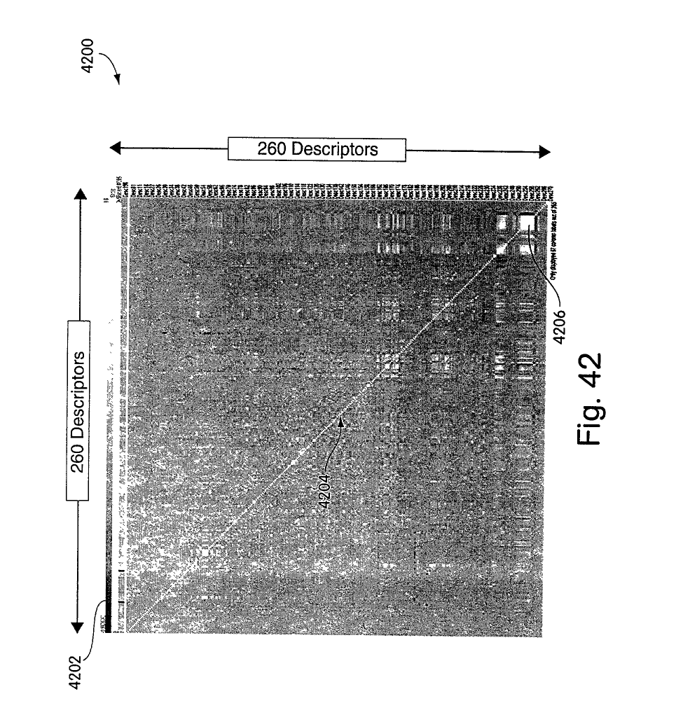

Another area in which the system and related methods of the above described example can be employed is in the field of predictive toxicology. One such illustrative example is described below with respect to FIGS. 42-50.

### EXAMPLE 5

In this example a data set consisting of 100,000 chemicals (records) each having 280 data fields (attributes) is analyzed. The 280 attributes comprise one biological assay, four liver enzymes, and 275 chemical descriptors. The 275 chemical descriptors consist of 166 substructure search keys exported from ISIS/Host, which is a product from MDL Information Systems Inc. and 109 Electrotopological State Indicators generated with MolConnZ™, from Hall Associates Consulting, Quincy Mass. 02170-2818 USA. Two goals of this example are to employ the invention to understand the statistical nature of the data set and to identify the liver isozyme inhibition by different chemotypes. To do so, the following example employs the above described attribute reduction subsystem 102, the record categorization subsystem 104 and data processing algorithms 106.

The following example performs the data set analysis in stages. More particularly, in this example, the operator employs the metadata overview features of the invention to look at the various correlations in the data set, and to identify any missing values, which might adversely affect the analysis results. Next, data cleansing is employed to format and reorganize the data set to optimize processing. Following cleansing, the biological activity described in the data set is binned so that various clustering and association techniques can be employed. Genetic algorithms are then employed to deal with combinatoric issues resulting from the high dimensionality of the data set. Next, visualization is used to provide not only a pictorial summary of the data, but also to provide intuitive insight into the meaning of the processing results.

During metadata overview processing and cleansing, it was found that 10 ISIS keys and 5 MolConnZ descriptors had zero values. For the following analysis, the fields having zero values were eliminated, thereby reducing the number of descriptors and keys to 260. Additionally, many records contained missing values. Specifically, about 49,000 biological assay values; 50,000 isozyme 1 values; 50,000 isozyme 2 values; 55,000 isozyme 3 values, and 50,000 isozyme 4 values were missing. About 24,000 records had all values of the biological activity and the four liver isozymes.

FIG. 42 is a GUI display screen 4200 depicting binned values of Pearson cross-correlations between the 260 remaining descriptors/attributes. All attributes are shown and all are displayed along both the x- and y-axes. The gray scale (or color scale) 4202 used is shown at the top of the display screen 4200, with dark gray representing a high negative correlation, medium gray representing no correlation, and light gray representing a high positive correlation. The light gray diagonal line 4204 corresponds to the high positive (1.0) self-correlation of every attribute. Correlation patterns possess mirror symmetry about the diagonal line 4204. Light gray sections of clustered key descriptors possessing high positive correlations are clearly visible close to the diagonal as well as a few sections of clustered horizontal and vertical dark gray sections with high negative correlations. As an example, the lower right light gray square 4206 corresponds to several descriptors having highly positive correlations to each other. In this example, interactive data probing using this visualization enabled the operator to identify the high positive and high negative attribute correlations. As described above, a single attribute may be selected to represent a group of highly correlated attributes in a result-effective attribute subset.

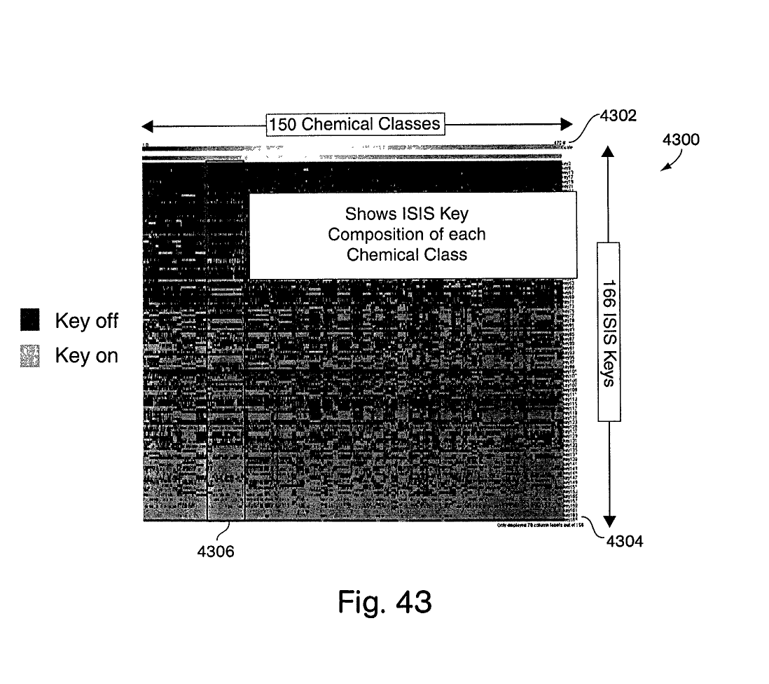

FIG. 43 is a GUI display screen 4300 depicting a binned table representation of the type employed by the attribute reduction subsystem 102, with class numbers 4302 (numbers partially shown) listed along the top of the display 4300 and key descriptors 4304 listed along the bottom of the display 4300. The binary key values go from top to bottom in the order of the original data set. Black or dark gray indicates that a key is 0 (off) and light gray indicates that a key is 1 (on). As an example of the utility of the display screen 4300, the box 4306 highlights one chemical class showing a broken line formed by a large number of dark gray (off) key values. This shows that certain keys are all on or off for this particular chemical class, also showing that the keys can be used to distinguish classes and class properties.

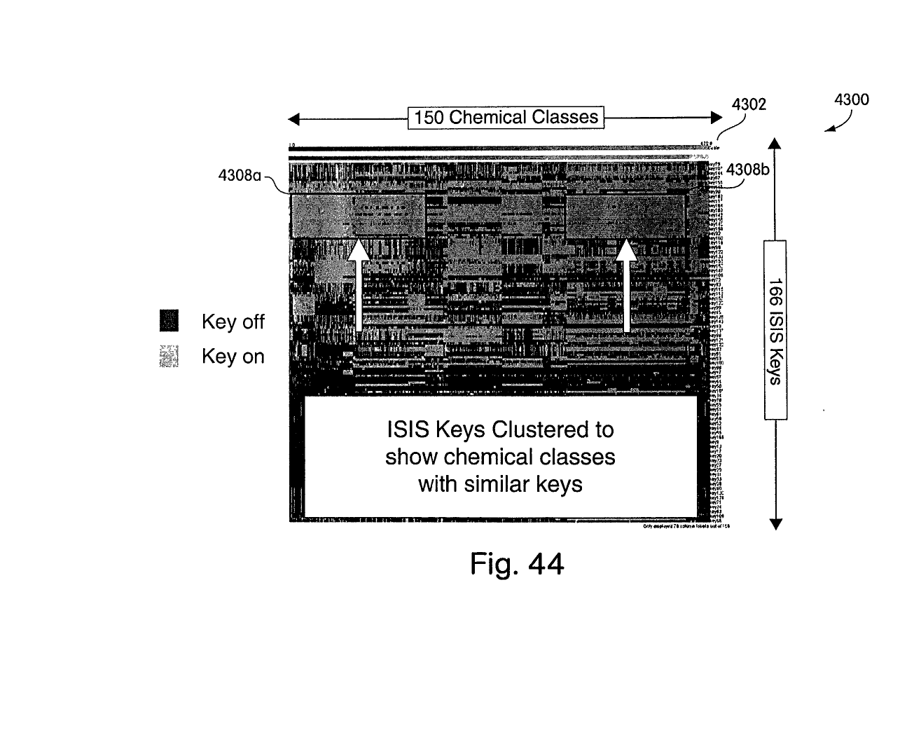

FIG. 44 depicts the display screen 4300 of FIG. 44, except that a subset 4308 of the classes 4302 is selected by boxes 4308a and 4308b. The class subset 4308 is clustered according to the column values. A Euclidean metric was used to form the clusters. This shows that groups of chemical classes can be distinguished by the keys, again suggesting that chemical properties can be classified by the ISIS keys.

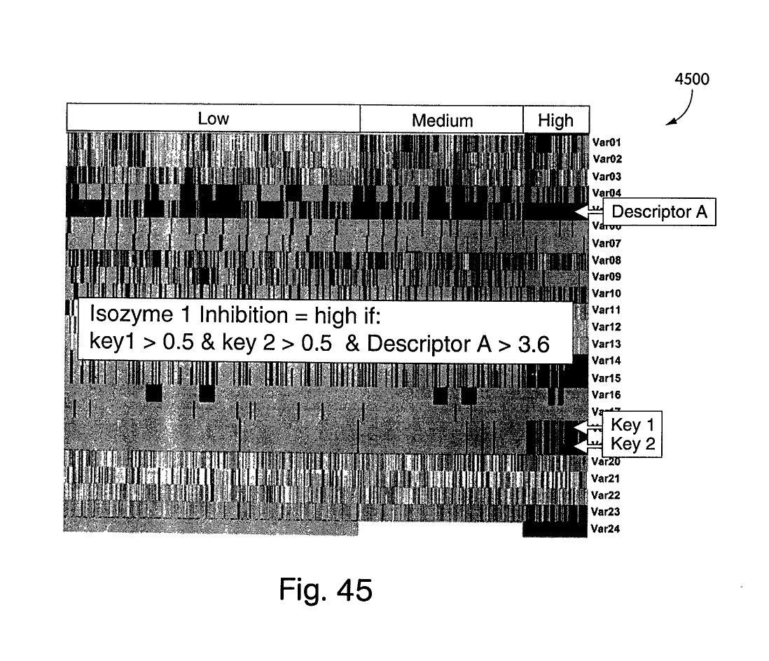

FIG. 45 shows a binned table 4500, of the type generated by the attribute reduction subsystem 102, used to identify and formulate association rules for highly correlated regions of the chemical descriptors. A subset of the ISIS keys and MolConnZ™ descriptors are columns (top to bottom). The rows or records are all the chemicals in a particular class sorted by Isozyme 1 (from Low to High). This type of visual display has proved useful in identifying association rules not found by conventional association rule generators, which do not have a visual component. As shown the association rule, isozyme 1 inhibition=high if: key1>0.5 (i.e., on) & key2>0.5 (i.e., on) & descriptor A>3.6. These keys and descriptors represent specific structural features, attributes, and properties.

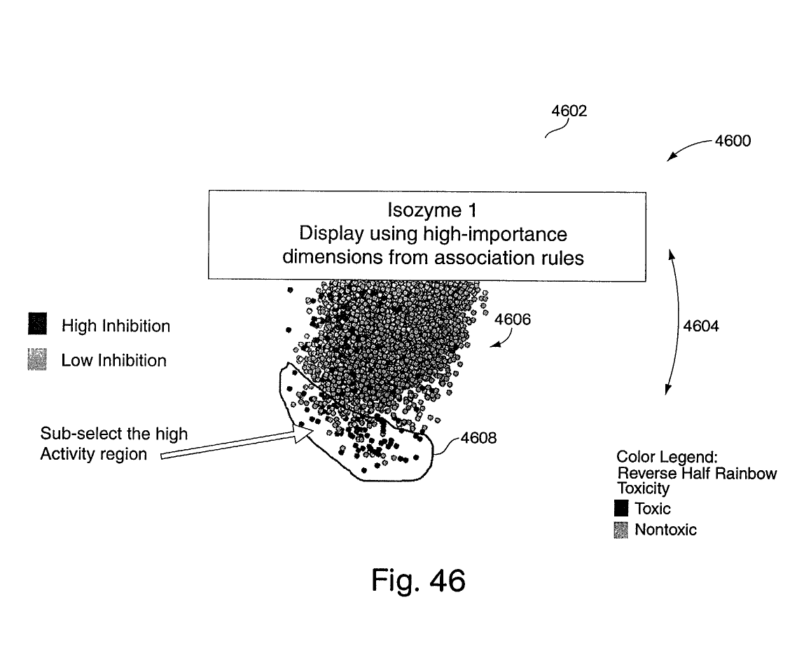

FIG. 46 depicts a radial visualization 4600 of the type generated by the record categorization subsystem 104. In the visualization 4600, the 266 descriptors are plotted as attributes 4602 along the periphery of a circular locus 4604. The records 4606 consist of the chemical records having no missing values for isozyme 1 activity. Black shading indicates records having high inhibition and light gray indicates records having low inhibition. A sub-selection 4608 of a clustering of records having high activity.

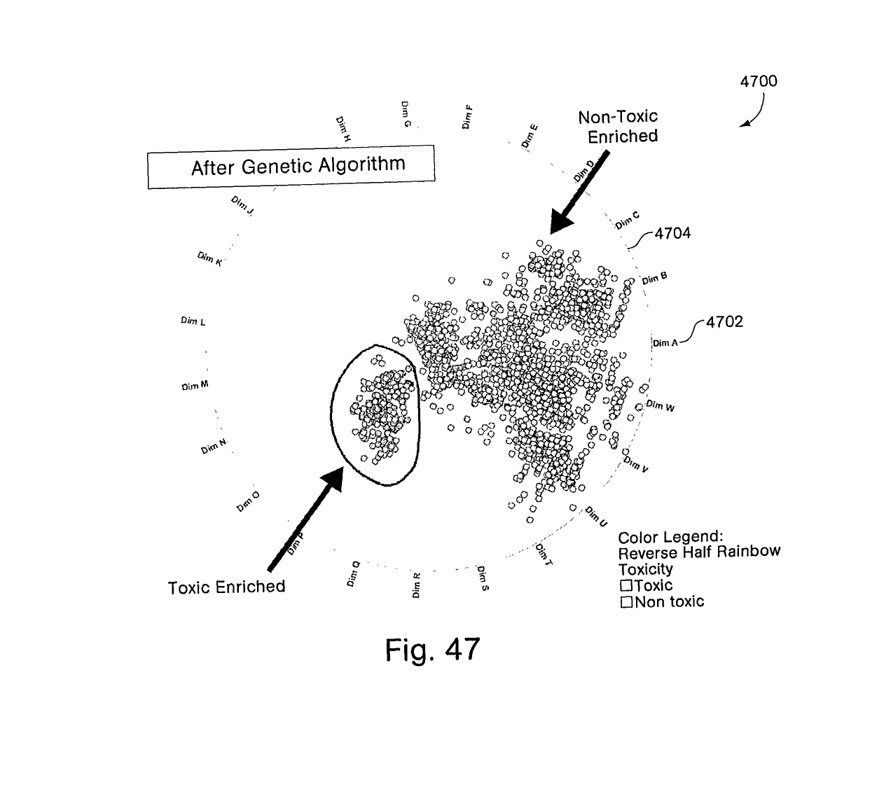

FIG. 47 shows a subset of attributes (chemical descriptors) laid out using a Genetic Algorithm to arrange the descriptors or attributes. These attributes in the sub-selection were identified as important attributes from association rules applied to a single chemical class. After the sub-selection, a genetic algorithm was applied to the radial visualization to find an optimum separation of toxic from non-toxic regions. The association rules were found from a commercial machine learning program. The genetic algorithm uses different “fitness” criteria for separating multi-class problems in the radial visualization by trying different arrangements of the attributes arranged around the circular locus until the class separation is “maximum” according to the genetic algorithm fitness function. Now that the descriptors (attributes 4702) have been selected an positioned along the locus 4704, the radial visualization 4700 is calibrated to be used as a predictor tool.

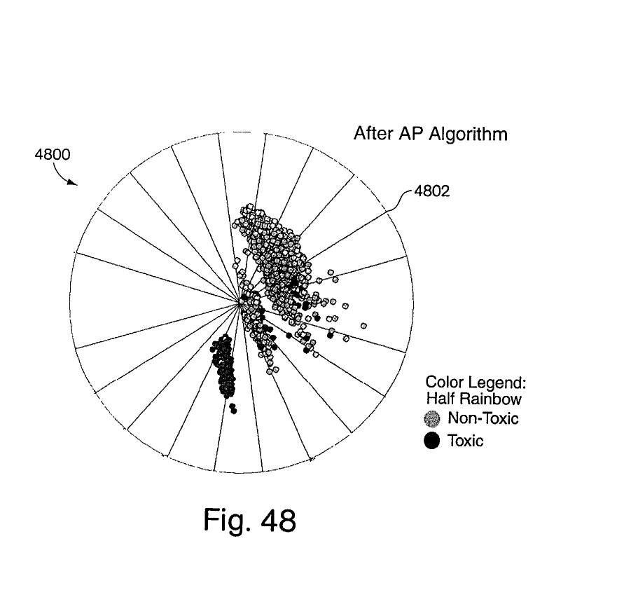

FIG. 48 shows a display 4800 of a similar example of the same dataset but in this case the AP layout algorithm was used to reduce and layout the attributes from the 260 descriptors. The top 20 descriptors 4802 for distinguishing toxic from non-toxic using the t-statistic are shown in FIG. 48. It can be seen that the separation or classification is as good as or better than the genetic algorithm and finds similar chemical descriptors.

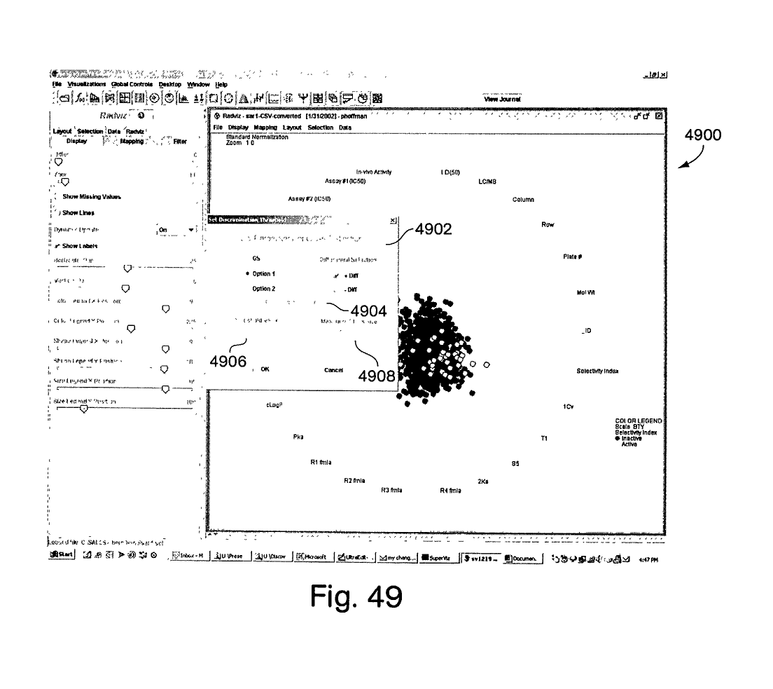

FIG. 49 depicts a GUI screen image 4900 of parameters for the AP algorithm, as described above with respect to FIGS. 14A-14C. The GUI screen image 4900 shows a “Set Discrimination Threshold” dialog box 4902 that enables the selection of parameters for class distinction. The “Set Discrimination Threshold” dialog box 4902 enables the selection of GS, option 1, and option 2, and the selection of a positive differential selection or a negative differential selection. The GS, option 1, and option 2 select differential statistical measures for laying out the attributes. Further, a significance level is employed upon the selection of the “Use Significance Level” checkbox 4904. Moreover, the dialog box 4902 enables an input of a threshold value 4906 and/or a maximum class size 4908.

Equivalents

While the invention has been particularly shown and described with reference to specific preferred embodiments, it should be understood by those skilled in the art that various changes in form and detail may be made therein without departing from the spirit and scope of the invention as defined by the appended claims.

What is claimed is:

1. A method of data analysis comprising,
employing data comprising, a plurality of records, each of said records having an associated plurality of attributes, said plurality of records being divisible into at least two categories,
providing a multidimensional array having intersecting first and second axes,
assigning each of said attributes as a one dimensional vector aligned along said first axis,
assigning each of said records as a one dimensional vector aligned along said second axis,
displaying a graphical indication of at least one of an occurrence and a value of each said attribute for each said record at an intersection of each said record vector with each said attribute vector, and
manipulating at least one of said record vectors and said attribute vectors to produce a graphical pattern representative of said at least two categories.

2. The method of claim 1, wherein said manipulating step comprises transposing vectors in at least one of a pair of said record vectors and a pair of said attribute vectors to produce said graphical pattern representative of said at least two categories.

3. The method of claim 1 further comprising, determining, from said graphical pattern, a result-effective subset of attributes that is sufficient to divide said records into said at least two categories.

4. The method of claim 3, wherein said result-effective subset is a minimum subset.

5. The method of claim 4, wherein said minimum subset is unique.

6. The method of claim 2 further comprising, repeating said transposing step until said graphical pattern is produced.

7. The method of claim 1, wherein said graphical indication has at least two states.

8. The method of claim 7, wherein each of said states is represented by a color.

9. The method of claim 7, wherein each of said states is represented by a symbol.

10. The method of claim 7, wherein each of said states is represented by an integer.

11. The method of claim 7, wherein said each of said states is represented by a shade of gray

12. The method of claim 1, wherein said data comprises training data obtained from control specimens.

13. The method of claim 1, wherein said manipulating step comprises employing a principal uncorrelated record set algorithm.

14. The method of claim 1, wherein said records represent cells and said attributes are properties of said cells.

15. The method of claim 1, wherein said records represent mammals and said attributes are characteristics of said mammals.

16. The method of claim 1, wherein said records represent a sample from a mammal and said attributes are biological markers.

17. The method of claim 16, wherein said biological marker is a gene product.

18. The method of claim 16, wherein said biological marker is at least one of a protein and an mRNA.

19. The method of claim 1, wherein at least one of said at least two categories represents a predisposition to contract a disease.

20. The method of claim 19, wherein said disease is leukemia.

21. The method of claim 1, wherein at least one of said at least two categories represents a predisposition to a medical treatment efficacy.

22. The method of claim 1, wherein a first category represents a mammal having a first phenotype and a second category represents a mammal having a second, different phenotype.

23. The method of claim 22, wherein the first phenotype is a disease affected phenotype.

24. The method of claim 22, wherein the second phenotype is a non-disease affected phenotype.

25. The method of claim 22, wherein the disease is a cancer.

26. The method of claim 12, wherein said control specimens are mammals having a non-disease affected phenotype.

27. The method of claim 12, wherein said control specimens are mammals having a disease affected phenotype.

28. A system for data analysis, comprising;
a processor adapted for,
providing data including, a plurality of records, each of said records having an associated plurality of attributes, said plurality of records being divisible into at least two categories,
providing a two dimensional array having intersecting first and second axes,
assigning each of said attributes as a one dimensional vector aligned along said first axis,
assigning each of said records as a one dimensional vector aligned along said second axis, and
manipulating at least one of said record vectors and said attribute vectors to produce a graphical pattern representative of said at least two categories; and
a display adapted to display a graphical indication of at least one of an occurrence and a value of each said attribute for each said record at an intersection of each said record vector with each said attribute vector.

29. The system of claim 28, wherein said manipulating comprises transposing vectors in at least one of a pair of said record vectors and a pair of said attribute vectors to produce said graphical pattern representative of said at least two categories.

30. The system of claim 28, wherein said processor is further adapted for determining, from said graphical pattern, a result-effective subset of attributes that is sufficient to divide said records into said at least two categories.

31. The system of claim 30, wherein said result-effective subset is a minimum subset.

32. The system of claim 30, wherein said minimum subset is unique.

33. The system of claim 29, wherein said processor is further adapted for repeating said transposing step unit said graphical pattern is produced.

34. The system of claim 28, wherein said graphical indication has at least two states.

35. The system of claim 34, wherein each of said states is represented by a color.

36. The system of claim 34, wherein each of said states is represented by a symbol.

37. The system of claim 34, wherein each of said states is represented by an integer.

38. The system of claim 34, wherein said each of said states is represented by a shade of gray.

39. The system of claim 28, wherein said data comprises training data obtained from control specimens.

40. The system of claim 28, wherein said manipulating comprises employing a principal uncorrelated record set algorithm.

41. The system of claim 28, wherein said records represent cells and said attributes are properties of said cells.

42. The system of claim 28, wherein said records represent mammals and said attributes are characteristics of said mammals.

43. The system of claim 28, wherein said records represent a sample from a mammal and said attributes are biological markers.

44. The system of claim 43, wherein said biological marker is a gene product.

45. The system of claim 43, wherein said biological marker is at least one of a protein and an mRNA.

46. The system of claim 28, wherein at least one of said at least two categories represents a predisposition to contract a disease.

47. The system of claim 46, wherein said disease is leukemia.

48. The system of claim 28, wherein at least one of said at least two categories represents a predisposition to a medical treatment efficacy.

49. The system of claim 28, wherein a first category represents a mammal having a first phenotype and a second category represents a mammal having a second, different phenotype.

50. The system of claim 49, wherein the first phenotype is a disease affected phenotype.

51. The system of claim 49, wherein the second phenotype is a non-disease affected phenotype.

52. The system of claim 50, wherein the disease is a cancer.

53. The system of claim 39, wherein said control specimens are mammals having a non-disease affected phenotype.

54. The system of claim 39, wherein said control specimens are mammals having a disease affected phenotype.

55. A computer program recorded on a computer-readable medium for graphical data analysis, said computer program when operating performing said steps of,
accepting data comprising, a plurality of records, each of said records having an associated plurality of attributes, said plurality of records being divisible into at least two categories,
constructing a multidimensional array having intersecting first and second axes,
assigning each of said attributes as a one dimensional vector aligned along said first axis,
assigning each of said records as a one dimensional vector aligned along said second axis,
displaying a graphical indication of at least one of an occurrence and a value of said attribute for each said record at an intersection of each said record vector with each said attribute vector, and
manipulating at least one of said record vectors and said attribute vectors to produce a graphical pattern representative of said at least two categories.

56. The computer program of claim 55, wherein said manipulating step comprises transposing vectors in at least one of a pair of said record vectors and a pair of said attribute vectors to produce said graphical pattern representative of said at least two categories.

57. The computer program of claim 55, when operating, further comprising, determining, form said graphical pattern, a result-effective subset of attributes that is sufficient to divide said records into said at least two categories.
